(19) United States
(12) Patent Application Publication
(10) Pub. No.: US 2026/0266768 A1
(43) Pub. Date: Sep. 10, 2026

(54) RAIL TRACK APPARATUS AND METHOD

(71) Applicant: Peak to Peak Measurement Solutions Limited, Sheffield South Yorkshire (GB)

(72) Inventors: Henry Peter Brunskill, Sheffield (GB); Andrew Kevin Hunter, Sheffield (GB)

(21) Appl. No.: 19/520,400

(22) PCT Filed: Sep. 16, 2024
(86) PCT No.: PCT/GB2024/052401

§ 371 Date: Mar. 17, 2026

(30) Foreign Application Priority Data
Sep. 14, 2023 (GB) 2314089.0

(51) Int. Cl. G01N 29/07; B61L 23/04

(52) U.S. Cl. CPC G01N 29/07; B61L 23/042; G01N 2291/011; G01N 2291/023; G01N 2291/101

(57) ABSTRACT

An apparatus and method for monitoring rail vehicle wheel-rail track interaction at a sensing region of a rail track. The apparatus comprises an ultrasonic sensor mountable on the rail track to form the sensing region of the rail track, whereby the sensing region of the rail track comprises an interface surface at which a wheel-rail interface forms when a rail vehicle wheel contacts the interface surface. The ultrasonic sensor comprises at least one ultrasonic longitudinal bulk wave transducer configured to detect a VTI ultrasonic longitudinal bulk wave signal reflected from the wheel-rail track interface; and at least one ultrasonic shear bulk wave transducer configured to detect a VTI ultrasonic shear bulk wave signal reflected from the wheel-rail track interface.

### TECHNICAL FIELD

The present invention relates to a rail track apparatus and method for monitoring rail vehicle-track interaction (VTI).

### INTRODUCTION

A rail vehicle wheel contacts a rail track as the rail vehicle travels along the track. Depending on the wheel design and rail track design, rail vehicle wheel-rail track contact may occur between a wheel tread and a rail track tread. When cornering, rail vehicle wheel-rail track contact may occur between a wheel flange and a rail track gauge. The area of contact between the rail vehicle wheel and rail track is commonly referred to as the “wheel-rail track interface”.

The contact and loading conditions between a rail vehicle wheel and a rail track as the rail vehicle travels along the rail track are commonly referred to as the “vehicle-track interaction VTI”, or alternatively referred to as “wheel-track interaction WTI”. Poor VTI can result in friction problems, slipping of the wheel, reduced vehicle speed, rail track wear, wheel damage, even rail track failure and rail vehicle derailment. Hence, the monitoring of VTI is critical to understanding the health and condition of the rail track and rail vehicle, and maintaining of a safe rail network.

However, as the interaction between the rail vehicle wheel and rail track is dynamic, complex, and difficult to access, the known systems and methods for VTI monitoring are currently limited, costly, and time consuming. Known systems and methods are often invasive and disruptive and the data collected is not in real-time. Long distance VTI monitoring along the length of a rail track is difficult to achieve.

One known approach for monitoring VTI uses strain gauges. However, the strain gauges are only able to approximately infer, rather than directly measure, key VTI parameters.

Another known approach for monitoring VTI uses optical systems to measure rail track position, profile, and some rail head defects. However, these optical systems often limit the rail vehicle's maximum speed or fail due to dirt or contamination on the optical lenses.

The present invention relates to a solution that mitigates the problems of monitoring VTI described above.

### SUMMARY OF INVENTION

The present invention relates to a sensing solution to monitor vehicle-track interaction VTI between a rail vehicle wheel and a rail track.

A first aspect of the invention provides an apparatus for monitoring VTI at a sensing region of a rail track, whereby the apparatus comprises an ultrasonic sensor mountable on the rail track to form the sensing region of the rail track. The sensing region of the rail track comprises an interface surface at which an interface forms during monitoring. The interface during monitoring may, for example, form between the interface surface of the sensing region and a rail vehicle wheel, the environmental atmosphere, and/or a third body (including a friction modifier, lubricant film, water, dirt, leaves, ice, corrosion etc).

The ultrasonic sensor may comprise bulk wave transducers configured to detect bulk wave signals reflected from the interface, whereby the reflected bulk wave signals propagate through the sensing region from the interface.

In an example, the ultrasonic sensor may comprise:
at least one ultrasonic longitudinal bulk wave transducer configured to detect an ultrasonic longitudinal bulk wave signal reflected from the interface; and
at least one ultrasonic shear bulk wave transducer configured to detect an ultrasonic shear bulk wave signal reflected from the interface.

By having at least one ultrasonic longitudinal bulk wave transducer and at least one ultrasonic shear bulk wave transducer, the ultrasonic sensor is a multi-planar bulk wave ultrasonic sensor. The multi-planar bulk wave ultrasonic sensor allows for the simultaneous detection of reflected bulk wave signals by the at least one ultrasonic longitudinal bulk wave transducer and at least one ultrasonic shear bulk wave transducer in real time.

In an example, the first ultrasonic sensor may comprise:
a plurality of ultrasonic longitudinal bulk wave transducers, whereby each transducer is configured to detect an ultrasonic longitudinal bulk wave signal reflected from the interface.

As such, the ultrasonic sensor allows for the simultaneous detection of multiple reflected longitudinal bulk wave signals by the plurality of ultrasonic longitudinal bulk wave transducers in real time.

In an example, the first ultrasonic sensor may comprise a plurality of ultrasonic shear bulk wave transducers, whereby each transducer is configured to detect an ultrasonic shear bulk wave reflected from the interface.

As a result, the ultrasonic sensor allows for the simultaneous detection of multiple reflected shear bulk wave signals by the plurality of ultrasonic shear bulk wave transducers in real time.

If the ultrasonic sensor comprises at least one ultrasonic longitudinal bulk wave transducer, the at least one ultrasonic longitudinal bulk wave transducer may be configured to operate at a predetermined frequency. As such, the ultrasonic sensor may be configured to detect the at least one reflected longitudinal bulk wave signal of the predetermined frequency.

If the ultrasonic sensor comprises a plurality of ultrasonic longitudinal bulk wave transducers, the plurality of longitudinal bulk wave transducers may be configured to operate at different predetermined frequencies. As a result, the ultrasonic sensor may be configured detect reflected longitudinal bulk wave signals of the different predetermined frequencies.

For example, the ultrasonic sensor may comprise:
at least one ultrasonic longitudinal bulk wave transducer operating at a first longitudinal bulk wave frequency, wherein the at least one ultrasonic longitudinal bulk wave transducer is configured to detect a longitudinal bulk wave signal reflected from the interface with the first longitudinal bulk wave frequency; and
at least one ultrasonic longitudinal bulk wave transducer operating at a second longitudinal bulk wave frequency that is different to the first longitudinal bulk wave frequency, wherein the at least one ultrasonic longitudinal bulk wave transducer is configured to detect a longitudinal bulk wave signal reflected from the interface with the second longitudinal bulk wave frequency.

Likewise, if the ultrasonic sensor comprises at least one ultrasonic shear bulk wave transducer, the at least one ultrasonic shear bulk wave transducer may be configured to operate at a predetermined frequency. As such, the ultrasonic sensor may be configured to detect the at least one reflected shear bulk wave signal with the predetermined frequency.

If the ultrasonic sensor comprises a plurality of ultrasonic shear bulk wave transducers, the plurality of shear bulk wave transducers may be configured to operate at different predetermined frequencies. As a result, the ultrasonic sensor may be configured detect reflected shear bulk wave signals with the different predetermined frequencies.

For example, the ultrasonic sensor may comprise:
at least one ultrasonic shear bulk wave transducer operating at a first shear bulk wave frequency, wherein the at least one ultrasonic shear bulk wave transducer is configured to detect a shear bulk wave signal reflected from the interface with the first shear bulk wave frequency; and
at least one ultrasonic shear bulk wave transducer operating at a second shear bulk wave frequency that is different to the first shear bulk wave frequency, wherein the at least one ultrasonic shear bulk wave transducer is configured to detect a shear bulk wave signal reflected from the interface with the second shear bulk wave frequency.

By having ultrasonic bulk wave transducers operating at different frequencies, the ultrasonic sensor is a multi-frequency bulk wave ultrasonic sensor. The multi-frequency bulk wave ultrasonic sensor allows for wide-frequency spectrum analysis, extending the measurement range of the ultrasonic sensor. The multi-frequency bulk wave ultrasonic sensor allows for self-verification of measurements by the ultrasonic sensor, and reducing of noise. Since the beam spread of the ultrasonic wave signal is dependent on its frequency, the multi-frequency bulk wave ultrasonic sensor allows for multiple sensor unit configurations in pulse-echo mode and pitch-catch mode.

If the ultrasonic sensor comprises at least one ultrasonic shear bulk wave transducer, the at least one ultrasonic shear bulk wave transducer may have a predetermined direction of polarisation. As such, the ultrasonic sensor may be configured to detect the at least one reflected shear bulk wave signal oscillating in the predetermined direction of polarisation.

If the ultrasonic sensor comprises a plurality of ultrasonic shear bulk wave transducers, the plurality of ultrasonic shear bulk wave transducers may have different predetermined directions of polarisation. As a result, the ultrasonic sensor may be configured to detect reflected shear bulk wave signals oscillating in different predetermined directions of polarisation.

For example, when the ultrasonic sensor comprises a plurality of ultrasonic shear bulk wave transducers, the ultrasonic sensor may comprise:
at least one ultrasonic shear bulk wave transducer with a first shear bulk wave direction of polarisation, wherein the at least one ultrasonic shear bulk transducer is configured to detect a shear bulk wave signal reflected from the interface oscillating in the first direction of polarisation, and
at least one ultrasonic shear bulk wave transducer with a second shear bulk wave direction of polarisation that is different to the first direction of polarisation, whereby the at least one ultrasonic shear bulk wave transducer is configured to detect a shear bulk wave signal reflected from the interface oscillating in the second direction of polarisation.

The at least one ultrasonic shear bulk wave transducer may comprise at least one ultrasonic shear bulk wave transducer with a direction of polarisation parallel to a longitudinal axis of the rail track (x-axis of the rail track, along the length of the rail track), whereby the at least one ultrasonic shear bulk wave transducer is configured to detect an ultrasonic shear bulk wave signal reflected from the interface and oscillating in the direction parallel to the longitudinal axis of the rail track (x-axis of the rail track).

The at least one ultrasonic shear bulk wave transducer may comprise at least one ultrasonic shear bulk wave transducer with a direction of polarisation parallel to a lateral axis of the rail track (y-axis of the rail track, across the width of the rail track), whereby the at least one ultrasonic shear bulk wave transducer is configured to detect an ultrasonic shear bulk wave signal reflected from the interface and oscillating in the direction parallel to the lateral axis of the rail track (y axis of the rail track).

The at least one ultrasonic shear bulk wave transducer may comprise at least one ultrasonic shear bulk wave transducer with a direction of polarisation parallel to an axis angled between the longitudinal axis of the rail track (x axis of the rail track) and the lateral axis of the rail track (y-axis of the rail track), whereby the at least one ultrasonic shear bulk wave transducer is configured to detect an ultrasonic shear bulk wave signal reflected from the interface and oscillating in the direction parallel to the axis angled between the longitudinal axis and lateral axis of the rail track.

By having ultrasonic shear bulk wave transducers of different polarisations, the ultrasonic sensor is a multi-polarisation bulk wave ultrasonic sensor.

When the rail vehicle wheel passes over and contacts the interface surface of the sensing region of the rail track, the interface formed at the interface surface of the sensing region may comprise a wheel-track interface formed between the rail vehicle wheel and the interface surface. Hence, to understand rail vehicle-rail track interaction at the interface surface of the rail track, the ultrasonic sensor may be configured to detect bulk wave signals reflected from the wheel-rail track interface when the rail vehicle wheel passes over and contacts the interface surface of the rail track.

For example, the ultrasonic sensor may comprise:
at least one ultrasonic longitudinal bulk wave transducer configured to detect an ultrasonic longitudinal bulk wave signal reflected from the wheel-rail track interface; and
at least one ultrasonic shear bulk wave transducer configured to detect an ultrasonic shear bulk wave signal reflected from the wheel-rail track interface.

For example, the ultrasonic sensor may comprise:
a plurality of ultrasonic longitudinal bulk wave transducers, whereby each transducer is configured to detect an ultrasonic longitudinal bulk wave signal reflected from the wheel-rail track interface.

For example, the ultrasonic sensor may comprise:
a plurality of ultrasonic shear bulk wave transducers, whereby each transducer is configured to detect an ultrasonic shear bulk wave signal reflected from the wheel-rail track interface.

The interface formed at the interface surface of the sensing region may comprise a reference interface when the interface surface is in a known, reference state. As a result, the ultrasonic sensor may be configured to detect bulk wave signals reflected from the reference interface. The reference interface may comprise an air-rail track interface formed between the atmosphere and the rail track when the interface surface is exposed to the environmental atmosphere and there is no contact with the rail vehicle. Hence, the ultrasonic sensor may be configured to detect bulk wave signals reflected from the air-rail track interface.

For example, the ultrasonic sensor may comprise:
at least one ultrasonic longitudinal bulk wave transducer configured to detect a reference ultrasonic longitudinal bulk wave signal reflected from the reference interface; and
at least one ultrasonic shear bulk wave transducer configured to detect a reference ultrasonic shear bulk wave signal reflected from the reference interface.

For example, the ultrasonic sensor may comprise:
a plurality of ultrasonic longitudinal bulk wave transducers, whereby each transducer is configured to detect an ultrasonic longitudinal bulk wave signal reflected from the reference interface.

For example, the ultrasonic sensor may comprise:
a plurality of ultrasonic shear bulk wave transducers, whereby each transducer is configured to detect an ultrasonic shear bulk wave signal reflected from the reference interface.

The ultrasonic sensor may be configured to continuously or intermittently detect bulk wave signals reflected from the interface over a predetermined period of time. By detecting bulk wave signals over time, a bulk wave signal pattern, characteristic pattern of the bulk wave signal and/or. VTI parameter pattern of the bulk wave signal may be determined. The ultrasonic sensor may be configured to detect reflected bulk wave signals for a predetermined period of time as a rail vehicle travels along a rail track with respect to the sensing region. The bulk wave signal pattern indicates how vehicle-rail track interaction varies at the sensing region over the predetermined period of time.

For example, the ultrasonic sensor may be configured to detect reflected bulk wave signals over the predetermined period of time as each wheel of a rail vehicle with multiple axles passes over and contacts the interface surface.

For example, the ultrasonic sensor may be configured to continuously or intermittently detect reflected bulk wave signals for a predetermined period of time as a rail vehicle travels along a rail track relative to the sensing region from an upstream to a downstream position.

For example, the ultrasonic sensor may be configured to detect bulk wave signals over a period of time when a variable interface forms at the interface surface.

For example, the ultrasonic sensor may comprise:
at least one ultrasonic longitudinal bulk wave transducer configured to continuously or intermittently detect an ultrasonic longitudinal bulk wave signal reflected from the interface over a predetermined period of time; and
at least one ultrasonic shear bulk wave transducer configured to continuously or intermittently detect an ultrasonic shear bulk wave signal reflected from the interface over the predetermined period of time.

For example, the ultrasonic sensor may comprise:
a plurality of ultrasonic longitudinal bulk wave transducers, whereby each transducer is configured to continuously or intermittently detect an ultrasonic longitudinal bulk wave signal reflected from the interface over a predetermined period of time.

For example, the ultrasonic sensor may comprise:
a plurality of ultrasonic shear bulk wave transducers, whereby each transducer is configured to continuously or intermittently detect an ultrasonic shear bulk wave signal reflected from the interface over a predetermined period of time.

The ultrasonic sensor may be mountable on the rail track so as to detect reflected bulk wave signals that propagate through the sensing region of rail track following reflection from the interface surface. The interface surface may comprise a track tread region at the sensing region. Additionally or alternatively, the interface surface may comprise a track gauge region of the sensing region. As such, the ultrasonic sensor may be mountable on the rail track to form the sensing region whereby the interface surface comprises a track tread region to allow for monitoring of VTI between the wheel tread and track tread region. The ultrasonic sensor may be mountable on the rail track to form a sensing region whereby the interface surface comprises a track gauge region to allow for monitoring of VTI between the wheel flange and track gauge region. For example, the ultrasonic sensor may be mounted on the underside of a foot of the rail track, on a web of the rail track, embedded within the rail track via a hole, slot or recess and/or on a head of the rail track. The ultrasonic sensor may be mounted on the rail track by being arranged between a rail track and a mount on which the rail track is mounted. The ultrasonic sensor may be embedded within a mount on which the rail track is mounted. The mount may be a sleeper or pad. When the ultrasonic sensor is mounted on the rail track, the transducers may be configured to detect reflected bulk wave signals that propagate through the sensing region of the rail track from the interface surface in a direction parallel to a vertical axis of the rail track (z axis of the rail track).

The at least one ultrasonic longitudinal bulk wave transducer and/or at least one ultrasonic shear bulk wave transducer may be a piezo-electric transducer, an electromagnetic acoustic transducer (EMAT), a laser transducer, a piezo-electric micromachined ultrasonic transducer (pMUT), a capacitive micromachined ultrasonic transducers (cMUT), a direct-write transducer (DWT), Fibre-Bragg transducer or any other suitable ultrasonic transducer.

The ultrasonic sensor may comprise surface wave transducers to detect ultrasonic surface wave signals, whereby the surface wave signals propagate along a rail track surface at the sensing region of the rail track.

In an example, the ultrasonic sensor may comprise:
at least one ultrasonic longitudinal surface wave transducer configured to detect an ultrasonic longitudinal surface wave signal propagating along the rail track surface at the sensing region of the rail track; and
at least one ultrasonic shear surface wave transducer configured to detect an ultrasonic shear surface wave signal propagating along the rail track surface at the sensing region of the rail track.

By having at least one ultrasonic longitudinal surface wave transducer and at least one ultrasonic shear surface wave transducer, the ultrasonic sensor is a multi-planar ultrasonic surface wave sensor. The multi-planar ultrasonic surface wave sensor allows for the simultaneous detection of surface wave signals by the at least one ultrasonic longitudinal surface wave transducer and at least one ultrasonic shear surface wave transducer in real time.

In an example, the ultrasonic sensor may comprise:
a plurality of ultrasonic longitudinal surface wave transducers, whereby each transducer is configured to detect an ultrasonic longitudinal surface wave signal propagating along the rail track surface at the sensing region of the rail track.

As a result, the ultrasonic sensor allows for the simultaneous detection of longitudinal surface wave signals by the plurality of ultrasonic longitudinal surface wave transducers in real time.

In an example, the ultrasonic sensor may comprise:
a plurality of ultrasonic shear surface wave transducers, whereby each transducer is configured to detect an ultrasonic shear surface wave propagating along the rail track surface at the sensing region of the rail track.

Hence, the ultrasonic sensor allows for simultaneous detection of shear surface wave signals by the plurality of ultrasonic shear surface wave transducers in real time.

If the ultrasonic sensor comprises at least one ultrasonic longitudinal surface wave transducer, the at least one longitudinal surface wave transducer may be configured to operate at a predetermined frequency. As such, the at least one longitudinal surface wave transducer may be configured to detect a longitudinal surface wave signal with the predetermined frequency.

If the ultrasonic sensor comprises a plurality of ultrasonic longitudinal surface wave transducers, the plurality of ultrasonic longitudinal surface wave transducer may be configured to operate at different predetermined frequencies. As a result, the ultrasonic sensor may be configured to detect ultrasonic longitudinal surface wave signals with the different predetermined frequencies.

For example, the ultrasonic sensor may comprise:
at least one longitudinal surface wave transducer operating at a first longitudinal surface wave frequency; wherein the at least one longitudinal surface wave transducer is configured to detect a longitudinal surface wave signal propagating along the rail track surface at the sensing region of the rail track at the first frequency; and
at least one ultrasonic longitudinal surface wave transducer operating at a second longitudinal surface wave frequency that is different to the first frequency, wherein the at least one longitudinal surface wave transducer is configured to detect a longitudinal surface wave signal propagating along the rail track surface at the sensing region of the rail track at the first frequency.

Likewise, if the ultrasonic sensor comprises at least one shear surface wave transducer, the at least one ultrasonic shear surface wave transducer may be configured to operate at a predetermined frequency. As such, the at least one shear surface wave transducer may be configured to detect an ultrasonic shear surface wave signal with the predetermined frequency.

If the ultrasonic sensor comprises at plurality of shear surface wave transducers, the plurality of ultrasonic shear surface wave transducers may be configured to operate at different predetermined frequencies. As such, the ultrasonic sensor may be configured to detect ultrasonic shear surface wave signals with the different predetermined frequencies.

For example, the ultrasonic sensor may comprise:
at least one ultrasonic shear bulk surface transducer operating at a first shear surface wave frequency, wherein the at least one shear surface wave transducer is configured to detect a shear surface wave signal propagating along the rail track surface at the sensing region of the rail track with the first frequency; and
at least one ultrasonic shear bulk wave transducer operating at a second shear surface wave frequency that is different to the first frequency, wherein the at least one shear surface wave transducer is configured to detect a shear surface wave signal propagating along the rail track surface at the sensing region of the rail track with the second frequency.

By having ultrasonic surface wave transducers operating at different frequencies, the ultrasonic sensor is a multi-frequency surface wave ultrasonic sensor.

If the ultrasonic sensor comprises at least one ultrasonic shear surface wave transducer, the at least one ultrasonic shear surface wave transducer may have a predetermined direction of polarisation. As such, the at least one ultrasonic shear surface wave transducer may be configured to detect a shear surface wave signal oscillating in the predetermined direction of polarisation.

If the ultrasonic sensor comprises a plurality of ultrasonic shear surface wave transducers, the plurality of ultrasonic shear surface wave transducers may have different predetermined directions of polarisation. As a result, the ultrasonic sensor may be configured to detect ultrasonic shear surface waves oscillating in the different predetermined direction of polarisation.

For example, when the ultrasonic sensor comprises a plurality of ultrasonic shear surface wave transducers, the ultrasonic sensor may comprise:
at least one ultrasonic shear surface wave transducer with a first shear surface wave direction of polarisation, whereby the at least one ultrasonic shear surface wave transducer to detect a shear surface wave signal propagating along the rail track surface at the sensing region of the rail track and oscillating in the first direction of polarisation; and
at least one ultrasonic shear surface wave transducer with a second shear surface wave direction of polarisation different to the first direction of polarisation, whereby the at least one ultrasonic shear surface wave transducer is configured to detect a shear surface wave signal propagating along the rail track surface at the sensing region of the rail track and oscillating in the second direction of polarisation.

The at least one ultrasonic shear surface wave transducer may comprise at least one ultrasonic shear surface wave transducer with a direction of polarisation parallel to a longitudinal axis of the rail track (x-axis of the rail track, along the length of the rail track), whereby the at least one ultrasonic shear surface wave transducer is configured to detect an ultrasonic shear surface wave signal propagating along the rail track surface at the sensing region of the rail track and oscillating in the direction parallel to the longitudinal axis of the rail track (x-axis of the rail track).

The at least one ultrasonic shear surface wave transducer may comprise at least one ultrasonic shear surface wave transducer with a direction of polarisation parallel to a lateral axis of the rail track (y-axis of the rail track, across the width of the rail track), whereby the at least one ultrasonic shear surface wave transducer is configured to detect a ultrasonic shear surface wave signal propagating along the rail track surface at the sensing region of the rail track and oscillating in the direction parallel to the lateral axis of the rail track (y axis of the rail track).

The at least one ultrasonic shear surface wave transducer may comprise at least one ultrasonic shear surface wave transducer with a direction of polarisation parallel to an axis angled between the longitudinal axis and lateral axis of the rail track, whereby the at least one ultrasonic shear surface wave transducer is configured to detect an ultrasonic shear surface wave signal propagating along the rail track surface at the sensing region of the rail track and oscillating in the direction parallel to the axis angled between the longitudinal axis and lateral axis of the rail track.

By having ultrasonic shear surface wave transducers of different polarisations, the ultrasonic sensor is a multi-polarisation surface wave ultrasonic sensor.

To understand rail vehicle-rail track interaction at the sensing region of the rail track, the ultrasonic sensor may be configured to detect surface wave signals propagating along the rail track surface at the sensing region of the rail track as the rail vehicle wheel passes over the interface surface of the sensing region of the rail track and the wheel-rail track interface forms. In other words, the transducers may be configured to detect surface wave signals when the interface formed at the interface surface comprises a wheel-rail track interface.

For example, the ultrasonic sensor may comprise:
at least one ultrasonic longitudinal surface wave transducer configured to detect an ultrasonic longitudinal surface wave signal propagating along the rail track surface at the sensing region of the rail track as the rail vehicle wheel passes over the interface surface of the sensing region of the rail track; and
at least one ultrasonic shear surface wave transducer configured to detect an ultrasonic shear surface wave signal propagating along the rail track surface at the sensing region of the track as the rail vehicle wheel passes over the interface surface of the sensing region of the rail track.

For example, the ultrasonic sensor may comprise:
a plurality of ultrasonic longitudinal surface wave transducers, whereby each transducer is configured to detect an ultrasonic longitudinal surface wave signal propagating along the rail track surface at the sensing region of the rail track as the rail vehicle wheel passes over the interface surface of the sensing region of the rail track.

In an example, the ultrasonic sensor may comprise:
a plurality of ultrasonic shear surface wave transducers, whereby each transducer is configured to detect an ultrasonic shear surface wave propagating along the rail track surface at the sensing region of the rail track as the rail vehicle wheel passes over the interface surface of the sensing region of the rail track.

The ultrasonic sensor may be configured to detect surface wave signals when the interface surface is exposed to the atmosphere, and the interface formed at the interface surface comprises an air-rail track interface.

For example, the ultrasonic sensor may comprise:
at least one ultrasonic longitudinal surface wave transducer configured to detect an ultrasonic longitudinal surface wave signal propagating along the rail track surface at the sensing region of the rail track when the interface surface of the sensing region is exposed to the atmosphere; and
at least one ultrasonic shear surface wave transducer may be configured to detect an ultrasonic shear surface wave signal propagating along the rail track surface at the sensing region of the track when the interface surface of the sensing region of the rail track is exposed to the atmosphere.

For example, the ultrasonic sensor may comprise:
a plurality of ultrasonic longitudinal surface wave transducers, whereby each transducer is configured to detect an ultrasonic longitudinal surface wave signal propagating along the rail track surface at the sensing region of the rail track when the interface surface of the sensing region of the rail track is exposed to the atmosphere.

For example, the ultrasonic sensor may comprise:
a plurality of ultrasonic shear surface wave transducers, whereby each transducer is configured to detect an ultrasonic shear surface wave propagating along the rail track surface at the sensing region of the rail track when interface surface of the sensing region of the rail track is exposed to the atmosphere.

The ultrasonic sensor may be configured to detect surface wave signals when the interface formed at the interface surface comprises a known, reference interface.

For example, the ultrasonic sensor may comprise:
the at least one ultrasonic longitudinal surface wave transducer may be configured to detect a reference ultrasonic longitudinal surface wave signal propagating along the rail track surface at the sensing region of the rail track when the interface surface of the sensing region of the rail track is in a reference state; and
the at least one ultrasonic shear surface wave transducer may be configured to detect a reference ultrasonic shear surface wave signal propagating along the rail track surface at the sensing region of the rail track when the interface surface of the sensing region of the rail track is in the reference state.

For example, the ultrasonic sensor may comprise:
a plurality of ultrasonic longitudinal surface wave transducers, whereby each transducer is configured to detect an ultrasonic longitudinal surface wave signal propagating along the rail track surface at the sensing region of the rail track when the interface surface of the sensing region of the rail track is in a reference state.

For example, the ultrasonic sensor may comprise:
a plurality of ultrasonic shear surface wave transducers, whereby each transducer is configured to detect an ultrasonic shear surface wave propagating along the rail track surface at the sensing region of the rail track when the interface surface of the sensing region of the rail track is in a reference state.

The ultrasonic sensor may be configured to continuously or intermittently detect surface wave signals over a predetermined period of time. By detecting surface wave signals over time, a surface wave signal pattern, characteristics pattern of the surface wave signal and/or VTI parameter pattern of surface wave signal can be determined. The ultrasonic sensor may be configured to detect surface wave signals propagating along the rail track surface at the sensing region of the rail track as the rail vehicle travels along the track relative to the sensing region. The surface wave signal pattern indicates how vehicle-rail track interaction varies at the sensing region of the rail track over the predetermined period of time.

For example, the ultrasonic sensor may be configured to detect surface wave signals over a period of time as a rail vehicle with multiple axles passes over the interface surface of the sensing region of the rail track.

For example, the ultrasonic sensor may be configured to continuously or intermittently detect surface wave signals for a predetermined period of time as a rail vehicle travels along a rail track relative to the sensing region from an upstream to a downstream position.

For example, the ultrasonic sensor may be configured to detect surface wave signals over a period of time when a variable interface forms at the interface surface.

For example, the ultrasonic sensor may comprise:
the at least one ultrasonic longitudinal surface wave transducer configured to continuously or intermittently detect an ultrasonic longitudinal surface wave signal propagating along the rail track surface at the sensing region of the rail track over a predetermined time period; and
the at least one ultrasonic shear surface wave transducer configured to continuously or intermittently detect an ultrasonic shear surface wave signal propagating along the rail track surface at the sensing region of the rail track over the predetermined time period.

For example, the ultrasonic sensor may comprise:
a plurality of ultrasonic longitudinal surface wave transducers, where each transducer is configured to continuously or intermittently detect an ultrasonic longitudinal surface wave signal propagating along the rail track surface at the sensing region of the rail track over a predetermined time period.

For example, the ultrasonic sensor may comprise:
a plurality of ultrasonic shear surface wave transducers, where each transducer is configured to continuously or intermittently detect an ultrasonic shear surface wave signal propagating along the rail track surface at the sensing region of the rail track over a predetermined time period.

The ultrasonic sensor may be mountable on the rail track so as to detect surface waves propagating along the surface of the rail track in the sensing region of the rail track. The surface of the rail track in the sensing region along which the surface waves propagate may comprise the interface surface of the sensing region at which in interface forms. Alternatively, the surface of the rail track in the sensing region along which the surface waves propagate may be separate and spaced from the interface surface of the sensing region. As such, the ultrasonic sensor may be mountable on the rail track to form a sensing region whereby the rail track surface at the sensing region comprises the interface surface. The ultrasonic sensor may be mountable on the rail track to form a sensing region whereby the rail track surface at the sensing region is separate and spaced apart from the interface surface. For example, the ultrasonic sensor may be mounted on the foot of the rail track (e.g. the underside of the foot), the web of the rail track and/or the head of the rail track. When the ultrasonic sensor is mounted on the rail track, the transducers may be configured to detect surface wave signals that propagate along the surface of the rail track in a direction parallel to the lateral axis of the rail track (y axis of the rail track) or in a direction parallel to the longitudinal axis of the rail track (x-axis of the rail track).

The at least one ultrasonic longitudinal surface wave transducer and/or at least one ultrasonic shear surface wave transducer may be a piezo-electric transducer, an electromagnetic acoustic transducer (EMAT), a laser transducer, a piezo-electric micromachined ultrasonic transducer (pMUT), a capacitive micromachined ultrasonic transducers (cMUT), a direct-write transducer (DWT), a Fibre-Bragg transducer or any other suitable ultrasonic transducer.

The at least one ultrasonic longitudinal wave transducer and/or at least one ultrasonic shear wave transducer may be arranged as a pair.

The at least one ultrasonic longitudinal wave transducer and/or at least one ultrasonic shear wave transducer may be arranged in a linear array.

The at least one ultrasonic longitudinal wave transducer and/or at least one ultrasonic shear wave transducer may be arranged in a two-dimensional array.

The at least one ultrasonic longitudinal wave transducer and/or at least one ultrasonic shear wave transducer may be arranged on a rigid or flexible backing plate, for example a flexible printed circuit board.

When mounted on a flexible backing plate, the ultrasonic sensor may be mounted and conform to a curved surface of the rail track.

The ultrasonic sensor may be permanently mounted or removably mounted on the rail track or adjacent the rail track.

The ultrasonic sensor may be clamped, bonded or coupled to the rail track or adjacent the rail track.

The apparatus may comprise a clamp to mount the ultrasonic sensor on the rail track.

The ultrasonic sensor may comprise damping to provide a controlled damping effect when detecting wave signals.

The damping may be configured to provide a high damping effect or a low damping effect.

The damping may be configured to provide a selective frequency bandwidth of the ultrasonic sensor.

The damping may comprise a damping layer having a predetermined acoustic impedance to achieve the desired controlled damping effect. The backing layer may comprise a predetermined acoustic impedance to achieve the desired controlled damping effect.

If the ultrasonic sensor comprises at least one ultrasonic longitudinal bulk wave transducer configured to detect a reflected ultrasonic longitudinal bulk wave signal, the at least one ultrasonic longitudinal bulk wave transducer may be further configured to operate in a pulse-echo mode at the sensing region of the rail track whereby the at least one ultrasonic longitudinal wave bulk wave transducer is further configured to emit an ultrasonic longitudinal wave signal to propagate a path through the sensing region of rail track to the interface formed at the interface surface of the sensing region.

As such, in the sensing region of the rail track, the ultrasonic longitudinal bulk wave transducer is configured to emit a ultrasonic longitudinal bulk wave signal to propagate a forward path through the sensing region of the rail track towards the interface, wherein at least a proportion of the ultrasonic longitudinal bulk wave signal is reflected from the interface and propagates a return path through the sensing region rail track, and the ultrasonic longitudinal bulk wave transducer is configured to detect the reflected ultrasonic longitudinal bulk wave signal.

If the ultrasonic sensor comprises at least one ultrasonic longitudinal bulk wave transducer configured to detect a reflected ultrasonic longitudinal bulk wave signal, and this transducer is a detecting-only ultrasonic longitudinal bulk wave transducer, the ultrasonic sensor may further comprise at least one corresponding emitting ultrasonic longitudinal bulk wave transducer configured to emit an ultrasonic longitudinal bulk wave signal to propagate through the sensing region of the rail track to the interface formed at the interface surface of the sensing region of the rail track. The emitting ultrasonic longitudinal bulk wave transducer and the detecting ultrasonic longitudinal bulk wave transducer are configured to operate in pitch-catch mode at the sensing region of the rail track.

As such, the emitting ultrasonic longitudinal bulk wave transducer is configured to emit an ultrasonic longitudinal bulk wave signal to propagate a path through the sensing region of the rail track to the interface, wherein at least a proportion of the ultrasonic longitudinal bulk wave signal is reflected at the interface formed at the interface surface and propagates a path through the sensing region of rail track, and the detecting ultrasonic longitudinal wave bulk transducer is configured to detect the reflected ultrasonic longitudinal bulk wave signal.

The emitting ultrasonic longitudinal bulk wave transducer and the corresponding detecting ultrasonic longitudinal wave transducer operating in pitch-catch mode in the sensing region of the rail track may be arranged in an array.

For example, the ultrasonic sensor may comprise:
a first ultrasonic longitudinal bulk wave sensor unit mounted on the rail track at a first longitudinal bulk wave location wherein the first sensor unit comprises an emitting ultrasonic longitudinal bulk wave transducer configured to emit an ultrasonic longitudinal bulk wave signal to propagate through the sensing region of the rail track to the interface formed at the interface surface of the sensing region, wherein at least a proportion of the ultrasonic longitudinal bulk wave signal is reflected from the interface and propagates through the sensing region; and
a second longitudinal bulk wave sensor unit mounted on the rail track at a second longitudinal bulk wave location wherein the second sensor unit comprises a corresponding detecting ultrasonic longitudinal bulk wave transducer configured to detect the ultrasonic longitudinal bulk wave signal reflected from the interface.

If the ultrasonic sensor comprises at least one ultrasonic shear bulk wave transducer configured to detect a reflected ultrasonic shear bulk wave signal, the at least one ultrasonic shear bulk wave transducer may be configured to operate in a pulse-echo mode in the sensing region of the rail track whereby the ultrasonic shear bulk wave transducer is further configured to emit the ultrasonic shear bulk wave signal rail to propagate in through the sensing region of the rail track towards the interface formed at the interface surface of the sensing region.

As such, the ultrasonic shear bulk wave transducer is configured to emit the ultrasonic shear bulk wave signal to propagate in a forward path through the rail track towards the interface, wherein at least a proportion of the ultrasonic shear bulk wave signal is reflected at the interface and propagates in a return path through the sensing region of the rail track, and the ultrasonic shear bulk wave transducer is configured to detect the reflected ultrasonic shear bulk wave signal.

If the ultrasonic sensor comprises at least one ultrasonic shear bulk wave transducer configured to detect a reflected ultrasonic shear bulk wave signal, and this transducer is a detecting-only ultrasonic shear bulk wave transducer, the ultrasonic sensor may further comprise at least one corresponding emitting ultrasonic shear bulk wave transducer configured to emit an ultrasonic shear bulk signal to propagate through the sensing region of the rail track towards the interface formed at the interface surface of the rail track. The emitting ultrasonic shear bulk wave transducer and the detecting ultrasonic shear bulk wave transducer are configured to operate in pitch-catch mode in the sensing region of the rail track.

As such, the emitting ultrasonic shear bulk wave transducer is configured to emit an ultrasonic shear bulk wave signal to propagate through the rail track to the interface, wherein at least a proportion of the ultrasonic shear bulk wave signal is reflected at the interface and propagates through the sensing region of the rail track, and the detecting ultrasonic shear bulk wave transducer is configured to detect the reflected ultrasonic shear bulk wave signal.

The emitting ultrasonic shear bulk wave transducer and the corresponding detecting ultrasonic shear bulk wave transducer operating in pitch-catch mode in the sensing region in the rail track may be arranged in an array.

For example, the ultrasonic sensor may comprise:
a first shear bulk wave sensor unit arranged at a first shear bulk wave location on the rail track wherein the first sensor unit comprises an emitting ultrasonic shear bulk wave transducer configured to emit an ultrasonic shear wave signal through the sensing region of the rail track to the interface formed at the interface surface of the sensing region of the rail track, wherein at least a proportion of the ultrasonic shear bulk wave signal is reflected from the interface and propagates through the sensing region; and
a second shear bulk wave sensor unit arranged at a second shear bulk wave location on the rail track wherein the second sensor unit comprises a corresponding detecting ultrasonic shear bulk wave transducer configured to detect the reflected ultrasonic shear bulk wave signal.

If the ultrasonic sensor comprises at least one ultrasonic longitudinal surface wave transducer configured to detect a longitudinal surface wave signal in the sensing region of the rail track, and this transducer is a detecting-only ultrasonic longitudinal surface wave transducer, the ultrasonic sensor may comprise at least one corresponding emitting ultrasonic longitudinal surface wave transducer configured to emit an ultrasonic longitudinal surface wave to propagate along the rail track surface in the sensing region of the rail track.

As such, the emitting ultrasonic longitudinal surface wave transducer is configured to emit an ultrasonic longitudinal surface wave signal along the rail track surface and the corresponding detecting ultrasonic longitudinal surface wave transducer is configured to detect the surface wave signal propagating along the surface of the rail track.

If the ultrasonic sensor comprises at least one ultrasonic shear surface wave transducer configured to detect a shear surface wave, and this transducer is a detecting-only ultrasonic shear surface wave transducer, the ultrasonic sensor may comprise at least one corresponding emitting ultrasonic shear surface wave transducer configured to emit an ultrasonic shear surface wave to propagate along the rail track surface in the sensing region of the rail track.

As such, the emitting ultrasonic shear surface wave transducer is configured to emit an ultrasonic shear surface wave signal along the rail track surface and the corresponding detecting ultrasonic shear surface wave transducer is configured to detect the ultrasonic shear wave signal propagating along the rail track surface.

The apparatus may comprise multiple ultrasonic sensors for sensing vehicle-rail track interaction in parallel rail tracks.

For example, the apparatus may comprise:
a first ultrasonic sensor mounted on a first rail track to sense the rail vehicle-rail track interaction at a first sensing region of a first rail track; and
a second ultrasonic sensor mounted on a second rail track to sense the rail vehicle-rail track interaction at a second sensing region of a second rail track, whereby the first rail track and second rail track are a parallel rail tracks, and the first ultrasonic sensor and second ultrasonic sensor are arranged in parallel.

The apparatus may comprise a processor configured to process the detected ultrasonic wave signals. The processor may be configured to:
determine a characteristic of a detected ultrasonic wave signal; and
determine a track interaction parameter based on the characteristic of the detected ultrasonic wave signal, wherein the characteristic of the detected ultrasonic wave signal is indicative of the vehicle track interaction parameter.

The characteristic of the detected ultrasonic wave signal may comprise the time of flight of the detected ultrasonic wave signal. The characteristic of the detected wave signal may comprise the amplitude of the detected wave signal.

The processor may be configured to determine the characteristic of the detected wave signal from the time domain and/or the frequency domain of the detected ultrasonic wave signal.

For example, to monitor vehicle-track interaction, the processor may be configured to process the ultrasonic wave signals detected as a rail vehicle travels along the rail track. The processor may be configured to:
determine a characteristic of a detected ultrasonic wave signal; and
determine a vehicle-track interaction parameter based on the characteristic of the detected ultrasonic wave signal, wherein the characteristic of the detected ultrasonic wave signal is indicative of the vehicle-track interaction parameter.

For example, when the ultrasonic sensor is configured to detect at least one longitudinal bulk wave signal reflected from the wheel-rail track interface and/or at least one shear bulk wave signal reflected from the wheel-rail track interface, the processor may be configured to:
determine a characteristic of the detected longitudinal bulk wave signal and/or the characteristic of the detected shear bulk wave signal; and
determine a vehicle track interaction parameter based on the characteristic of the detected longitudinal bulk wave signal and/or the characteristic of the detected shear bulk wave signal, wherein the characteristic of the detected longitudinal wave bulk signal and/or characteristic of the detected shear bulk wave signal is indicative of the vehicle track interaction parameter.

For example, when the ultrasonic sensor is configured to detect at least one longitudinal surface wave signal as the rail vehicle wheel passes over the sensing region of the rail track and/or at least one shear surface wave signal as the rail vehicle passes over the sensing region of the rail track, the processor may be configured to:
determine a characteristic of the detected longitudinal surface wave signal and/or the characteristic of the detected shear surface wave signal; and
determine a vehicle-track interaction parameter based on the characteristic of the detected longitudinal surface wave signal and/or the characteristic of the detected shear surface wave signal, wherein the characteristic of the detected longitudinal surface wave signal and/or characteristic of the detected shear surface wave signal is indicative of the vehicle-track interaction parameter.

The apparatus may be configured to determine the vehicle-track interaction parameter in real-time as the rail vehicle passes over the sensing region of the rail track forming the wheel-rail track interface.

To determine a vehicle-track interaction parameter, the processor may be configured to compare the characteristic of the ultrasonic wave signal detected as the rail vehicle is passing over the sensing region of the rial track and forming a wheel-track interface at the interface surface to a corresponding characteristic of a reference ultrasonic wave signal detected when the interface at the interface surface is known.

The processor may be configured to determine whether the characteristic of the detected ultrasonic wave signal (and thereby the detected track interaction parameter) is within a predetermined range, above a predetermined threshold, or below a predetermined threshold.

The processor may be configured to determine whether a change between the characteristic of the detected ultrasonic wave signal (and thereby the change in the track interaction parameter) is within a predetermined range, above a predetermined threshold or below a predetermined threshold.

The apparatus may further comprise an alarm, wherein the alarm is configured to activate when the change in the characteristic of the detected ultrasonic wave signal (and thereby the track interaction parameter) or the change in the characteristic of the ultrasonic wave signal (and thereby the change in the track interaction parameter) is outside the predetermined range, above the predetermined threshold or below the predetermined threshold. The alarm may comprise an audible alarm, user readable alarm and/or a visual alarm.

When the characteristic of the detected ultrasonic wave signal comprises amplitude, one or more vehicle-track interaction parameter may be derivable from the amplitude of the detected ultrasonic wave signal.

In an example, when the sensor is mounted on the rail track and the characteristic of the detected ultrasonic longitudinal wave signal (ultrasonic longitudinal bulk wave signal and/or ultrasonic longitudinal surface wave signal) comprises amplitude, the processor may be further configured to determine a percentage change in amplitude % A for each ultrasonic longitudinal wave signal (bulk and/or surface), whereby:

$$\% A σ = ( A σ wheel / A σ reference ) \times 100$$

wherein % Aσ is the percentage change in the amplitude of the ultrasonic longitudinal wave signal (bulk and/or surface);
wherein Aσwheel is the amplitude of the detected ultrasonic longitudinal signal (bulk and/or surface) as the rail vehicle wheel passes over the interface surface of the sensing region of the rail track forming the wheel-rail track interface;
wherein Aσreference is the amplitude of the detected ultrasonic longitudinal signal (bulk and/or surface) when the interface formed at the interface surface is a known, reference interface.

Having determined the percentage change in amplitude for the longitudinal wave signal (ultrasonic bulk wave signal and/or ultrasonic longitudinal surface wave signal), the processor may be further configured to determine vehicle-track interaction longitudinal parameter of normal interface stiffness (K_{RW})σ at the wheel-track interface, whereby:

$$( {K}_{R M /} ) σ = π fcp \sqrt{{( \frac{1}{\vert \% A σ \vert} )}^{2} - 1}$$

wherein (K_{RW})σ is the normal interface stiffness at the wheel-track interface derivable from the amplitude of the longitudinal ultrasonic wave signal (bulk and/or surface wave signal);
wherein f is the wave frequency;
wherein c is the acoustic velocity in the rail;
wherein ρ is density in the rail;
wherein |% Aσ| is the magnitude of proportion vector % Aσ.

If the ultrasonic sensor comprises ultrasonic longitudinal wave transducers (at least one ultrasonic longitudinal bulk wave transducer and/or at least one ultrasonic longitudinal surface wave transducer) with different frequencies, the processor may be configured to determine the normal interface stiffness for each frequency of the detected ultrasonic longitudinal wave signals (bulk and/or surface wave signal).

Likewise, in an example when the sensor is mounted on the rail track, and the characteristic of the detected ultrasonic shear wave signal (ultrasonic shear bulk wave signal and/or ultrasonic shear surface wave signal) comprises amplitude, the processor may be further configured to determine percentage change in amplitude % A for each ultrasonic shear wave signal (bulk and/or surface), whereby:

$$\% A τ = ( A τ wheel / A τ reference ) \times 100$$

wherein % Aτ is the percentage change in the amplitude of the ultrasonic shear wave signal (bulk and/or surface wave signal);
wherein Aτwheel is the amplitude of the detected ultrasonic shear signal (bulk and/or surface) when the wheel passes over the interface surface of the sensing region of the rail track forming the wheel-rail track interface;
wherein Aτreference is the amplitude of the detected ultrasonic shear signal (bulk and/or surface) when the interface at the interface surface is a known, reference track interface.

Having determined the determined the percentage change in amplitude of the ultrasonic shear wave signal (ultrasonic shear bulk signal and/or ultrasonic surface wave signal), the processor may be further configured to determine the shear interface stiffness (K_{RW})τ at the wheel-track interface, whereby:

$$( {K}_{RW} ) τ = π fc ρ \sqrt{{( \frac{1}{\vert \% A τ \vert} )}^{2} - 1}$$

wherein (K_{RW})τ is the shear interface stiffness at the wheel-track interface derivable from the amplitude of the ultrasonic shear wave signal (bulk and/or surface);
wherein f is the wave frequency;
wherein c is the acoustic velocity in the rail;
wherein ρ is density in the rail;
wherein |% Aτ| is the magnitude of proportion vector % Aτ.

If the ultrasonic sensor comprises shear wave transducers (at least one ultrasonic shear bulk wave transducer and/or at least one ultrasonic shear surface wave transducer) with different directions of polarisations, the processor may be configured to determine the shear interface stiffness in the different polarised directions from each of the differently polarised detected ultrasonic shear wave signals (bulk and/or surface) as the vehicle passes over the track.

If the ultrasonic sensor comprises shear wave transducers (at least one ultrasonic shear bulk wave transducer and/or at least one ultrasonic shear surface wave transducer) with different frequencies, the processor may be configured to determine the shear interface stiffness for each frequency of the detected ultrasonic shear wave signals (bulk and/or surface).

The processor may be configured to compare the normal interface stiffness (K_{RW})σ and the shear interface stiffness (K_{RW})τ by determining a difference in normal interface stiffness and shear interface stiffness ΔK and/or a percentage ratio between the normal interface stiffness and shear interface stiffness % K, whereby:

$$\begin{matrix}Δ K = {( {K}_{RW} )}_{σ} - {( {K}_{RW} )}_{τ} \\ \% K = ( {( {K}_{RW} )}_{τ} / {( {K}_{RW} )}_{σ} ) \times 100\end{matrix}$$

In an example, the processor may be configured to compare the normal interface stiffness (K_{RW})σ and the shear interface stiffness (K_{RW})τ to identify, for example, wheel slip, any third bodies between the wheel and rail track, a continuous liquid layer between the wheel and rail track, a mixed mode interface, and/or surface texturing and roughness at the wheel-rail track interface.

When the sensor is mounted on the rail track and the characteristic comprises the time of flight, one or more vehicle-track interaction parameter may be derivable from the time of flight of the detected ultrasonic wave signal. The one or more vehicle-track interaction parameter derivable from the time of flight of detected ultrasonic wave signals may comprise loading of the rail track (for example, multi-planar). For example, the time of flight of the detected ultrasonic longitudinal wave signal (ultrasonic longitudinal bulk wave signal and/or ultrasonic longitudinal surface wave signal) of the rail track may be indicative of normal (vertical) load V in the rail track and normal load in the rail track V. For example, the time of flight of the detected shear wave signal (ultrasonic shear bulk wave signal and/or ultrasonic shear surface wave signal) oscillating in a direction parallel to the lateral axis (y-axis) across the width of the rail track (and in a direction perpendicular to the longitudinal axis (x-axis) along the length of the rail track) may be indicative of lateral load Ly in the rail track. For example, the time of flight of the detected shear wave signal (bulk and/or surface) oscillating in a direction parallel to the longitudinal axis (x-axis) along the length of the rail track may be indicative of longitudinal load Lx acting in the rail track along the length of the rail track.

In an example, when the sensor is mounted on the rail track and the characteristic of the detected longitudinal wave signal (ultrasonic longitudinal bulk wave signal and/or ultrasonic longitudinal surface wave signal) and the detected shear wave signal with a lateral polarisation (ultrasonic shear bulk wave signal and/or ultrasonic shear surface wave signal) comprises the time of flight, the processor may be further configured to determine the time of flight ratio of:

$$\frac{ToF ( Lateral )}{ToF ( Vertical )}$$

wherein ToF (Lateral) is the time of flight of the detected shear wave signal (bulk and/or surface) oscillating in a lateral direction parallel to lateral axis (y-axis) across the width of the rail track and perpendicular to the longitudinal axis (x-axis) along the length of the rail track;
wherein ToF (Vertical) is the time of flight of the detected longitudinal wave signal.

Since the time of flight of the detected ultrasonic wave signal through the rail track is dependent on the load acting on the rail track at the interface surface, the time of flight ratio is indicative of the load ratio

$$\frac{Ly}{V}$$

wherein Ly is the lateral load of the rail track;
wherein V is the vertical load of the rail track.

When the ultrasonic sensor is mounted on the rail track and the characteristic comprises time of flight, the processor may be configured:
to identify a pattern in the detected longitudinal wave signal (ultrasonic longitudinal bulk wave signal and/or ultrasonic longitudinal surface wave signal) and/or the detected shear wave signal (ultrasonic shear bulk wave signal and/or ultrasonic shear surface wave signal).

The pattern in the detected ultrasonic wave signals is indicative of a changing rail track interaction, and the processor may be configured to determine the changing rail track interaction at the sensing region of the rail track based on the pattern.

The apparatus may further comprise a sensor to concurrently measure a different factor of the rail track as the ultrasonic sensor detects ultrasonic signals. For example, the apparatus may comprise at least one of a temperature sensor, acoustic emission sensor, accelerometer sensor, optical and/or audible range acoustic sensor.

The apparatus may comprise a processor configured to correlate one or more detected ultrasonic wave signal relating to a known vehicle-track interaction parameter with respect to one or more complementary sensor signals of complementary sensors to identify the signal feature in the complementary sensor signal that corresponds to the known vehicle-track interaction parameter.

The processor may train data to form a complementary sensor model for the known vehicle track interaction. Using the complimentary sensor model for the known vehicle-track interaction allows for the subsequent monitoring of the vehicle-track interaction using complementary sensors rather than ultrasonic sensors.

The apparatus for monitoring rail vehicle wheel-rail track interaction (VTI) may comprise:
the ultrasonic sensor mountable on a rail track at a sensing region of the rail track, whereby the sensing region comprises an interface surface at which an interface forms during monitoring;
a complementary sensor;
a processor configured:
   to receive an ultrasonic signal of the ultrasonic sensor, wherein the at least one ultrasonic signal comprises a known signal feature indicative of a known VTI parameter;
   to receive a complementary sensor signal of the complementary sensor, wherein the complementary sensor signal is detected concurrently with the ultrasonic signal of the ultrasonic sensor;
to correlate the known signal feature of the ultrasonic signal indicative of the known VTI parameter with signal features of the complementary sensor signal to identify a complementary signal feature of the complementary sensor signal indicative of the known VTI parameter; and
   to create a complimentary sensor model for the known VTI parameter based on the identified complementary signal feature of the complementary sensor signal indicative of the known VTI parameter.

A processor may be configured:
to receive an ultrasonic signal of a ultrasonic sensor, wherein the at least one ultrasonic signal comprises a known signal feature indicative of a known VTI parameter, wherein the ultrasonic sensor is mounted on the rail track at a sensing region of the rail track, whereby the sensing region comprises an interface surface at which a wheel-rail track interface forms when the rail vehicle wheel contacts the interface surface;
to receive a complementary sensor signal of the complementary sensor, wherein the complementary sensor signal is detected concurrently with the ultrasonic signal of the ultrasonic sensor;
to correlate the known signal feature of the ultrasonic signal indicative of the known VTI parameter with signal features of the complementary sensor signal to identify a complementary signal feature of the complementary sensor signal indicative of the known VTI parameter; and
to create a complementary sensor model for the known VTI parameter based on the identified complementary signal feature of the complementary sensor signal indicative of the known VTI parameter.

The ultrasonic sensor may comprise an ultrasonic sensor as previously explained and/or operating as previously explained.

The complementary sensor may comprise a temperature sensor, acoustic emission sensor, accelerometer, optical sensor, audible range acoustic sensor, and/or any other suitable non-ultrasonic sensor for detecting a VTI parameter.

A method of training a complementary sensor model for a VTI parameter may comprise:
receiving, at a processor, an ultrasonic signal of an ultrasonic sensor, wherein the ultrasonic signal comprises a known signal feature indicative of a known VTI parameter, wherein the ultrasonic sensor is mounted on the rail track at a sensing region of the rail track, whereby the sensing region comprises an interface surface at which a wheel-rail track interface forms when the rail vehicle wheel contacts the interface surface;
receiving, at the processor, a complementary sensory signal of a complementary sensor detected concurrently with the ultrasonic signal of the ultrasonic sensor;
correlating, using the processor, the known signal feature of the ultrasonic signal and signal features of the complementary sensor signal to identify a complementary signal feature of the complementary sensor signal indicative of the known VTI parameter;
creating, using the processor, a complementary sensor model for the known VTI parameter based on the identified complementary signal feature of the complementary sensor signal indicative of the known VTI parameter.

The ultrasonic sensor may comprise an ultrasonic sensor as previously explained and/or operating as previously explained. The complementary sensor may comprise a temperature sensor, acoustic emission sensor, accelerometer, optical sensor, audible range acoustic sensor, and/or any other suitable non-ultrasonic sensor for detecting a VTI parameter.

A computer readable medium may be encoded with instructions to execute the method for training the complimentary sensor moder for a VTI parameter in one or more clause.

An apparatus for monitoring rail vehicle wheel-rail track interaction (VTI) may comprise:
a processor configured:
   to receive a complementary sensor signal of a complementary sensor;
   to identify, using a complementary sensor model for a VTI parameter, a complimentary signal feature of the complementary sensor signal indicative of the VTI parameter.

A processor may be configured:
to receive a complementary sensor signal of a complementary sensor;
to identify, using a complementary sensor model for a VTI parameter, a complimentary signal feature of the complementary sensor signal indicative of the VTI parameter.

The complementary sensor may comprise a temperature sensor, acoustic emission sensor, accelerometer, optical sensor, audible range acoustic sensor, and/or any other suitable non-ultrasonic sensor for detecting a VTI parameter.

The complementary sensor model may be trained as explained previously.

The processor may be configured to determine, based on the complimentary signal feature and using the complementary sensor model, a metric of the VTI parameter.

The processor configured to activate an alarm if the VTI parameter is present and/or the metric of the VTI parameter is outside a threshold range, above a threshold and/or below a threshold.

An apparatus for monitoring VTI may comprise:
a complimentary sensor configured to detect a complementary sensor signal;
a processor comprising a complementary sensor model for a VTI parameter and configured to:
   to receive a complementary sensor signal of the complementary sensor;
   use the complementary sensor model to identify a complimentary signal feature of the complementary sensor signal indicative of the VTI parameter.

The complementary sensor may comprise a temperature sensor, acoustic emission sensor, accelerometer, optical sensor, audible range acoustic sensor, and/or any other suitable non-ultrasonic sensor for detecting a VTI parameter.

The complementary sensor model may be trained as explained previously.

The processor is configured to determine, based on the complimentary signal feature and using the complementary sensor model, a metric of the VTI parameter.

The apparatus may comprise an alarm configure to activate if the VTI parameter is present and/or the metric of the VTI parameter is outside a threshold range, above a threshold and/or below a threshold.

A method for monitoring VTI may comprise:
detecting, using a complimentary sensor, a complimentary sensor signal;
identifying, using a processor with a complimentary sensor model for a VTI parameter, a complementary signal feature of the complementary sensor signal indicative of the VTI parameter.

The complementary sensor may comprise a temperature sensor, acoustic emission sensor, accelerometer, optical sensor, audible range acoustic sensor, and/or any other suitable non-ultrasonic sensor for detecting a VTI parameter.

The complementary sensor model may be trained as explained previously.

The method may comprise determining, using the processor with the complementary sensor model, a metric of the VTI parameter based on the identified complementary signal feature.

The method may comprise triggering an alarm if the VTI parameter is present and/or the metric of the VTI parameter is outside a threshold range, above a threshold and/or below a threshold.

A computer readable medium encoded with instructions to execute the method for monitoring VTI using the processor with the complimentary sensor moder for a VTI parameter in one or more clause.

A further aspect of the disclosure relates to a method for ultrasonically sensing rail vehicle-track interaction.

In an example, a method for ultrasonically sensing rail vehicle-track interaction comprises:
mounting a multi-planar ultrasonic sensor on a rail track, wherein the ultrasonic sensor comprises at least one ultrasonic longitudinal bulk wave transducer and at least one ultrasonic shear bulk wave transducer;
detecting, using the at least one ultrasonic longitudinal bulk wave transducer, an ultrasonic longitudinal bulk wave signal reflected from an interface formed at an interface surface of a sensing region of the rail track;
detecting, using the at least one ultrasonic shear bulk wave transducer, an ultrasonic shear bulk wave signal reflected from the interface formed at the interface surface at a sensing region of the rail track
determining, using a processor, a characteristic of the detected longitudinal bulk wave signal and the corresponding characteristic of the detected shear bulk wave signal, wherein the characteristic comprises a time of flight and/or amplitude;
determining, using the processor, a vehicle-track interaction parameter based on the characteristic of the detected longitudinal bulk wave signal and/or the corresponding characteristic of the detected shear bulk wave signal, wherein the characteristic of the detected longitudinal bulk wave signal and corresponding characteristic of the detected shear bulk wave signal are indicative of the vehicle-track interaction parameter.

In an example, a method for ultrasonically sensing rail-vehicle track interaction comprises:
mounting an ultrasonic sensor on a rail track, wherein the ultrasonic sensor comprises a plurality of ultrasonic longitudinal bulk wave transducers each operating at the same predetermined frequency or a different predetermined frequency;
detecting, using each ultrasonic longitudinal bulk wave transducer, ultrasonic longitudinal bulk wave signals with the same predetermined frequency or different predetermined frequencies reflected from an interface formed at the interface surface region of a sensing region of the rail track;
determining, using a processor, a characteristic of the detected longitudinal bulk wave signals with the same predetermined frequency or different predetermined frequencies, wherein the characteristic is a time of flight and/or amplitude;
determining, using the processor, a vehicle-track interaction parameter based on the characteristic of the detected longitudinal bulk wave signals with the same predetermined frequency or different predetermined frequencies, wherein the characteristic of the detected longitudinal bulk wave signal is indicative of the vehicle-track interaction parameter.

A method for ultrasonically sensing rail-vehicle track interaction may additionally or alternatively comprise:
mounting an ultrasonic sensor on a rail track, wherein the ultrasonic sensor comprises a plurality of ultrasonic shear bulk wave transducers each operating at the same predetermined frequency or a different predetermined frequency;
detecting, using each ultrasonic shear bulk wave transducer, ultrasonic shear bulk wave signals with the same predetermined frequency or different predetermined frequencies reflected from an interface formed at an interface surface at a sensing region of the rail track;
determining, using a processor, a characteristic of the detected shear bulk wave signals with the same predetermined frequency or different predetermined frequencies, wherein the characteristic is a time of flight and/or amplitude;
determining, using the processor, a vehicle-track interaction parameter based on the characteristic of the detected shear bulk wave signals of same predetermined frequency or the different predetermined frequencies, wherein the characteristic of the detected shear bulk wave signal is indicative of the vehicle-track interaction parameter.

A method for ultrasonically sensing rail-vehicle track interaction may additionally or alternatively comprise:
mounting an ultrasonic sensor on a rail track, wherein the ultrasonic sensor comprises a plurality of ultrasonic shear bulk wave transducers each operating at the same predetermined direction of polarisation or different predetermined directions of polarisation;
detecting, using each ultrasonic shear bulk wave transducers, ultrasonic shear bulk wave signals with the same predetermined direction of polarisation or different predetermined directions of polarisation reflected from an interface formed at an interface surface of a sensing region of the rail track;
determining, using a processor, a characteristic of the detected shear bulk wave signals with the same predetermined direction of polarisation or different predetermined directions of polarisation, wherein the characteristic is a time of flight and/or amplitude;
determining, using the processor, a vehicle-track interaction parameter based on the characteristic of the detected shear bulk wave signals with the same predetermined direction of polarisation or the different predetermined directions of polarisation, wherein the characteristic of the detected shear longitudinal bulk wave signal is indicative of the vehicle-track interaction parameter.

In an example, a method for ultrasonically sensing rail-vehicle track interaction may comprise:
mounting a multi-planar ultrasonic sensor on a rail track, wherein the ultrasonic sensor comprises at least one ultrasonic longitudinal surface wave transducer and at least one ultrasonic shear surface wave transducer;
detecting, using the at least one ultrasonic longitudinal surface wave transducer, an ultrasonic longitudinal surface wave signal propagating along a rail track surface at a sensing region of the rail track;
detecting, using the at least one ultrasonic shear surface wave transducer, an ultrasonic shear wave signal propagating along the rail track surface at the sensing region of the rail track;
determining, using a processor, a characteristic of the detected longitudinal surface wave signal and the corresponding characteristic of the detected shear surface wave signal, wherein the characteristic comprises a time of flight and/or amplitude;
determining, using the processor, a vehicle-track interaction parameter based on the characteristic of the detected longitudinal surface wave signal and/or the corresponding characteristic of the detected shear surface wave signal, wherein the characteristic of the detected longitudinal surface wave signal and corresponding characteristic of the detected shear surface wave signal are indicative of the vehicle-track interaction parameter.

In an example, a method for ultrasonically sensing rail-vehicle track interaction may comprise:
mounting an ultrasonic sensor on a rail track, wherein the ultrasonic sensor comprises at a plurality of ultrasonic longitudinal surface wave transducers each operating at the same predetermined frequency or a different predetermined frequency;
detecting, using each ultrasonic longitudinal surface wave transducer, ultrasonic longitudinal surface wave signals with the same predetermined frequency or different predetermined frequencies propagating along a rail track surface at a sensing region of the rail track;
determining, using a processor, a characteristic of the detected longitudinal surface wave signals with the same predetermined frequency or different predetermined frequencies, wherein the characteristic comprises a time of flight and/or amplitude;
determining, using the processor, a vehicle-track interaction parameter based on the characteristic of the detected longitudinal surface wave signals with the same predetermined frequency or different predetermined frequencies, wherein the characteristic of the detected longitudinal surface wave signal is indicative of the vehicle-track interaction parameter.

In an example, a method for ultrasonically sensing rail-vehicle track interaction may comprise:
mounting an ultrasonic sensor on a rail track, wherein the ultrasonic sensor comprises at a plurality of ultrasonic shear surface wave transducers each operating at the same predetermined frequency or different predetermined frequency;
detecting, using each ultrasonic shear surface wave transducer, ultrasonic shear surface wave signals with the same predetermined frequency or different predetermined frequencies propagating along a rail track surface at a sensing region of the rail track;
determining, using a processor, a characteristic of the detected shear surface wave signals with the same predetermined frequency or different predetermined frequencies, wherein the characteristic comprises a time of flight and/or amplitude;
determining, using the processor, a vehicle-track interaction parameter based on the characteristic of the detected shear surface wave signals with the same predetermined frequency or different predetermined frequencies, wherein the characteristic of the detected shear surface wave signal is indicative of the vehicle-track interaction parameter.

In an example, a method for ultrasonically sensing rail-vehicle track interaction may comprise:
mounting an ultrasonic sensor on a rail track, wherein the ultrasonic sensor comprises at a plurality of ultrasonic shear surface wave transducers operating at the same predetermined direction of polarisation or different predetermined directions of polarisation;
detecting, using each ultrasonic shear surface wave transducer, ultrasonic shear surface wave signals with the same predetermined direction of polarisation or different directions of polarisation propagating along a rail track surface at the sensing region of the rail track;
determining, using a processor, a characteristic of the detected shear surface wave signals with the same predetermined direction of polarisation or different predetermined directions of polarisation, wherein the characteristic comprises a time of flight and/or amplitude;
determining, using the processor, a vehicle-track interaction parameter based on the characteristic of the detected shear surface wave signals with the same predetermined direction of polarisation or different predetermined directions or polarisation, wherein the characteristic of the detected shear surface wave signal is indicative of the vehicle-track interaction parameter.

### BRIEF DESCRIPTION OF DRAWINGS

The accompanying drawings illustrate examples of the disclosure, and together with the general description given above and the detailed description of the examples below, serve to explain the principles of the disclosure.

FIG. 1 depicts a cross-sectional view of a rail track;

FIG. 2 depicts the direction of oscillation and propagation of a longitudinal wave;

FIG. 3 depicts the direction of oscillation and propagation of a shear wave;

FIG. 4 depicts an example of a multi-planar ultrasonic sensor mounted on a rail track according to the present invention;

FIG. 5 depicts an example of a multi-planar ultrasonic sensor with different directions of polarisation according to the present invention;

FIG. 6 depicts an example of an ultrasonic sensor with surface wave transducers mounted on a rail track according to the present invention;

FIG. 7 depicts an example of an ultrasonic sensor with transducers mounted on a backing plate according to the present invention;

FIG. 8 depicts an alternative example of an ultrasonic sensor with transducers mounted on a backing plate according to the present invention;

FIG. 9 depicts a further alternative example of an ultrasonic sensor with transducers mounted on a backing plate according to the present invention;

FIGS. 10a to 10h depict examples of ultrasonic sensors according to the present invention;

FIGS. 11a, 11b and 11c depict an example of an ultrasonic sensor with negligible or no damping, the wave signal over time and frequency bandwidth response according to the present invention;

FIGS. 12a, 12b and 12c depict an example of an ultrasonic sensor with damping, the wave signal and frequency bandwidth response according to the present invention;

FIG. 13 depicts a graph showing the relationship between energy trapped in the transducer and the acoustic impedance of different damping materials according to the present invention;

FIG. 14 depicts a rail track with ultrasonic sensors mounted in different locations according to the present invention;

FIG. 15 depicts an example of a multi-sensor sensing probe according to the present invention;

FIG. 16 depicts an example of an ultrasonic sensor embedded in a rail track according to the present invention;

FIG. 17 depicts an example of an ultrasonic sensor arranged between a rail track foot and a mount according to the present invention;

FIGS. 18a and 18b depict an example of ultrasonic sensor with surface wave transducers mounted on a rail track according to the present invention;

FIGS. 19 and 20 depict an example of a clamp for mounting an ultrasonic sensor on a rail track according to the present invention;

FIG. 21 depicts an example of ultrasonic sensors mounted on parallel rail tracks according to the present invention;

FIGS. 22a and 22b depict an example of an ultrasonic sensor with sensing units mounted in spaced relationship along a rail track according to the present invention;

FIG. 23 depicts a graph of the change in the time of flight with respect to ultrasonic wave signals under load with different directions of polarisation according to the present invention;

FIG. 24a depicts a graph show the change in time of flight between two ultrasonic wave signals according to the present invention, FIGS. 24b and 24c show the time of flight change during a wheel pass event;

FIGS. 25a and 25b depict the change in wave signal amplitude for a ultrasonic wave signal deflected from an air-rail track interface and a wheel-rail track interface according to the present invention;

FIG. 26 depicts a change in time-amplitude graph of an ultrasonic wave signal according to the present invention;

FIG. 27 depicts a change in frequency-amplitude graph of an ultrasonic wave signal according to the present invention;

FIGS. 28 to 39 depict different amplitude and stiffness graphs of ultrasonic wave signals according to the present invention;

FIGS. 40 and 41 depict an example of a multi-frequency ultrasonic sensor and the frequency response graph according to the present invention;

FIG. 42 depicts an alternative example of a multi-frequency ultrasonic sensor according to the present invention;

FIGS. 43 and 44 depict amplitude-frequency graphs of a multi-frequency ultrasonic sensor according to the present invention;

FIG. 45 depicts a thickness-frequency graph for different examples of ultrasonic sensors according to the present invention;

FIG. 46 depicts an example of a multi-frequency ultrasonic sensor mounted on a rail track according to the present invention;

FIG. 47 depicts method steps of an example of a complementary analysis according to the present invention;

FIG. 48 depicts correlating ultrasonic wave signals according to the present invention.

### DETAILED DESCRIPTION

The disclosure relates to an apparatus and method for monitoring vehicle-track interaction (VTI) between a rail vehicle wheel and a rail track. The apparatus and method comprises an ultrasonic sensor mountable on the rail track at a sensing region of the rail track.

With the ultrasonic sensor, the apparatus and method may monitor the following rail vehicle-rail track interactions (VTIs) at the sensing region of the rail track:
Contact between the rail vehicle wheel and the rail track—including detecting wheel-rail track contact location, contact geometry, contact area, wheel tread-rail tread contact, wheel flange-rail gauge contact, and risk of wheel climb for vehicle speed optimization—which, in turn, can indicate other issues including camber gauge, cyclic top wheel, and unloading point;
Loading between the rail vehicle wheel and rail track—including detecting vertical loading, vertical strain, lateral loading, lateral strain, lateral and vertical loading ratio L/V, high lateral loads at risk locations—so as to determine maximum vehicle speeds and improve scheduling;
Axle loads—including detecting rail vehicle tonnage, overloading of rail vehicle, load imbalances (both side-to-side and end-to-end)—so as to reduce rail track wear, reduce rail track damage, reduce ballast disruption, reduce rail deflection, gauge and cant issues, and reduce tie damage;
Friction coefficient and/or traction so as to improve lubrication strategy;
Pummelling, yaw, angle of attack, wheel alignment track, hunting, wheel impact on the rail track, wheel flats, wheel slip, wheel-rail track wear, and rail track head defects;
Presence and characterisation of third body layers—including lubricant films, friction modifiers, leaf layers and ice—so as to improve friction management and understand seasonal risk areas;
Interfacial stiffness and pressure—so as to determine rail surface finish, surface roughness and traction—which, in turn, improves rail maintenance (milling and grinding) strategy; and/or
Trouble areas of rail track—including extreme wear, broken ties or ballast disruption—that could result in accelerated rail vehicle damage.

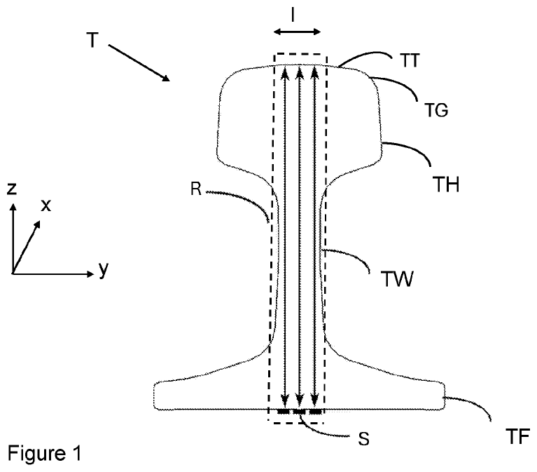

FIG. 1 depicts an example of a rail track (T) comprising a track head (TH), a track central web (TW) and a track foot (TF). The rail track has a longitudinal axis extending the length of the rail track (x-axis), a lateral axis extending the width of the axis (y-axis), and a vertical axis extending the height of the trail track (z-axis). The track head (TH) comprises a track tread surface (TT) and a track gauge surface (TG).

As shown in the example depicted in FIG. 1, an ultrasonic sensor(S) is mountable on the rail track (T) at a sensing region (R) of the rail track. The sensing region is a segment (portion) of the rail track monitored by the apparatus and method. The sensing region of the rail track comprises an interface surface (I) at which an interface forms during monitoring.

To monitor VTI, the interface may comprise a wheel-rail track interface formed at the interface surface between the rail vehicle wheel and the interface surface as the rail vehicle passes over and contacts the interface surface.

To allow for comparative analysis, the interface may comprise a reference interface formed at the interface surface when the interface is in a known reference state. The interface may be known when the interface surface is in contact with a known reference material and under a known reference load. For example, the reference interface may comprise an air-rail track interface formed at the interface surface between the environmental atmosphere and the interface surface when the interface surface is exposed to the environmental atmosphere and is out of contact with the rail vehicle wheel.

To monitor how VTI varies at the sensing region over time, the interface formed during monitoring may comprise a variable interface formed at the interface surface over a time period as the state of the interface varies over the time period. For example, the variable interface may form when the interface surface is in variable contact with the rail vehicle and under a variable rail vehicle load over the time period. The variable interface may form as the rail vehicle travels upstream towards the interface surface over the time period. The variable interface may form as the rail vehicle travels downstream away from the interface surface over the period of time.

The ultrasonic sensor may be mountable on the rail track to form a sensing region whereby the interface surface comprises a track tread surface region to allow for the monitoring of VTI between the wheel tread and track tread surface. The ultrasonic sensor may be mountable on the rail track to form a sensing region whereby the interface surface comprises a track gauge surface region to allow for the monitoring of VTI between the wheel flange and track gauge region.

In the example depicted in FIG. 1, the ultrasonic sensor(S) is mounted on the underside of the track foot (TF) and spans the width of the track web (TW). As such, the sensing region (R) formed by the ultrasonic sensor is a segment of the rail track with a height extending between the track foot and track tread surface (TT) and a cross-sectional width corresponding to the width of the track web. The interface surface (I) of the sensing region is a track tread surface region that corresponds to the width of the track web (TW).

### Ultrasonic Sensor Comprising Ultrasonic Bulk Wave Transducers

In an example, the ultrasonic sensor may comprise a plurality of bulk wave transducers.

For example, the ultrasonic sensor may comprise at least one (one or more) ultrasonic bulk wave transducer operating in longitudinal mode, and at least one (one or more) ultrasonic bulk wave transducer operating in shear mode.

For example, the ultrasonic sensor may comprise a plurality of ultrasonic bulk wave transducers operating in longitudinal mode.

For example, the ultrasonic sensor may comprise a plurality of ultrasonic bulk transducers operating in shear mode.

According to the principles of ultrasonic reflectometry, at least a proportion of an ultrasonic bulk wave is reflected at an interface of two materials. The proportion of the ultrasonic bulk wave reflected at an interface of two materials is commonly referred to as a “reflection coefficient R”. and is determined by following equation:

$$R = \frac{{z}_{2} - {z}_{1}}{{z}_{2} + {z}_{1}}$$

Where z₁ and z₂ are the acoustic impedances of the two materials bounding at the interface. According to the equation, the reflection coefficient R depends on the mismatch of the acoustic impedances of the two materials at the interface.

Since acoustic impedance is a product of the density and speed of sound in the material, an ultrasonic bulk wave propagates well through dense material but propagates poorly through materials of sparse particle density, such as air. Hence, the proportion of an ultrasonic bulk wave that is reflected at an interface varies according to the density of a contacting material at the interface. For example, at a solid-gas interface (for example, steel-air interface), the proportion of an ultrasonic bulk wave transmitted to the gas contacting material is limited and the ultrasonic bulk wave is substantially reflected back from the solid-gas interface. However, at a solid-solid interface, a greater proportion of an ultrasonic wave signal is transmitted to the solid contacting material and a remaining proportion of the ultrasonic bulk wave is reflected from the solid-solid interface. As a result, the proportion of an ultrasonic bulk wave reflected from a solid-gas interface is greater than the proportion of an ultrasonic bulk wave reflected from a solid-solid interface.

The ultrasonic sensor with the plurality of bulk wave transducers may be mounted on the rail track to detect ultrasonic bulk wave signals reflected from the interface formed at the interface surface of the sensing region that propagate through the sensing region of the rail track following reflection from the interface.

Hence, the ultrasonic sensor is mounted on the rail track to detect ultrasonic bulk waves reflected from the interface formed at the interface sensing region of the rail track at the sensing region.

To monitor vehicle-track interaction when the rail wheel passes over the interface surface of the sensing region of the rail track and the interface comprises a wheel-rail track interface, the ultrasonic sensor may be configured to detect the ultrasonic bulk wave signals reflected from the wheel-rail track interface. To provide a comparative analysis when the interface surface of the sensing region of the rail track is in a known reference state, the ultrasonic sensor may be configured to detect reference ultrasonic bulk waves reflected from the known reference track interface. To detect a sensing pattern over time, the ultrasonic sensor may be configured to detect ultrasonic bulk wave signals reflected from the interface over a period of time.

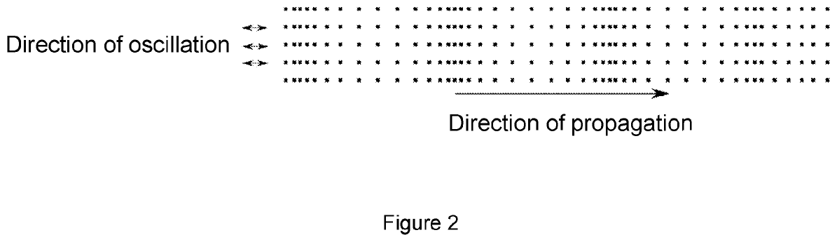

An ultrasonic bulk wave transducer operating in longitudinal mode is configured to detect a reflected ultrasonic longitudinal bulk wave signal, and so may be referred to as an ultrasonic longitudinal bulk wave transducer. As shown in FIG. 2, an ultrasonic longitudinal bulk wave signal has a direction of oscillation that is parallel to the direction of propagation through the rail track. As such, if the ultrasonic sensor comprises at least one ultrasonic longitudinal bulk wave transducer, the at least one longitudinal bulk wave transducer is configured to detect a reflected longitudinal bulk wave signal that oscillates and propagates in the same direction through the sensing region of the rail track. The ultrasonic sensor may be mounted on the rail track to detect reflected ultrasonic longitudinal bulk wave signals propagating and oscillating in a direction parallel to the vertical axis (z-axis) of the rail track.

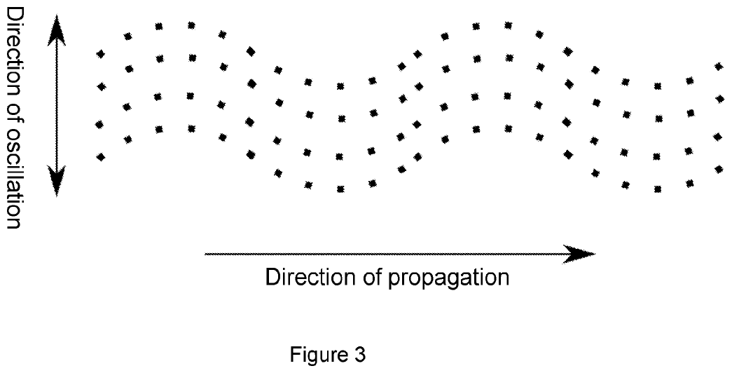

An ultrasonic bulk wave transducer operating in shear mode is configured to detect a reflected ultrasonic shear bulk wave signal, and so may be referred to as an ultrasonic shear bulk wave transducer. As shown in FIG. 3, an ultrasonic shear bulk wave signal has a direction of oscillation that is perpendicular to the direction of propagation through the rail track. As such, if the ultrasonic sensor comprises at least one ultrasonic shear bulk wave transducer, the at least one shear bulk wave transducer is configured to detect a reflected shear bulk wave signal that oscillates in a direction that is perpendicular to the direction of propagation through the sensing region of the rail track. The ultrasonic sensor may be mounted on the rail track to detect reflected ultrasonic shear bulk wave signals propagating in a direction parallel to the vertical axis (z-axis) of the rail track and oscillating in a direction parallel to a lateral axis (y-axis) of the rail track. The ultrasonic sensor may be mounted on the rail track to detect reflected ultrasonic shear bulk wave signals propagating in a direction parallel to the vertical axis (z-axis) of the rail track and oscillating in a direction parallel to the longitudinal axis (x-axis) of the rail track.

By having a plurality of bulk wave transducers, the ultrasonic sensor may simultaneously detect multiple ultrasonic bulk wave signals (longitudinal bulk wave signals and/or shear bulk wave signals) in real time.

When the ultrasonic sensor comprises one or more ultrasonic bulk wave transducer operating in longitudinal mode, and one or more ultrasonic bulk wave transducer operating in shear mode, the ultrasonic sensor is may be referred to as a multi-planar bulk wave ultrasonic sensor.

The bulk wave transducers may be a piezo-electric, an electromagnetic acoustic transducer (EMAT), a laser transducer, piezo-electric micromachined ultrasonic transducer (PMUT), a direct-write transducer (DWT), a Fibre-Bragg transducer or any other suitable ultrasonic transducer.

The ultrasonic sensor may comprise at least one ultrasonic longitudinal bulk wave transducer configured to operate at a predetermined frequency so as to detect a reflected ultrasonic longitudinal bulk wave signal with the predetermined frequency.

The ultrasonic sensor may comprise a plurality of ultrasonic longitudinal bulk wave transducers configured to operate at different predetermined frequencies. As a result, each ultrasonic longitudinal bulk wave transducer may detect reflected ultrasonic longitudinal bulk wave signals with a different predetermined frequency, which in turn allows for wide frequency spectrum measurements and/or variable beam spread measurements. For example, the ultrasonic sensor may comprise at least one longitudinal bulk wave transducer operating at a first longitudinal bulk wave frequency and at least one longitudinal bulk wave transducer operating at a second longitudinal bulk wave frequency that is different to the first frequency.

In addition to detecting the reflected longitudinal bulk wave signal, the at least one ultrasonic longitudinal bulk wave transducer of the ultrasonic sensor may be configured to emit a longitudinal bulk wave signal that propagates through the sensing region of the rail track towards the interface, whereby at least a portion of the emitted longitudinal bulk wave signal is reflected from the interface. As such, the one or more ultrasonic longitudinal bulk wave transducer operates in pulse-echo mode.

If the at least one ultrasonic longitudinal bulk wave transducer is a detecting-only ultrasonic longitudinal bulk wave transducer, the ultrasonic sensor may further comprise at least one corresponding emitting ultrasonic longitudinal bulk wave transducer configured to emit a longitudinal bulk wave signal that propagates through the sensing region of the rail track towards the interface, whereby at least a portion of the longitudinal bulk wave signal is reflected at the interface, and the at least one detecting ultrasonic bulk wave transducer is configured to detect the reflected longitudinal bulk wave signal. As such, the at least one emitting ultrasonic longitudinal bulk wave transducer and corresponding at least one detecting ultrasonic longitudinal bulk wave transducer are configured to operate in pitch-catch mode.

For example, the ultrasonic sensor may comprise:
a first ultrasonic longitudinal bulk wave sensor unit arranged at a first longitudinal bulk wave position on the rail track; and
a second ultrasonic longitudinal bulk wave sensor unit arranged at a second longitudinal bulk wave position on the rail track;
wherein the first ultrasonic longitudinal bulk wave sensor unit comprises:
   at least one emitting ultrasonic longitudinal bulk wave transducer configured to emit an ultrasonic longitudinal wave signal to propagate through the sensing region of the rail track to the interface, wherein at least a portion of the ultrasonic longitudinal wave signal is reflected from the interface and propagates through the sensing region towards the second ultrasonic sensor unit; and
wherein the second ultrasonic longitudinal bulk wave sensor unit comprises:
   at least one detecting ultrasonic longitudinal bulk wave transducer corresponding to the at least one emitting ultrasonic longitudinal bulk wave transducers, wherein the at least one detecting ultrasonic longitudinal bulk wave transducer is configured to detect the ultrasonic longitudinal bulk wave signal reflected from the interface.

The ultrasonic sensor may comprise at least one ultrasonic shear bulk wave transducer configured to operate at a predetermined frequency so as to detect a reflected ultrasonic shear bulk wave signal with the predetermined frequency.

The ultrasonic sensor may comprise a plurality of ultrasonic shear bulk wave transducers configured to operate at different predetermined frequencies. As a result, each ultrasonic shear bulk wave transducers may detect a reflected ultrasonic shear bulk wave signals with a different predetermined frequency, which in turn allows for wide frequency spectrum measurements and/or variable beam spread measurements. For example, the ultrasonic sensor may comprise at least one shear bulk wave transducer operating at a first shear bulk wave frequency, and at least one shear bulk wave transducer operating at a second shear bulk wave frequency that is different to the first frequency.

The direction of polarisation of a shear bulk wave transducer determines the direction of oscillation of the detected shear wave signal.

The ultrasonic sensor may comprise at least one ultrasonic shear wave transducer with a predetermined direction of polarisation, whereby the at least one ultrasonic shear bulk transducer is configured to detect a reflected ultrasonic shear bulk wave signal oscillating in the predetermined direction of polarisation.

The ultrasonic sensor may comprise at least one ultrasonic shear bulk wave transducer with a direction of polarisation parallel to the longitudinal axis of the rail track (x axis along the length of the rail track), whereby the at least one ultrasonic shear bulk wave transducer is configured to detect a reflected ultrasonic shear bulk wave signal oscillating in the direction parallel to the longitudinal axis of the rail track (x-axis of the rail track) as it propagates through the sensing region of the rail track (for example, in a direction parallel to the vertical axis (z-axis) of the rail track).

The ultrasonic sensor may comprise at least one ultrasonic shear bulk wave transducer with a direction of polarisation parallel to a lateral axis of the rail track (a across the width of the rail track), whereby the at least one ultrasonic shear bulk wave transducer is configured to detect a reflected ultrasonic shear bulk wave signal oscillating in the direction parallel to the lateral axis of the rail track (y axis of the rail track) as it propagates through the sensing region of the rail track (for example, in a direction parallel to the vertical axis (z-axis) of the rail track).

The ultrasonic sensor may comprise at least one ultrasonic shear bulk wave transducer with a direction of polarisation parallel to an axis angled between the longitudinal axis (x axis) and lateral axis (y-axis) of the rail track, whereby the at least one ultrasonic shear bulk wave transducer is configured to detect a reflected ultrasonic shear bulk wave signal oscillating in the direction parallel to the axis angled between the longitudinal axis (x axis) and lateral axis (y-axis) of the rail track as it propagates through the sensing region of the rail track (for example, in a direction parallel to the vertical axis (z-axis) of the rail track).

When the ultrasonic sensor comprises a plurality of ultrasonic shear bulk wave transducers with different direction of polarisation. For example, the ultrasonic sensor may comprise at least one shear bulk wave transducer with a first direction of polarisation and at least one shear bulk wave transducer with a second direction of polarisation that is different to the first direction of polarisation.

In addition to detecting the reflected shear bulk wave signal, the at least one ultrasonic shear bulk wave transducer of the ultrasonic sensor may be configured to emit a shear bulk wave that propagates through the sensing region of the rail track towards the interface, whereby at least a portion of the emitted shear bulk wave signal is reflected from the interface. As such, ultrasonic shear bulk wave transducer operates in the pulse-echo mode.

If the one or more ultrasonic shear bulk wave transducer of the ultrasonic sensor is a detecting-only ultrasonic shear bulk wave transducer, the ultrasonic sensor may further comprise at least one emitting ultrasonic shear bulk wave transducer configured to emit a shear bulk wave that propagates through the sensing region of the rail track towards the interface, whereby at least a portion of the shear bulk wave signal is reflected at the interface, and the one or more detecting ultrasonic shear bulk wave transducer is configured to detect the reflected shear bulk wave signal. As such, the one or more emitting ultrasonic shear bulk wave transducer and corresponding one or more detecting ultrasonic shear bulk wave transducer are configured to operate in pitch-catch mode.

For example, the ultrasonic sensor may comprise:
a first ultrasonic shear bulk wave sensor unit arranged at a first shear bulk wave position on the rail track;
a second ultrasonic shear bulk wave sensor unit arranged at a second hear bulk wave position on the rail track;
wherein the first ultrasonic shear bulk wave sensor unit comprises:
   at least one emitting ultrasonic shear bulk wave transducer configured to emit an ultrasonic shear bulk wave signal to propagate through the sensing region of the rail track to the interface, wherein at least a portion of the ultrasonic shear bulk wave is reflected from the interface and propagates through the sensing region towards the second ultrasonic sensor unit; and
wherein the second ultrasonic shear bulk wave sensor unit comprises:
   at least one detecting ultrasonic shear bulk wave transducer corresponding to the at least one emitting ultrasonic shear bulk wave transducer, wherein the at least one detecting ultrasonic shear bulk wave transducers is configured to detect the ultrasonic shear bulk wave signal reflected from the interface.
      Ultrasonic Sensor with Ultrasonic Surface Wave Transducers

The ultrasonic sensor may comprise a plurality of ultrasonic surface wave transducers, additionally or alternatively to the plurality of ultrasonic bulk wave transducers.

For example, the ultrasonic sensor may comprise at least one (one or more) ultrasonic surface wave transducer operating in longitudinal mode, and at least one (one or more) ultrasonic surface wave transducers operating in shear mode.

For example, the ultrasonic sensor may comprise a plurality of ultrasonic surface wave transducers operating in longitudinal mode.

For example, the ultrasonic sensor may comprise a plurality of ultrasonic surface wave transducers operating in shear mode.

Ultrasonic surface wave signals propagate along the surface of the rail track at the sensing region of the rail track. Depending on the arrangement of the ultrasonic surface wave transducers, the surface wave may propagate along the surface of the sensing region of the rail track via the interface surface at which the interface forms. Alternatively, depending on the ultrasonic arrangement of the surface wave transducers, the surface wave may propagate along the surface of the sensing region of the rail track separate and spaced from interface surface. To detect vehicle-track interaction, the ultrasonic sensor is mounted on the rail track to detect ultrasonic surface wave signals propagating along the surface of the sensing region of the rail track when the rail wheel passes over the interface surface and the interface formed at the interface surface comprises a wheel-rail track interface. To provide a comparative analysis, the ultrasonic sensor may be configured to detect reference ultrasonic surface waves propagating along the surface of the sensing rail track when the interface surface is in a known reference state and the interface formed at the interface surface comprises a reference interface. To detect a sensing pattern over time, the ultrasonic sensor may be configured to continuously or intermittently detect reflected ultrasonic surface wave signals propagating along the surface of the sensing region over a period of time.

An ultrasonic surface wave transducer operating in longitudinal mode is configured to detect an ultrasonic longitudinal surface wave signal, and so may be referred to as an ultrasonic longitudinal surface wave transducer. As shown in FIG. 2, an ultrasonic longitudinal surface wave signal has a direction of oscillation that is parallel to the direction of propagation.

An ultrasonic surface wave transducer operating in shear mode is configured to detect an ultrasonic shear surface wave signal, and so may be referred to as an ultrasonic shear surface wave transducer. As shown in FIG. 3, an ultrasonic shear surface wave signal has a direction of oscillation that is perpendicular to the direction of propagation.

The surface wave transducers allow the ultrasonic sensor to simultaneously detect multiple ultrasonic surface wave signals (longitudinal surface wave signals and/or shear surface wave signals) in real time.

When the ultrasonic sensor comprises one or more ultrasonic surface wave transducer operating in longitudinal mode, and one or more ultrasonic surface wave transducer operating in shear mode, the ultrasonic sensor is may be referred to as a multi-planar surface wave ultrasonic sensor.

The surface wave transducers may be a piezo-electric transducer, an electromagnetic acoustic transducer (EMAT), a laser transducer, a piezo-electric micromachined ultrasonic transducer (PMUT), a direct-write transducer (DWT), a Fibre-Bragg transducer or any other suitable ultrasonic transducer.

When the ultrasonic sensor comprises one or more ultrasonic surface wave transducer operating in longitudinal mode, the ultrasonic surface wave transducer is configured to detect an ultrasonic longitudinal surface wave signal propagating along the surface of the rail track in the sensing region of the rail track. As shown in FIG. 2, the longitudinal surface wave has a direction of oscillation that is parallel to the direction of propagation along the surface of the rail track. As such, the one or more ultrasonic longitudinal surface wave transducer is configured to detect a longitudinal surface wave signal that oscillates and propagates in the same direction along the rail track surface from the interface sensing region. The ultrasonic sensor may be mounted on the rail track to detect ultrasonic longitudinal surface wave signals propagating laterally across the rail track surface, parallel to the lateral axis of the rail track (y-axis). The ultrasonic sensor may be mounted on the rail track to detect ultrasonic longitudinal surface wave signals propagating longitudinally across the rail track surface, parallel to the longitudinal axis of the rail track (x-axis)

The ultrasonic sensor may comprise one or more ultrasonic longitudinal surface wave transducer configured to operate at a predetermined frequency so as to detect an ultrasonic longitudinal surface wave signal propagating along the rail track surface with the predetermined frequency.

The ultrasonic sensor may comprise a plurality of ultrasonic longitudinal surface wave transducers configured to operate at different predetermined frequencies. As a result, the ultrasonic longitudinal bulk wave transducer detects ultrasonic longitudinal surface wave signal propagating along the rail track surface at a different predetermined frequency, which in turn allows wide frequency spectrum measurements and/or variable beam spread measurements. For example, the ultrasonic sensor may comprise at least one longitudinal surface wave transducer with a first longitudinal surface wave frequency and at least one second longitudinal surface wave transducer with a second longitudinal surface wave frequency that is different to the first frequency.

In addition to the at least one detecting ultrasonic longitudinal surface wave transducer, the ultrasonic sensor may further comprise at least one corresponding emitting ultrasonic longitudinal surface wave transducer configured to emit an ultrasonic longitudinal surface wave to propagate along the rail track surface to the detecting ultrasonic longitudinal surface wave transducers. As such, the emitting ultrasonic longitudinal surface wave transducer is configured to emit an ultrasonic longitudinal surface wave signal along the rail track surface and the corresponding detecting ultrasonic longitudinal surface wave transducer is configured to detect the surface wave signal propagating along the surface of the rail track.

When the ultrasonic sensor comprises one or more ultrasonic surface wave transducer operating in shear mode, the at least one ultrasonic shear surface wave transducer is configured to detect an ultrasonic shear surface wave signal propagating along the surface of the rail track, and so it may be referred to as an ultrasonic shear surface wave transducer. As shown in FIG. 3, an ultrasonic shear surface wave has a direction of oscillation that is perpendicular to the direction of propagation. As explained further below, the direction of oscillation of the detected shear surface wave signal is dependent on the direction of polarisation of the shear surface bulk transducers.

The ultrasonic sensor may comprise one or more ultrasonic shear surface wave transducer configured to operate at predetermined frequency so as to detect a ultrasonic shear surface wave signal at the predetermined frequency.

The ultrasonic sensor may comprise a plurality of ultrasonic shear surface wave transducers operating at different predetermined frequencies. As a result, the ultrasonic shear surface wave transducer detects an ultrasonic shear surface wave signal at a different predetermined frequency, which allows for wide frequency spectrum measurements. For example, the ultrasonic sensor may comprise at least one shear surface wave transducer with a first shear surface wave frequency and at least one shear surface wave transducer with a second shear surface wave frequency that is different to the first frequency.

As mentioned above, the direction of polarisation of a shear surface wave transducer determines direction of oscillation of the detected shear wave signal.

The ultrasonic sensor may comprise one or more ultrasonic shear surface wave transducer with a predetermined direction of polarisation, whereby the one or more ultrasonic shear surface transducer is configured to detect an ultrasonic shear surface wave signal propagating along the rail track surface and oscillating in the predetermined direction of polarisation.

The ultrasonic sensor may comprise one or more ultrasonic shear surface wave transducer with a direction of polarisation parallel to the longitudinal axis of the rail track (x axis along the length of the rail track), whereby the one or more ultrasonic shear bulk wave transducer is configured to detect a reflected ultrasonic shear bulk wave signal oscillating in the direction parallel to the longitudinal axis of the rail track (x-axis of the rail track) as it propagates along the rail track surface.

The ultrasonic sensor may comprise one or more ultrasonic shear surface wave transducer with a direction of polarisation parallel to a lateral axis of the rail track (y axis across the width of the rail track), whereby the one or more ultrasonic shear surface wave transducer is configured to detect an ultrasonic shear surface wave signal oscillating in the direction parallel to the lateral axis of the rail track (y axis of the rail track) as it propagates along the rail track surface.

The ultrasonic sensor may comprise one or more ultrasonic shear surface wave transducer with a direction of polarisation parallel to an axis angled between the longitudinal axis (x axis) and lateral axis (y-axis) of the rail track, whereby the at least one ultrasonic shear surface wave transducer is configured to detect an ultrasonic shear bulk wave signal oscillating in the direction parallel to the axis angled between the longitudinal axis (x axis) and lateral axis (y-axis) of the rail track as it propagates along the rail track surface.

The ultrasonic sensor may comprise a plurality of ultrasonic shear surface wave transducers with different direction of polarisation. For example, the ultrasonic sensor may comprise at least one shear surface wave transducer with a first shear surface wave direction of polarisation and at least one shear surface wave transducer with a second shear surface wave direction of polarisation that is different to the first direction of polarisation.

In addition to the at least one detecting ultrasonic shear surface wave transducer to detect a shear surface wave, the ultrasonic sensor may further comprise at least one corresponding emitting ultrasonic shear surface wave transducer configured to emit an ultrasonic shear surface wave to propagate along the rail track surface to the detecting ultrasonic shear surface wave transducers. As such, the emitting ultrasonic shear surface wave transducer is configured to emit an ultrasonic shear surface wave signal along the rail track surface and the corresponding detecting ultrasonic shear surface wave transducer is configured to detect the ultrasonic shear wave signal propagating along the rail track surface.

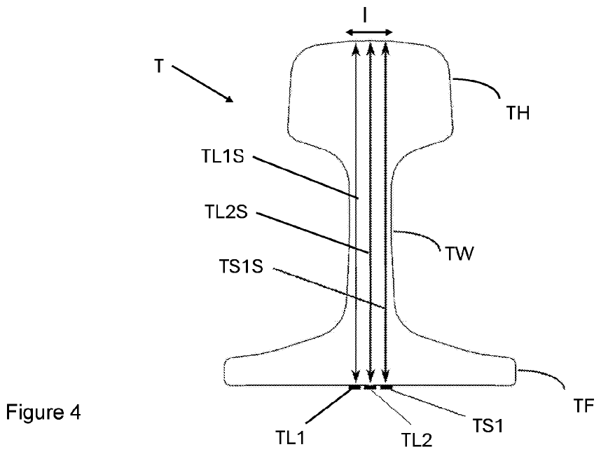

FIG. 4 depicts an example of a multi-planar ultrasonic bulk wave sensor mounted on a rail track (T). The ultrasonic sensor comprises a linear array of transducers comprising a first longitudinal bulk wave transducer (TL1), a second longitudinal bulk wave transducer (TL2) and a first shear bulk wave transducer (TS1). The multi-planar ultrasonic sensor is mounted on the underside of the rail track foot (TF) to form an ultrasonic sensing region (R) of the rail track. The ultrasonic sensing region (R) is a segment of the rail track. The mounting and configuration of the transducers determines the configuration of the ultrasonic sensing region (R), whereby in this example, the array of transducers spans the width of the rail track web, forming an elongate ultrasonic sensing region (R) in the rail track that extends along the height of the rail track and has a cross-section shape corresponding to the width of the rail track web. The sensing region comprises an interface surface (I) at which an interface forms between the interface surface and one or more other material (material rail vehicle wheel, third body, air etc) during operation. Due to the mounting and configuration of the transducers, the interface surface comprises a track tread region of the track head (TH) at the sensing region of the rail track. In operation, each transducer is configured to operate in pulse-echo mode to emit an ultrasonic bulk wave signal that propagates in a forward path through the sensing region of the rail track towards the interface, whereby at least a portion of the ultrasonic bulk wave signal is reflected from interface and propagates a return path through the sensing region to be detected by the respective transducer. The longitudinal bulk wave transducers (TL1, TL2) are configured to emit and detect the respective reflected longitudinal bulk wave signals (TL1S, TL2S) that oscillate and propagate in a same direction through the rail track parallel to the vertical axis (z-axis) of the rail track. The shear bulk wave transducer (TS1) is configured to emit and detect the reflected shear bulk wave signal (TS1S) that propagates through the rail track in a direction parallel to the vertical axis (z-axis of the rail track) and oscillates perpendicularly to the direction of propagation through the rail track from the interface. The direction of oscillation of the detected shear bulk wave signal is dependent on the direction of polarisation of the shear wave bulk transducer. For example, the shear wave bulk transducer (TS1) may have a direction of polarisation to detect a reflected shear bulk wave oscillating in a direction parallel to the direction of motion of the wheel along the rail track (parallel to the longitudinal axis of the rail track, x-axis), to detect a reflected shear bulk wave oscillating in a direction parallel to a lateral axis of the rail track (y-axis), or to detect a reflected shear bulk wave oscillating in a direction parallel to an axis at any angle therebetween the x-axis and γ-axis of the rail track. To monitor vehicle-track interactions, each transducer is configured to detect the reflected ultrasonic bulk wave signals as the rail vehicle wheel passes over and contacts the interface surface (I). Hence, the interface formed at the interface sense region (I) thereby comprises a wheel-rail track interface.

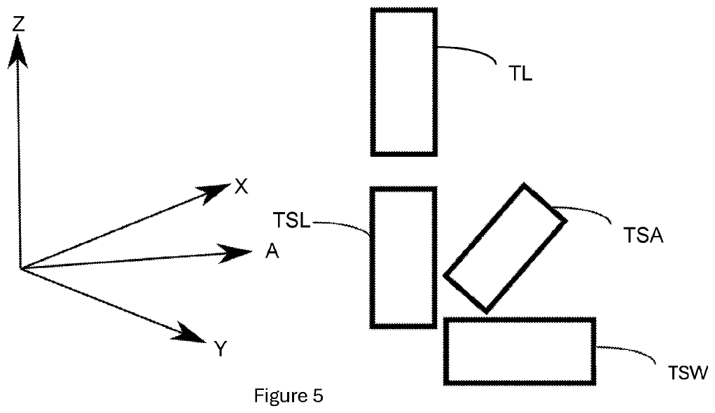

FIG. 5 depicts an example of a multi-planar ultrasonic bulk wave sensor mountable on a rail track where the ultrasonic sensor comprises a longitudinal bulk wave transducer (TL) and three shear bulk wave transducers (TSL, TSA, TSW). The transducers are arranged in a two-dimensional array to define the cross-sectional shape of the sensing region of the rail track and thereby the 2-dimensional shape of the interface surface. In operation, all the transducers (TL, TSL, TSA, TSW) are configured to operate in pulse-echo mode to emit ultrasonic bulk wave signals that propagate through the sensing region to the interface formed at the interface surface, and detect the respective ultrasonic waves propagating in a return path through the sensing region following reflection from the interface. The ultrasonic sensor may be mountable on the rail track such that bulk wave signals propagate through the rail track in a direction parallel to a vertical axis of the rail track (z-axis). The longitudinal bulk wave emitted and detected by the longitudinal bulk wave transducer (TL) oscillates and propagates through the rail track in the direction parallel to the vertical axis of the rail track (z-axis). The first shear wave transducer (TSL) has an x-axis direction of polarisation whereby the first shear wave transducer is configured to emit and detect a shear bulk wave propagating through the rail track in the direction parallel to the vertical axis of the rail track (z-axis) and oscillating in a direction parallel to the longitudinal axis of the rail track length (along the length of the rail track in the direction of vehicle motion, x-axis). The second shear bulk wave transducer (TSW) has a y-axis direction of polarisation whereby the second bulk wave transducer is configured to emit and detect a shear bulk wave propagating through the rail track in the direction parallel to the vertical axis of the rail track (z-axis) and oscillating in a direction parallel to the lateral axis of rail track (across the width of the rail track, y-axis). The third shear bulk wave transducer (TSA) has an a-axis direction of polarisation whereby the third shear bulk wave transducer is configured to emit and detect a shear bulk wave propagating through the rail track in the direction parallel to the vertical axis of the rail track (z-axis) and oscillating in a direction (A) at an angle to longitudinal axis of the rail track length (along the rail track length in the direction of motion, x-axis) and lateral axis of the rail track (across the rail track width, y-axis). The shear bulk wave transducers may have the same or different frequency.

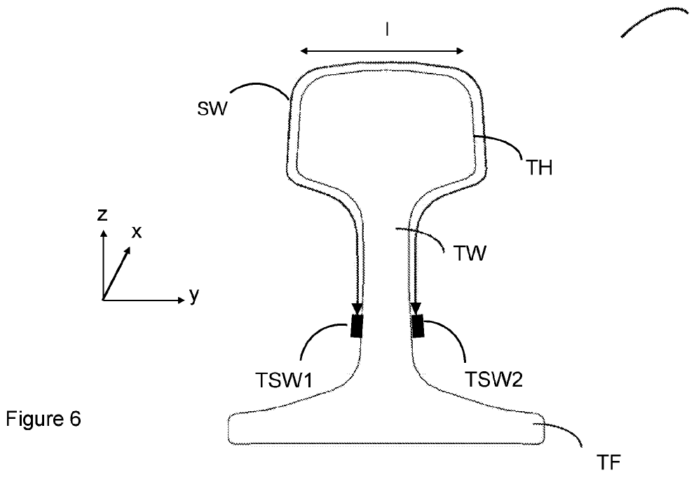

FIG. 6 depicts an example of an ultrasonic sensor mountable on the rail track where the ultrasonic sensor comprises an emitting surface wave transducer (TSW1) and a detecting surface wave transducer (TSW2). The corresponding emitting and detecting surface wave transducers may be configured to emit and detect a longitudinal surface wave signal or a shear surface wave signal. In this example, the emitting and detecting surface transducers are arranged on opposing walls of the web (TW) to form a sensing region of the rail track. The sensing region includes an interface surface (I) at which an interface forms during monitoring. The emitting transducer emits a surface wave (SW) that propagates laterally along the rail track surface via the interface surface (I) and to the detecting surface wave transducer.

Ultrasonic Sensor with Backing Plate

The ultrasonic sensor may comprise a backing plate on which the ultrasonic transducers are mounted. The backing plate may comprise a customised backing layer such as a metal or polymer plate, or a printed circuit board (PCB). The arrangement of the ultrasonic transducers on a backing plate allows for low cost volume production.

The backing plate may be flexible to allow for the ultrasonic sensor to conform to the surface on which it is being mounted. For example, the ultrasonic sensor may be flexible to conform to a curved surface.

The ultrasonic transducers may be arranged in pairs on the backing plate.

The ultrasonic transducers may be arranged in a two-dimensional array on the backing plate.

The ultrasonic transducers may be arranged as a linear array on the backing plate.

Each ultrasonic transducer of the ultrasonic array may have a width in the range of approximately 0.2 mm to 20 mm. Each ultrasonic transducer may have a length in the range of approximately 0.3 mm to 40 mm. Each ultrasonic transducer may have a generally rectangular, square, circular or oval shape.

Each ultrasonic transducer may have a thickness in the range of approximately 0.02 mm to 15 mm.

The configuration of the sensing region of the rail track is dependent on the number and arrangement of the transducers.

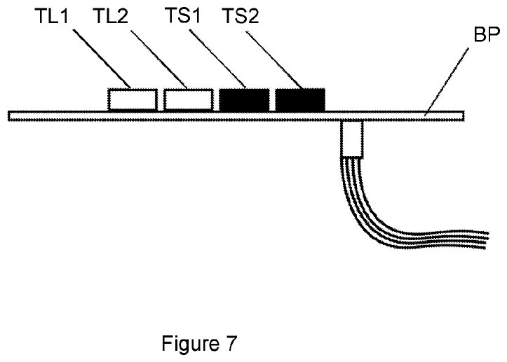

FIG. 7 depicts an example of a multi-planar ultrasonic sensor mountable on a rail track where a plurality of ultrasonic transducers (TL1, TL2, TS1, TS2) are arranged in a linear array on the backing plate (BP). In this example, the ultrasonic sensor comprises a pair of longitudinal bulk wave transducers (TL1, TL2) and a pair of shear bulk wave transducers (TS1, TS2) arranged linearly in the row on the backing plate (BP). When mounted on the rail track, the ultrasonic transducers form a sensing region of the rail track having a corresponding cross-sectional linear shape and size. The interface surface at the sensing region of the rail track thereby has the same 2 dimensional geometry. The longitudinal bulk wave transducers may have the same or different frequency. The shear bulk wave transducers may have the same or different frequency. The shear bulk wave transducers may have the same or different directions of polarisations.

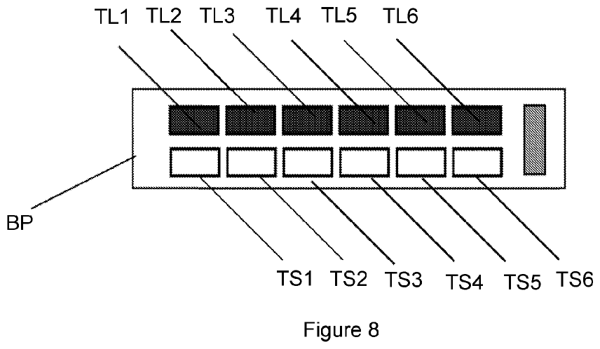

FIG. 8 depicts an example of a multi-planar ultrasonic sensor mountable on a rail track where a plurality of ultrasonic transducers (TL1 to TL6, TS1 to TS6) are arranged in two rows on a backing plate (BP). In this example, the ultrasonic sensor comprises six longitudinal surface wave transducers (TL1 to TL6) arranged linearly in a first row and six shear surface wave transducers (TS1 to TS6) arranged linearly in a second row on the backing plate (BP). The first row and second row of surface wave transducers are parallel, forming a two-dimensional array. When mounted on the rail track, the ultrasonic transducers form a sensing region of the rail track, and thereby an interface surface of the sensing region, having a corresponding cross-sectional shape and size. The longitudinal bulk wave transformers may have the same or different frequency. The shear bulk wave transducers may have the same or different frequency. The shear bulk wave transducers may have the same or different directions of polarisations.

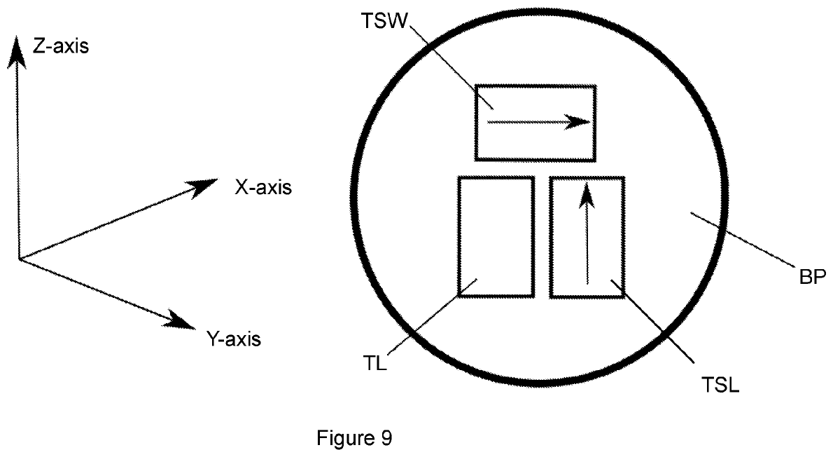

FIG. 9 depicts an example of a multi-planar ultrasonic sensor mountable on a rail track. The ultrasonic sensor comprises a longitudinal bulk wave transducer (TL), a first shear bulk wave transducer (TSL) and a second shear bulk wave transducer (TSW). The transducers are arranged in a two-dimensional array with a rosette formation on a backing layer (BP), such as a metal or polymer plate, to achieve triaxial planar measurement at the same location with one ultrasonic sensor assembly. When the ultrasonic sensor is mounted on the rail track, the transducers form a sensing region in the rail track, and thereby an interface surface of the sensing region, with a corresponding two-dimensional cross-sectional shape. The transducers are configured to operate in pulse-echo mode to emit ultrasonic bulk wave signals that propagate through the sensing region to the interface formed at the interface surface, and detect at least a portion of the respective bulk wave signals reflected from the interface. The ultrasonic sensor may be mountable on the rail track such that the bulk wave signals propagate through the sensing region of rail track to and from the interface in a direction parallel to the vertical axis of the rail track (z-axis). In pulse-echo mode, the longitudinal bulk wave transducer (TL) is configured to emit and detect a longitudinal bulk wave signal that oscillates and propagates in a direction parallel with the z-axis of the rail track. In pulse-echo mode, the first shear bulk wave transducer (TSL) has an x-axis direction of polarisation and is thereby configured to emit and detect a first shear bulk wave signal that oscillates in a direction parallel to the x-axis of the rail track and propagates in a direction parallel to the z-axis of the rail track. In pulse-echo mode, the second shear wave transducer (TSW) has a y-axis direction of polarisation whereby the second shear wave transducer is configured to emit and detect a second shear bulk wave that oscillates in a direction parallel to the y-axis of the rail track and propagates in a direction parallel to the z-axis of the rail track.

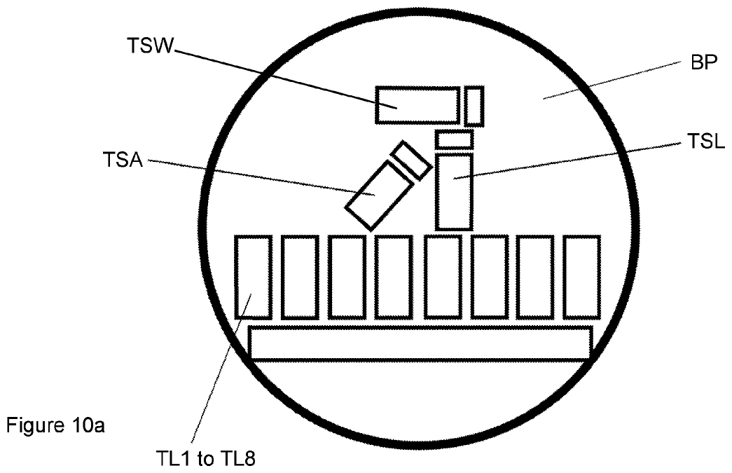

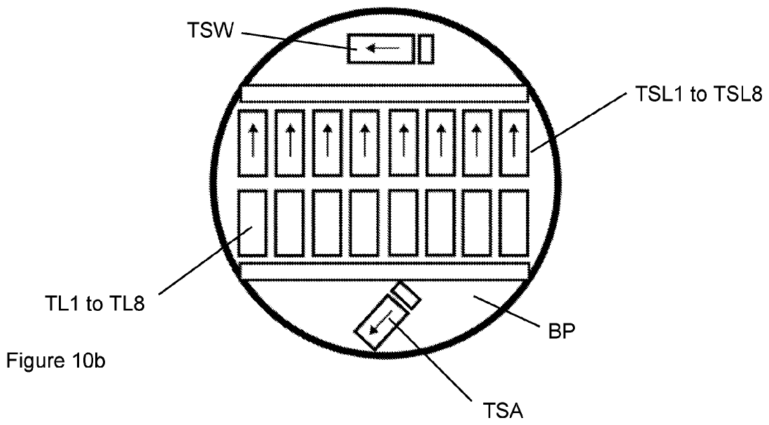

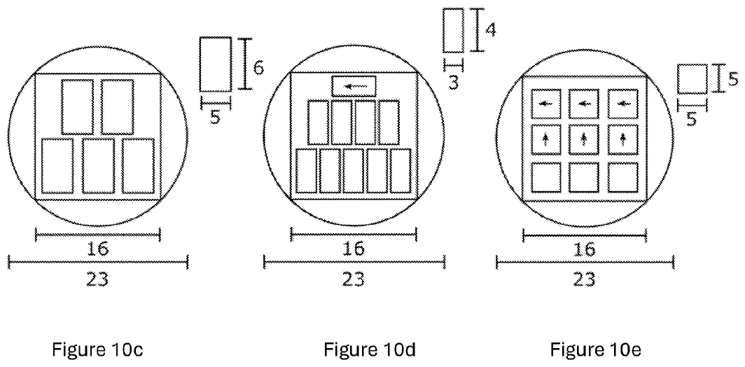

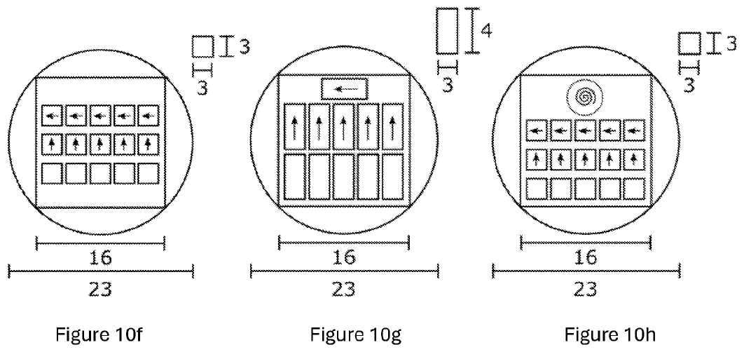

Further examples of multi-planar ultrasonic sensors having different transducer arrangements on a backing plate (BP) are shown in FIGS. 10a to 10h. The ultrasonic sensors are mountable on a rail track. In these examples, the ultrasonic sensor comprises at least one longitudinal bulk wave transducer (TL), and/or at least one first shear bulk wave transducer (TSL) with an x-axis direction of polarisation, and/or at least one second shear bulk wave transducer (TSW) with a y-axis direction of polarisation, and/or at least one third shear bulk wave transducer (TSA) with an a-axis direction of polarisation, as per the example depicted in FIG. 5. When the ultrasonic sensor is mounted on the rail track, the transducers are arranged in an array to form a sensing region in the rail track, whereby the sensing region has an interface surface at which an interface forms during operation. In operation, the bulk wave transducers are configured to operate in a pulse-echo mode to emit and detect bulk waves propagating to and from the interface in a direction parallel to the vertical axis of the rail track (z-axis).

Ultrasonic Sensor with Damping

The ultrasonic sensor may comprise damping to provide a controlled damping effect on an ultrasonic transducer. The damping may be selected to provide a predetermined damping effect on an ultrasonic transducer.

Greater damping of an ultrasonic transducer increases the frequency bandwidth of the ultrasonic transducer. Greater damping applied to the rear of the transducer enhances the dissipation of the ultrasonic wave emanating from the rear of the transducer. Greater damping constrains ultrasonic wave signal oscillations (number of oscillations).

For example, the damping may be selected to provide a high damping effect to achieve a broadband frequency response. Alternatively, the damping may be selected to provide a low damping effect to achieve a narrowband frequency response.

The damping effect of the damping is determined by the acoustic impedance of the damping. As such, the damping may comprise a predetermined acoustic impedance to achieve the desired damping effect. For example, the damping may comprise a damping layer with a predetermined acoustic impedance. The damping layer may be arranged between the transducer and backing plate. Alternatively, the damping may comprise a damped backing plate with a predetermined acoustic impedance. For example, the damped backing plate may comprise the damping layer incorporated or embedded within the backing plate. Alternatively, the damped backing plate may comprise a damping material with a predetermined acoustic impedance. For example, the backing plate may be manufactured from a suspension of metal powder in an organic base, where the metal suspension acts to increase the acoustic impedance of the mix to achieve a desired damping effect and help scatter the rear facing ultrasonic wave signals. The organic base may comprise a bonding or setting material such as an epoxy resin. The organic base aids the absorbing of the rear facing ultrasonic wave signals and bonding of the backing plate to the transducers.

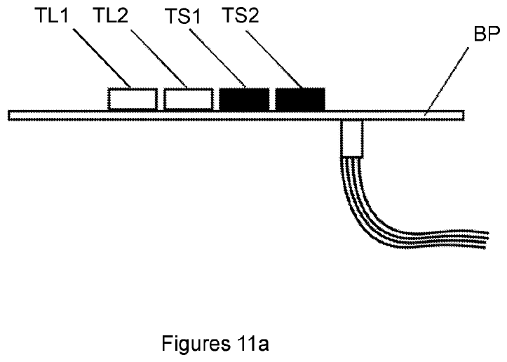

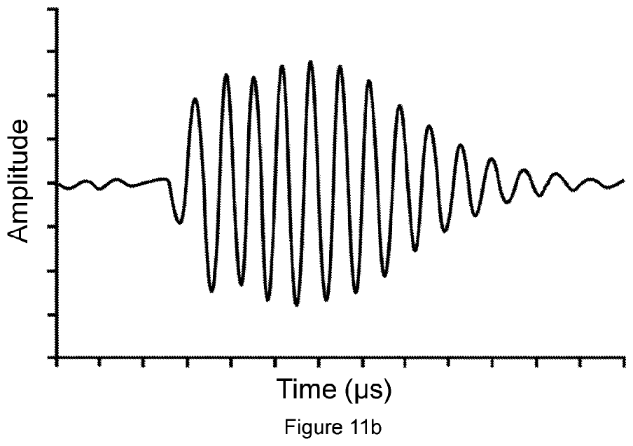

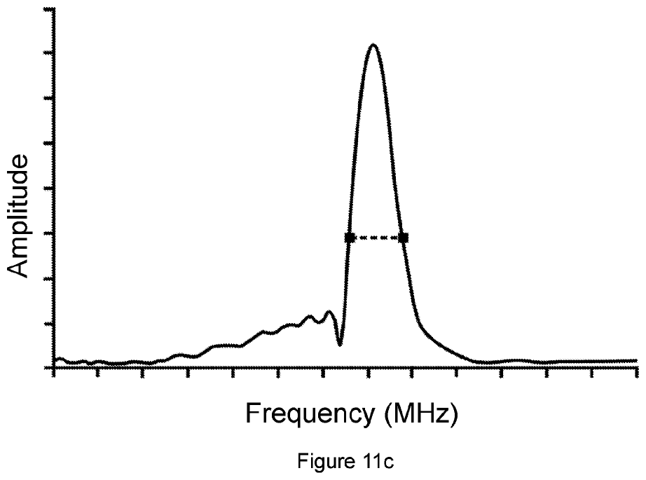

FIG. 11a depicts an example of an ultrasonic sensor comprising longitudinal bulk wave transducers TL1, TL2, and shear bulk wave transducers TS1, TS2. The transducers are arranged in a linear array on back plate (BP) and there is neglible or no damping. FIGS. 11b and 11c depict the waveform of a detected ultrasonic bulk wave signal over time and frequency bandwidth of the detected ultrasonic bulk wave signal with negligible or no damping.

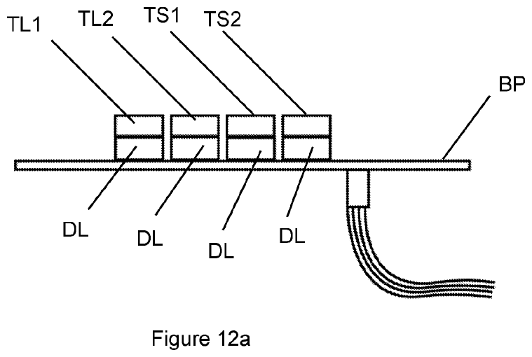

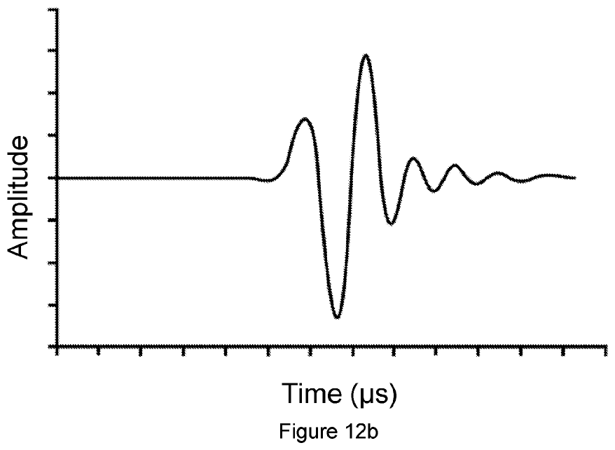

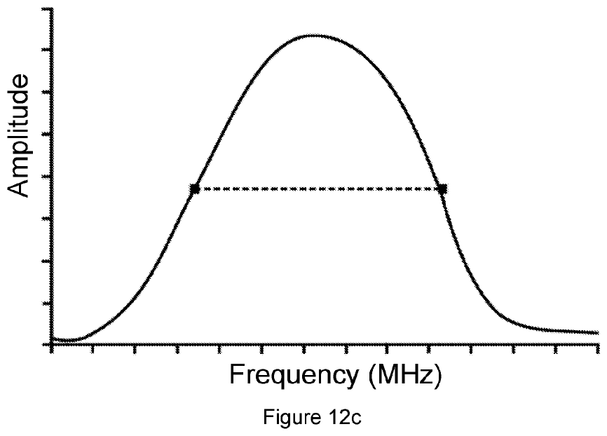

FIG. 12a depicts an example of an ultrasonic sensor comprising the longitudinal bulk wave transducers TL1, TL2, and shear bulk wave transducers TS1, TS2. The transducers are arranged in a linear array on back plate (BP) and a damping layer (DL) is arranged between each bulk wave transducer and the backing plate. The damping layer has a predetermined acoustic impedance to provide a high damping effect on each bulk wave transducer. FIGS. 12b and 12c depict the waveform of the detected ultrasonic bulk wave over time and frequency bandwidth of the detected ultrasonic sensor with high damping. In contrast to FIGS. 11b and 11c, it can be seen from FIGS. 12b and 12c that damping increases the frequency bandwidth response of the ultrasonic sensor, resulting in high sensitivity across a wider range of frequencies. Damping layer also dissipates ultrasonic wave propagation and reduces the oscillation of the ultrasonic wave.

The target acoustic impedance of the damping depends on the specific type of transducer used, and the front face material of the ultrasonic transducer. This is calculated using the following equation based on the energy trapped inside the transducer:

$$W = ( \frac{{Z}_{D} - {Z}_{A}}{{Z}_{D} + {Z}_{A}} ) ( \frac{{Z}_{D} - {Z}_{B}}{{Z}_{D} + {Z}_{B}} )$$

Where W represents the square root of the energy trapped in the transducer after one oscillation, Z_{D} is the transducer acoustic impedance, Z_{A} is the acoustic impedance of the material on the front face of the transducer and Z_{B} is the acoustic impedance of the backing (backing plate with damping material/damping layer).

The density, acoustic impedance and attenuation coefficient of the backing materials may be controlled to achieve a desired W value.

When a broadband frequency bandwidth response is desirable, the target acoustic impedance of the backing Z_{B} is selected such that W is approximately 0.3 or below.

For a highly damped response and broadband frequency bandwidth response, the target acoustic impedance of the backing Z_{B} is selected such that W<0.1.

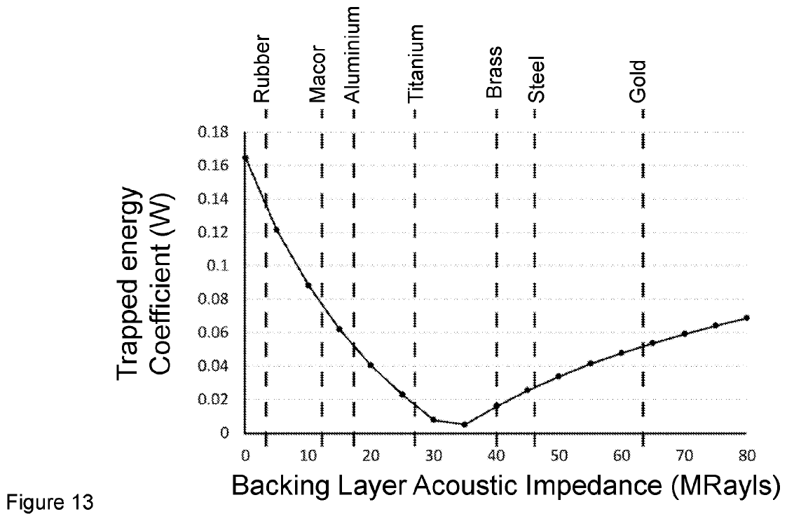

FIG. 13 depicts a graph showing the relationship between W and acoustic impedance of the backing Z_{B} (backing plate with damping material/damping layer) for different backing materials.

In an example, it is desirable for the transducers of the ultrasonic sensor to have an optimum frequency bandwidth response when sensing for third body layers and third body layer thickness interfacing the interface surface, as this measurement is frequency dependent. As such, a damping layer or backing plate may be manufactured from titanium or brass to provide the ultrasonic sensor with high damping control.

### Mounting of Ultrasonic Sensor on the Rail Track

The ultrasonic sensor may be permanently mounted or removably mounted on the rail track or adjacent the rail track.

The ultrasonic sensor may be clamped, bonded or coupled to the rail track or adjacent the rail track.

The ultrasonic sensor may be arranged within a sensing housing. For example, the ultrasonic sensor may be arranged in a sensing housing with one or more other types of sensors (for example a temperature sensor, acoustic emission sensor, accelerometer, audible acoustic sensor) to form a multi-sensor sensing probe. The sensing probe is then mounted on the rail track.

The ultrasonic sensor may be mounted on the rail track at any suitable location and with any suitable arrangement to form the sensing region of the rail track. For example, the ultrasonic sensor may be mounted on the foot of the rail track, such as the underside of the foot. The ultrasonic sensor may be mounted on the web of the rail track. The ultrasonic sensor may be mounted on the head of the rail track. The ultrasonic sensor may be embedded within the rail track via a hole, slot or recess. The ultrasonic sensor may be arranged between the rail track and a mount on which the rail track is mounted. The ultrasonic sensor may be embedded within the mount on which the rail track is mounted. The mount may be a sleeper or pad.

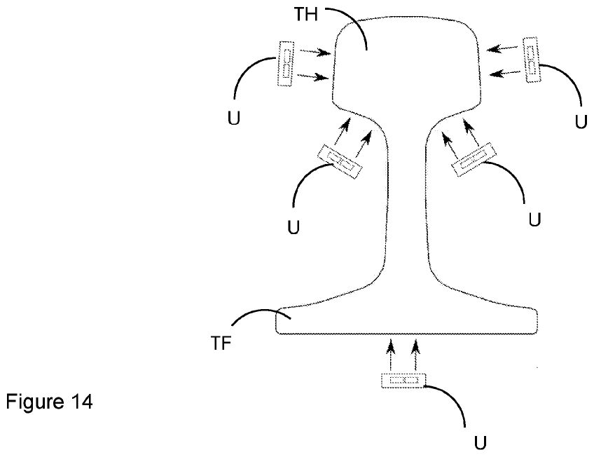

FIG. 14 depicts an example of a rail track showing how one or more ultrasonic sensor (U) comprising a plurality of ultrasonic bulk wave transducers may be arranged in relation to the rail track to form a sensing region and to detect ultrasonic bulk wave signals reflected from the interface that forms at the interface surface of the sensing region. The ultrasonic sensor may comprise at least one longitudinal bulk transducer, at least one shear bulk transducers, at least one longitudinal surface transducer, and/or at least one shear surface transducer. For example, one or more ultrasonic sensor may be arranged on the underside of the rail track foot (TF). One or more ultrasonic sensor may be mounted on the underside of the rail track head (TH). One or more ultrasonic sensor may be mounted on the side of the rail track head (TH).

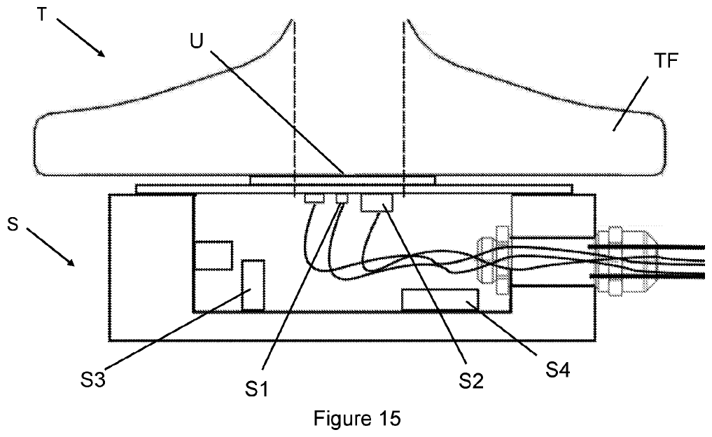

FIG. 15 depicts an example of a multi-sensor sensing probe mounted on the underside of the rail track foot (TF). The sensing probe houses a variety of different sensors. For example, the sensing probe comprises an ultrasonic sensor(S) extending across the underside of the rail track foot and spanning the width of the rail track web. The sensing probe also includes a temperature sensor (S1), whereby example measurements include rail temperature monitoring for neutral rail temperature (NRT), hot axle/hot box detection, detection of stuck wheels. The sensing probe includes an acoustic emission sensor (S2), whereby example measurements include high frequency acoustic analysis for rolling contact fatigue (RCF), roughness, friction, and lubricant characterisation. The sensing probe includes an accelerometer (S3), whereby example measurements include vibration indicating, for example, track displacement, wheel flats and/or out of round wheels. The sensing probe also includes an audible range acoustic sensor (S4), whereby example measurements include noise and/or squeal indicating, for example, corrugation, poor lubrication and severely worn wheels.

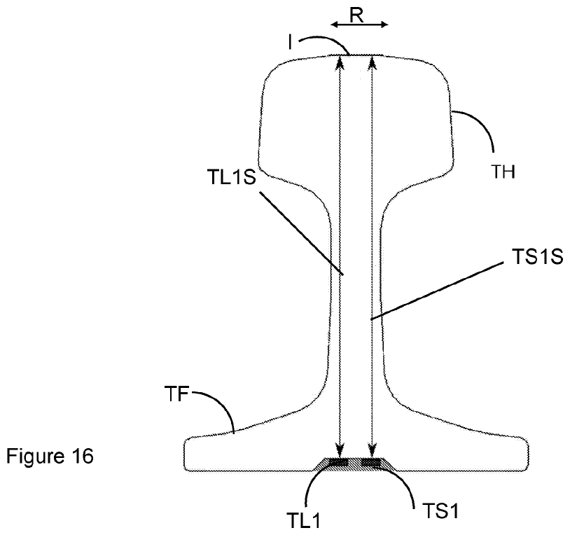

FIG. 16 depicts an example of a multi-planar ultrasonic sensor comprising a longitudinal bulk wave transducer TL1 operating in pulse-echo mode and shear bulk wave transducer TS1 operating in pulse-echo mode. The ultrasonic sensor is embedded in a recess formed on the underside of the rail track foot TF. The longitudinal bulk wave transducer and shear bulk wave transducer are configured to form a sensing region (R) of the rail track that is a segment of the rail track approximately the width of the web and approximately the height of the rail track. The sensing region comprises an interface surface (I) at which an interface forms between rail track and rail vehicle wheel, air, and/or third body etc. Due to the arrangement of the ultrasonic sensor, the interface surface is a track tread region (upper surface region) of the track head (TH). The longitudinal bulk wave transducer TL1 operates in pulse-echo mode and is configured to emit a longitudinal bulk wave signal through the rail track towards the interface surface (I), and detect a reflected longitudinal bulk wave signal (TL1S) that propagates in a return path through the sensing region of rail track following reflection at the interface formed at the interface surface (I). The shear bulk wave transducer TS1 operates in pulse-echo mode and is configured to emit a shear bulk wave signal (TS1S) through the sensing region of the rail track towards the interface surface (I), and detect a reflected shear bulk wave signal that propagates in a return path through the sensing region of the rail track following reflection at the interface formed at the interface surface.

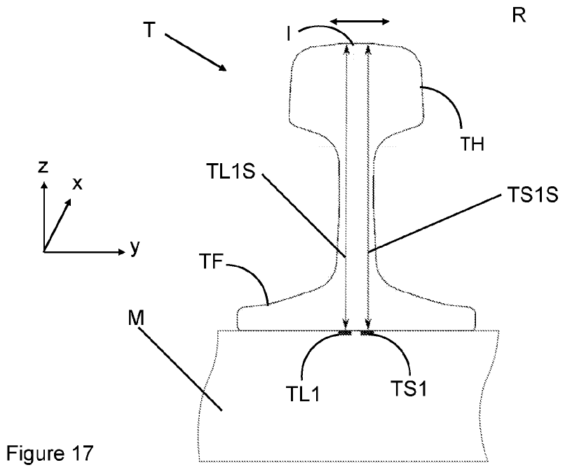

FIG. 17 depicts an example of a multi-planar ultrasonic sensor arranged between the underside of a rail track foot (TF) and a mount M, on which the rail track (T) is located. The mount may be a sleeper or a pad. The ultrasonic sensor comprises a longitudinal bulk wave transducer (TL1) and a shear bulk wave transducer (TS1) configured to form a sensing region (R) in the rail track. The longitudinal bulk wave transducer (TL1) operates in pulse-echo mode and is configured to emit a longitudinal bulk wave signal through the sensing region of the rail track to the interface surface (I) and detect the reflected longitudinal bulk wave signal (TL1S). The ultrasonic sensor also comprises a shear bulk wave transducer (TS1) operating in pulse-echo mode and configured to emit a shear bulk wave signal through the sensing region of the rail track to the interface surface (I) and detect the reflected shear bulk wave signal. Due to the arrangement of the ultrasonic sensor, the interface surface at a track tread region (upper surface region) of the track head (TH), and the sensing region (R) extends the full height of the rail track from the underside of track foot (TF) to the interface surface (I). Hence, the emitted and reflected ultrasonic wave signals propagate the full height of the rail track parallel to the vertical axis (z-axis) of the rail track.

The ultrasonic sensor may comprise one or more ultrasonic sensing unit. For example, the ultrasonic sensor may comprise:
a first ultrasonic sensing unit with an emitting ultrasonic wave transducer and arranged at a first location on a rail track; and
a second ultrasonic sensing unit with a corresponding detecting ultrasonic wave transducer and arranged at a second location of the rail track.

The emitting ultrasonic wave transducer and corresponding detecting ultrasonic wave transducer are operating in pitch-catch mode. The emitting ultrasonic wave transducer and corresponding detecting ultrasonic wave transducer may be configured to emit and detect at least one longitudinal bulk wave signal, at least one shear bulk wave signal, at least one longitudinal surface signal or at least one shear surface wave signal.

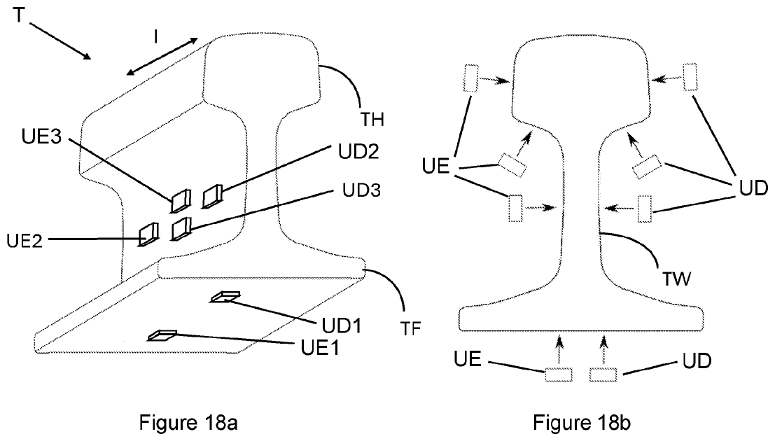

FIGS. 18a and 18b depict examples of multi-unit ultrasonic surface wave sensors, and show how emitting ultrasonic surface wave transducers (UE) and detecting ultrasonic surface wave transducers (UD) may be mounted on the rail track (T) to emit and detect surface wave signals propagating along a surface of the rail track. For example, as shown in FIGS. 18a and 18b, one or more of the surface transducers may be on the underside the rail track foot (TF). One or more of the surface transducers may be mounted on the underside of rail track head (TH). One or more of the surface transducers may be mounted on a side of the rail track head. One or more surface transducers may be mounted on the web of the rail track (TW). The emitting and detecting ultrasonic surface wave transducers may be mounted on the rail track to emit and detect surface waves propagating along a surface of the rail track in a direction parallel to the vertical axis (z-axis) of the rail track, or in a direction parallel to the longitudinal axis (x-axis) of the rail track or in a direction parallel to the lateral axis (y-axis) of the rail track. The emitting and detecting ultrasonic surface wave transducers may be mounted on the rail track to emit and detect surface waves propagating along a surface of the rail track via the interface surface (I), or separate and spaced from the interface surface. In FIG. 18a, the emitting and detecting ultrasonic surface wave transducers (UE1, UD1) are mounted on the underside of the trail track head to form a first sensing region, and configured to emit and detect surface waves propagating along the underside surface of the rail track foot in a direction parallel to the longitudinal axis (x-axis) of the rail track. The emitting and detecting ultrasonic wave transducers (UE2, UD2) are mounted on the web of the rail track to form a second sensing region, and configured to emit and detect surface waves propagating along the web surface of the rail track in a direction parallel to the longitudinal axis (x-axis) of the rail track. The emitting and detecting ultrasonic surface wave transducers (UE3, UD3) are mounted on the web of the rail track to form a third sensing region, and configured to emit and detect surface waves propagating along the web surface of the rail track in a direction parallel to the vertical axis (z-axis) of the rail track. The surfaces along which to surface waves are emitted and detected by the surface wave transducers (UE1, UD1, UE2, UD2, UE3, UD3) are separate and spaced from the interface surface at which an interface forms during monitoring.

The apparatus may comprise a clamp, spring mechanism, magnetic mechanism, lever, hydraulic compression mechanism or pneumatic suction mechanism, or any other suitable means, to mount the ultrasonic sensor on the rail track or mount adjacent the rail track.

The clamp may be configured and positioned in use so as not to impair the passing of the rail vehicle wheel over the rail track.

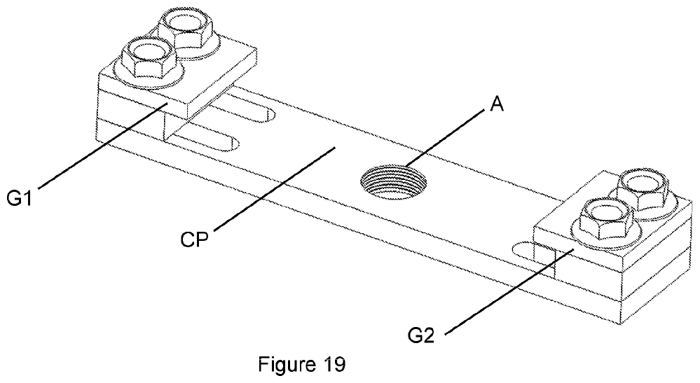

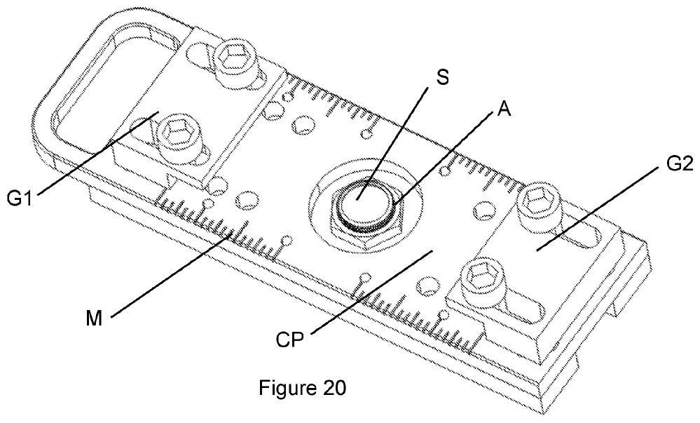

FIGS. 19 and 20 depicts an example of a clamp for mounting an ultrasonic sensor housed in a sensing probe to the underside of the rail track foot. In this example, the clamp comprises a central portion (CP) that extends across the underside of the rail track foot. The central portion comprises a sensing probe aperture A through which an ultrasonic sensing probe(S) can protrude after being inserted from below. In an alternative design, the central portion may comprise a sensing probe recess in which the ultrasonic sensing probe can be located. The clamp also comprises a first grip (G1) and a second grip (G2) arranged at each ends of the central portion to engage the opposing edges of the rail track foot. As shown in FIG. 20, the clamp may have position markers (M) on the upper surface to ensure the clamp is installed in the correct position on the rail track. The clamp has a low profile design that does not encroach on the rail track web or head, and does not impede the passing of the rail vehicle wheel along the rail track. The clamp has sufficient resilience to withstand vibration and maintain a secure fixing. The clamp is quick and easy to install.

To allow for co-monitoring at parallel rail tracks, the apparatus may comprise:
a first ultrasonic sensor arranged on a first rail track; and
a second ultrasonic sensor arranged on a second rail track, whereby the first rail track and second rail track are a parallel set of tracks, and the first ultrasonic sensor and second ultrasonic sensor are arranged parallel.

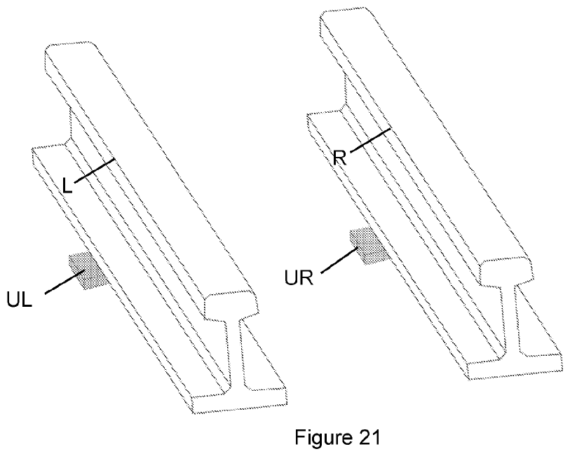

FIG. 21 depicts an example of the sensing apparatus, where the sensing apparatus comprises a pair of ultrasonic sensors (UL, UR) arranged in parallel with respect to each rail track (L, R) to create parallel ultrasonic sensing regions on the parallel rail tracks. The ultrasonic sensors may comprise at least one longitudinal bulk wave transducers, at least one shear bulk wave transducers, at least one longitudinal surface wave transducers, at least one shear surface wave transducers, multi-frequency transducers and/or multi-polarised transducers. In this example, each ultrasonic sensor is arranged on the underside of the rail track foot by a clamp. By simultaneously sensing the rail vehicle-rail track interactions at the sensing regions of both rail tracks a comparative assessment of both rails can be conducted. For example, the change in amplitude of the wave signals can be calculated to determine the precise contact location of each wheel on the respective rail track. From this, the angle of attack/yaw of the wheelset may be determined. By comparing the time of flight of the wave signals, the normal force acting on each rail can be determined to identify any uneven contact and loads.

To allow for multi-frequency monitoring, the ultrasonic sensor may comprise:
an emitting ultrasonic sensing unit with an emitting ultrasonic wave transducer configured to emit ultrasonic wave signals with a first frequency and second frequency, and arranged at a first location on a rail track;
a first detecting ultrasonic sensing unit with a detecting ultrasonic wave transducer configured to detect the ultrasonic wave signals with the first frequency, and arranged at a second location of the rail track;
a second detecting ultrasonic sensing unit with a detecting ultrasonic wave transducer configured to detect ultrasonic wave signals with a second frequency, and arranged at a third location of the rail track.

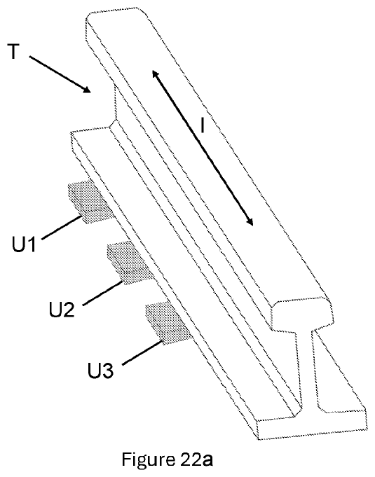

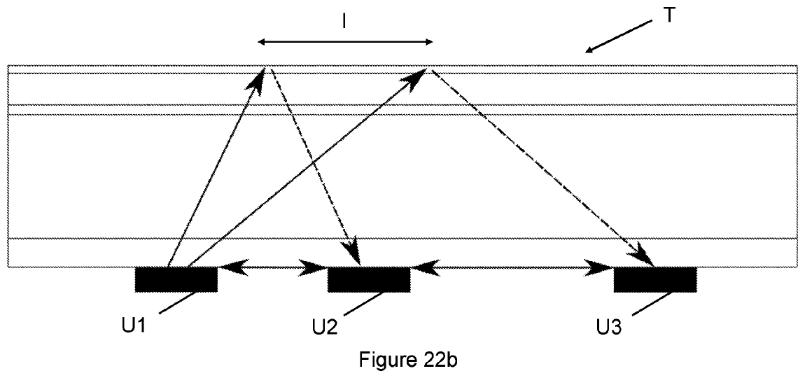

FIGS. 22a and 22b depict an example where the sensing apparatus comprises first sensor unit (U1) comprising bulk wave transducers configured to emit ultrasonic bulk wave signals with a first frequency and a second frequency towards an interface surface (I) of the rail track (T), where at least a portion of each bulk wave signal is reflected from the interface formed at the interface surface. The sensing apparatus comprises a second sensor unit (U2) comprising a bulk wave transducer configured to detect the at least one reflected ultrasonic bulk wave signal with the first frequency. The sensing apparatus comprises a third sensor unit (U3) comprising a bulk wave transducer configured to detect the at least one reflected ultrasonic bulk wave signal with a second frequency. The sensor units are arranged linearly along the rail track at a first location, second location and third location respectively. By emitting ultrasonic bulk wave signals with a beam spread to propagate at an angle through the rail track to the interface, and thereby extending the propagation path of the reflected ultrasonic bulk wave signals through the rail track, the sensitivity of the force-induced elasticity effects is improved and force measurements based on the ultrasonic wave signals are improved.

The beam spread of an ultrasonic signal is dependent on the frequency of the ultrasonic signal, whereby the greater the frequency the smaller the beam spread. As shown in FIGS. 22a and 22b, if the first sensor unit emits ultrasonic bulk wave signals of different frequencies to propagate to the interface surface of the rail track, the apparatus may comprise a plurality of detecting sensor units arranged in space relationship along the length of the rail track to detect the ultrasonic wave signals emitted by the first sensor unit and reflected from the interface at the interface surface. The detecting sensor units each detect ultrasonic bulk wave signals of a different frequency and thereby different beam spread. In FIGS. 22a and 22b the first emitter sensor unit (U1) emits at least one first bulk wave signal at a high frequency with a low beam spread to be detected by the second sensor unit (U2), and at least one second bulk wave signal with a lower frequency with a higher beam spread to be detected by the third detecting sensor unit (U3).

In the example depicted in FIGS. 22a and 22b, the first sensor unit (U1), second sensor unit (U2) and third sensor unit (U3) also comprise surface wave transducers configured to emit and detect surface waves propagating along the underside surface of the track foot.

### Controller

The apparatus may further comprise a controller configured to control the operation the ultrasonic sensor.

For example, the controller may be configured to selectively control the operation of one or more transducer of the ultrasonic sensor to allow for monitoring with selected combinations of transducers. In an example, the controller may be configured to selectively control the simultaneous operation of multiple transducers. The controller may be configured to selectively control the simultaneous operation of one type of transducer in combination with another type of transducers. The controller may be configured to selectively control the operation of transducers operating at one or more desired frequency. The controller may be configured to selectively control the operation of shear transducers with one or more desired polarisations. The controller may be configured to control the operation of the ultrasonic sensor to simultaneously detect ultrasonic wave signals as the rail vehicle wheel passes over the sensing region of the rail track and the wheel-rail track interface is formed at the interface surface. The controller may be configured to control the operation of the ultrasonic sensor to detect reference ultrasonic wave signals when the sensing region of the rail track is in known reference state (for example, the interface surface is under a known load or unloaded). For example, the controller may be configured to control the operation of the ultrasonic sensor to detect ultrasonic wave signals when the interface surface of the rail track is exposed to the atmosphere and an air-rail track interface is formed at the interface surface. The controller may be configured to control the operation of the ultrasonic sensor to detect ultrasonic wave signals for a predetermined period of time (for example, when a rail vehicle is travel along a rail track and the rail vehicle is downstream, passing and/or upstream from sensing region of the rail track). The controller may be configured to control the operation of the ultrasonic sensor to continuously or intermittently detect ultrasonic wave signals.

### Processor

Following detection by the ultrasonic transducers, the apparatus and method may utilise a processor to process the detected ultrasonic wave signals.

The processor allows for simultaneous processing of the detected ultrasonic waves. The processor allows for real-time processing of the detected ultrasonic wave signals, for example, as the rail vehicle passes over the sensing region of the rail track and forms a wheel-rail track interface at the interface sensing region.

The processor may be configured to process the detected ultrasonic wave signals to determine one or more characteristic of the detected ultrasonic wave signals.

The characteristic may be a time of flight of the detected ultrasonic wave signal. The time of flight of the detected ultrasonic wave signal is the time the ultrasonic wave takes to travel from the emitting transducer to the detecting transducer, which is dependent on the ultrasonic wave velocity. For the bulk wave signals, the time of flight is the time taken to travel a predetermined distance to and from the reflecting interface between the emitting ultrasonic bulk wave transducer and the detecting ultrasonic bulk wave transducer. For surface wave signals, the time of flight is the time take to travel a predetermined distance along the rail track surface between the emitting ultrasonic surface wave transducer and the detecting ultrasonic surface wave transducer.

The characteristic of the detected wave signal may comprise the amplitude of the detected wave signal. The amplitude is the strength of the detected ultrasonic wave.

The processor may be configured to determine the characteristic of the detected wave signal from the time domain and/or the frequency domain of the detected ultrasonic wave signal. For example, the processor may be configured to determine a characteristic from the time domain and/or frequency domain of the detected ultrasonic longitudinal bulk wave signal, detected ultrasonic shear bulk wave signal, detected ultrasonic longitudinal surface bulk wave signal and/or detected ultrasonic shear surface wave signal.

The processor may be configured to determine a track interaction parameter based on the characteristic of the detected ultrasonic wave signal, wherein the characteristic is indicative of the track interaction parameter. The processor may be configured to determine vehicle-track interaction (VTI) based on the characteristic of the detected ultrasonic wave signal when a rail vehicle is travelling along the rail track (for example, when the rail vehicle is passing the sensing region, upstream from the sensing region and/or downstream from the sensing region).

The characteristics of the detected ultrasonic wave signals are indicative of one or more interaction parameter. For example, the time of flight of the ultrasonic waves may be indicative of a normal (vertical) load, lateral load, overloading, uneven loading, pummeling, friction coefficient, traction, yaw, angle of attack, tracking (wheel alignment) of the wheel, hunding, wheel impact, wheel flats, wheel slip, location of wheel contact, wheel rim contact, wheel flange contact, wheel climb at the interface surface of the sensing region of the rail track. For example, the amplitude of the ultrasonic waves may be indicative of a wheel contact with the interface surface, location of contact, wheel rim contact, wheel flange contact, wheel climb, contact pressure, contact geometry, interfacial contact stiffness (which is an indication of rail track surface finish and roughness), rail track surface finish, rail track roughness, characterisation of third body layers, friction coefficient, traction, yaw, angle of attack, tracking, hunting, wheel impact, wheel flats, wheel slip. The time of flight and/or amplitude of the detected ultrasonic wave signals may be indicative of rail track features including gauge, vertical alignment, super elevation, camber, cant, roll, twist, switch and crossing health, breaks and fractures, rolling contact fatigue (RCF), squats, wheel burns, head checks, studs, cyclic top, corrugation, spalling flanking, running bend deviation and corrosion. Also the time of flight and/or amplitude of the detected ultrasonic wave signals may be indicative of rail vehicle features including wheel wear, hollow wheels, suspension issues, stuck brakes, stuck wheels, and lateral position of wheels on the rail track.

The apparatus may comprise a processor configured to process the detected ultrasonic wave signals. The processor may be configured to:
determine a characteristic of a detected ultrasonic wave signal; and
determine a track interaction parameter based on the characteristic of the detected ultrasonic wave signal, wherein the characteristic of the detected ultrasonic wave signal is indicative of the track interaction parameter.

For example, to monitor vehicle-track interaction, the processor may be configured to process the detected ultrasonic wave signals as a rail vehicle travels along the rail track. The processor may be configured to:
determine a characteristic of a detected ultrasonic wave signal; and
determine a vehicle-track interaction parameter based on the characteristic of the detected ultrasonic wave signal, wherein the characteristic of the detected ultrasonic wave signal is indicative of the vehicle-track interaction parameter.

For example, when the ultrasonic sensor is configured to detect at least one longitudinal bulk wave signal reflected from the wheel-rail track interface and/or at least one shear bulk wave signal reflected from the wheel-rail track interface, the processor may be configured to:
determine a characteristic of the detected longitudinal bulk wave signal and/or the characteristic of the detected shear bulk wave signal; and
determine a track interaction parameter based on the characteristic of the detected longitudinal bulk wave signal and/or the characteristic of the detected shear bulk wave signal, wherein the characteristic of the detected longitudinal wave bulk signal and/or characteristic of the detected shear bulk wave signal is indicative of the track interaction parameter.

For example, when the ultrasonic sensor is configured to detect at least one longitudinal surface wave signal as the rail vehicle wheel passes over the sensing region of the rail track and/or at least one shear surface wave signal as the rail vehicle passes over the sensing region of the rail track, the processor may be configured to:
determine a characteristic of the detected longitudinal surface wave signal and/or the characteristic of the detected shear surface wave signal; and
determine a vehicle-track interaction parameter based on the characteristic of the detected longitudinal surface wave signal and/or the characteristic of the detected shear surface wave signal, wherein the characteristic of the detected longitudinal surface wave signal and/or characteristic of the detected shear surface wave signal is indicative of the vehicle-track interaction parameter.

To determine a vehicle-track interaction parameter, the processor may be configured to compare the characteristic of the detected ultrasonic wave signal as the rail vehicle is passing over the sensing region of the rial track and forming a wheel-track interface at the interface surface to a corresponding characteristic of a detected reference ultrasonic wave signal when the interface at the interface surface is known and the sensing region is thereby in a known reference state.

The processor may be configured to determine whether the characteristic of the detected ultrasonic wave signal (and thereby the detected track interaction parameter) is within a predetermined range, above a predetermined threshold, or below a predetermined threshold. For example, the processor may be configured to determine whether the characteristic of the detected ultrasonic longitudinal wave signal (and thereby the detected track interaction longitudinal parameter) is within a predetermined range, above a predetermined threshold or below a predetermined threshold. The processor may be configured to determine whether the characteristic of the detected ultrasonic shear wave signal (and thereby the detected track interaction shear parameter) is within a predetermined range, above a predetermined threshold or below a predetermined threshold.

The processor may be configured to determine whether a change between the characteristic of the detected ultrasonic wave signal (and thereby the change in the track interaction parameter) is within a predetermined range, above a predetermined threshold or below a predetermined threshold. For example, the processor may be configured to determine whether a change between the characteristic of the detected ultrasonic longitudinal wave signal (and thereby the change in the track interaction parameter) is within a predetermined range, above a predetermined threshold or below a predetermined threshold. The processor may be configured to determine whether a change between the characteristic of the detected ultrasonic shear wave signal (and thereby the change in the track interaction parameter) is within a predetermined range, above a predetermine threshold, or below a predetermined threshold.

The apparatus may further comprise an alarm, wherein the alarm is configured to activate when the characteristic of the detected ultrasonic wave signal (and thereby the track interaction parameter) or the change in the characteristic of the ultrasonic wave signal (and thereby the change in the track interaction parameter) is outside the predetermined range, above the predetermined threshold or below the predetermined threshold. The alarm may comprise an audible alarm, user readable alarm and/or a visual alarm.

### The Time of Flight of the Ultrasonic Wave Signals

The multiplanar ultrasonic sensor allows for simultaneous measuring of longitudinal and shear waves to provide accurate sensing of the time of flight and changes in the time of flight (which is indicative of the change in ultrasonic wave velocity), and subsequent determining of track interaction parameters based on the time of flight/change in time of flight, which are indicative of stress (loads) and strain in the rail track and rail vehicle wheel.

The multiplanar ultrasonic sensor may comprise at least one longitudinal bulk wave transducer detecting a reflected longitudinal bulk wave signal and at least one shear bulk wave transducer detecting a reflected shear bulk wave signal. Alternatively, or additionally, the multi-planar ultrasonic sensor may comprise at least one longitudinal surface wave transducer detecting a surface longitudinal wave signal and at least one shear surface wave transducer detecting a surface shear wave signal. The multi-planar ultrasonic sensor may detect wave signals with multiple frequencies and/or multiple directions of polarisations.

The time of flight is dependent on the ultrasonic wave velocity. Ultrasonic wave velocity (the ultrasonic wave velocity of the wave propagating at the sensing region of the rail track) is dependent on the elasticity of the rail track and this, in turn varies according to load acting on the rail track at the sensing region.

The elasticity modulus that defines the acoustic velocity is dependent on the type of wave signal. The acoustic velocity of longitudinal waves is predominantly influenced by Young's modulus, while the acoustic velocity for shear waves is a function of the shear modulus. The change in acoustic velocity for a given load is therefore dependent on both the wave polarisation and its propagation direction relative to the direction of the load. Hence, ultrasonic wave velocity is dependent on the type of wave and direction of the load. Ultrasonic waves are predominantly affected by load acting in the same plane as the polarisation of the transducer. For example, longitudinal wave velocity and shear wave velocity are affected differently depending on the direction of applied load. For example, applying a compression load to a rail track/wheel increases the acoustic velocity for a longitudinal wave. The application of a tension load on the rail track/wheel decreases longitudinal wave velocity.

As a rail vehicle wheel travels along the rail track it applies a force to the rail track. The rail track and the wheel thereby become loaded, and their elasticity changes. This change in elasticity results in a change in the acoustic velocity of the ultrasonic signal propagating in the sensing region of the rail track.

When the rail track is in compression due to the load, and a longitudinal wave (bulk and/or surface) propagates in the direction of the load, the acoustic velocity of the propagating longitudinal wave increases and the time-of-flight decreases. Inversely, when the rail track or wheel is in tension, the acoustic velocity of the propagating longitudinal wave (bulk and/or surface) decreases and the time-of-flight increases.

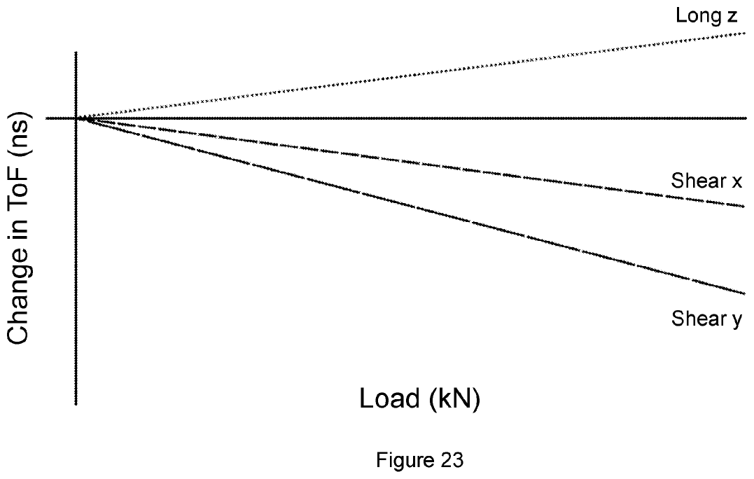

Moreover, as shown in FIG. 23, the change in the time of flight also varies with respect to a load applied at the interface surface in the z direction for ultrasonic waves polarised in different directions.

Given that the time of flight of the ultrasonic wave signals is dependent on the load/strain acting on the rail track, measuring of the time of flight for the longitudinal and/or shear wave wave signals allows for the load/strain acting on the rail track to be derived.

Simultaneous measuring of the time for flight for longitudinal and shear wave signals (bulk and/or surface) in different polarisations allows for the three-dimensional load/strain state of the rail track to be determined.

For reflected bulk wave signals (longitudinal and/or shear), the change in time of flight may be determined by assessing change in the time it takes for the ultrasonic waves to travel through the rail track and back again in a known state (unloaded or known load) relative to an unknown state. For surface wave signals (longitudinal and/or shear), the change in time of flight may determined by assessing the time it takes for the ultrasonic waves to travel a predetermined distance along the surface of the rail track/wheel in a known state relative to the unknown state.

Therefore, to determine the change in the time of flight, the processor may be configured to:
compare the time of flight of the detected longitudinal wave signal (bulk and/or surface) to the time of flight of a reference longitudinal wave signal (bulk and/or surface);
compare the time of flight of the detected shear wave signal (bulk and/or surface) to the time of flight of flight of a reference shear wave signal (bulk and/or surface).

The reference longitudinal wave signal (bulk and/or surface) and reference shear wave signal (bulk and/or surface) may be detected by the ultrasonic sensor when the rail track is in a known reference state. The rail track may be in a known reference state when unloaded (for example when the sensing region of the rail track is exposed to the atmosphere) or under a known load.

To allow for the comparative assessment, the apparatus may be configured to detect the reference longitudinal and shear wave signals (bulk and/or surface) when the rail track/wheel is in the known state (unloaded or subject to a known load).

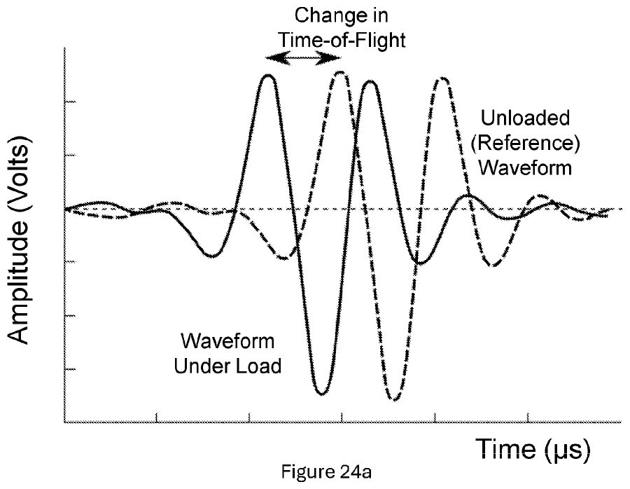

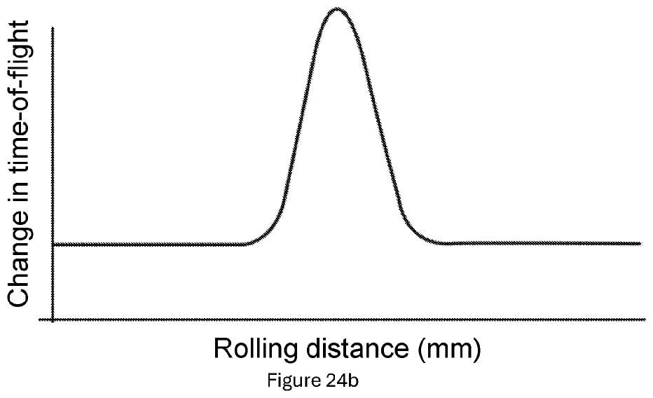

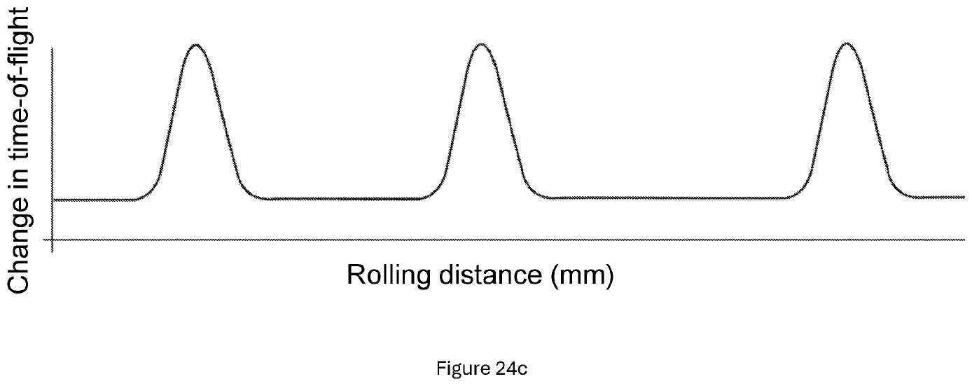

FIG. 24a depicts a comparative time of flight graph for a reference ultrasonic wave signal when the rail track is unloaded and an ultrasonic wave signal when the rail track is under load. The graph shows that as the rail track experiences strain under an unknown load, the ultrasonic waves shift/change position in the time-domain. By comparing the time shift of the two traces, the change in time-of-flight can be calculated.

FIG. 24a relates to an example where, for an ultrasonic longitudinal wave signal (bulk and/or surface), compression of the rail track in the direction of pressure wave vibration has the effect of increasing the acoustic velocity of the wave signal, and this can be seen as a wave signal shifts earlier in the time domain in a comparative time of flight graph.

However, for an ultrasonic longitudinal wave signal, tension of the rail track in the direction of pressure wave vibration has the effect of decreasing the acoustic velocity of the ultrasonic longitudinal wave signal. This can be seen as a wave signal shift later in the time domain in the comparative time of flight graph.

The processor may be configured to relate the time of flight for each wave signal to the deflection of the rail track whereby:

$$Δ t = \frac{- 2 {d}_{0} αδ}{c ( {d}_{0} - αδ )}$$

wherein Δt is the change in time of flight;
wherein δ is a deflection of the rail track or wheel;
wherein d₀ is an initial length (the height of the rail track for a rail track mounted sensor);
wherein c is the unstrained acoustic velocity.

The acoustoelastic constant α is a function of the steel material properties and is determined experimentally. A typical value for a rail track steel and a longitudinal wave is α=−2.5.

The change in time of flight can be used to calculate the load acting on the rail track. As such, the processor may be configured to determine load F whereby:

$$F = \frac{Δ tcEA}{α ( Δ tc - 2 {d}_{0} )}$$

wherein F is Load;
wherein E is the Youngs Modulus;
wherein A is the wheel-rail track contact interface area in the place of deflection.

The same equation can be applied to ultrasonic wave signals of different frequencies and/or different polarisations by substituting the relevant speed of sound and acoustoelastic constant for each wave signal.

For example, using the relevant values for a longitudinal ultrasonic wave, the normal load V can be determined, and for each longitudinal ultrasonic wave at a different frequency.

For example, using relevant values for a shear ultrasonic wave, the lateral load L can be determined, and for each shear ultrasonic wave at a different frequency. Using the shear ultrasonic wave signals detected by at least one shear wave transducer polarised in the lateral direction across the width of the rail, the lateral load Ly can be determined, and from which uneven rail vehicle load and cornering/flange contact/track alignment issues can be identified. Using the shear ultrasonic wave signal detected by at least one shear wave transducer polarised in the longitudinal direction along the length of the rail, the longitudinal load Lx can be determined, and from which poor pre-loading and temperature effects (expansion and contraction) in continuously welded rail track can be identified.

In an example of the ultrasonic sensor mounted to the underside of the rail track foot, the processor may be configured:
to determine normal load from the vehicle load based on the longitudinal wave signal detected by the least one longitudinal wave transducer (bulk, surface, multi-frequency longitudinal wave); and/or
to determine lateral loading based on the shear wave signal (bulk, surface multi-frequency shear waves) detected by at least one shear wave transducer, whereby shear wave transducer is polarised to detect ultrasonic waves oscillating in a direction across the width of the rail track (shear wave is polarised in the Y direction); and/or
to determine longitudinal loading based on the shear wave signal (bulk and/or surface) detected by at least one shear wave transducer, whereby the shear wave transducer is configured to detect shear wave oscillating in a direction parallel to the longitudinal axis of the rail track (shear wave polarised in the same direction as the longitudinal axis of the rail).

The longitudinal wave transducer may be detecting a reflected longitudinal wave or a longitudinal surface wave. The shear wave transducer may be detecting a reflected shear wave or a shear surface wave.

By having the different multiplanar transducers at the same location, the multiplanar sensor allows the direct comparison of the different measurements to yield load relationships such as L/V load ratio, where Ly is the lateral load detected by the shear wave transducer polarised in the Y direction and V is the normal load detected by the longitudinal wave transducer.

Having the different transducers being processed by the same processor facilitates comparative data treatment operations to be performed.

The loads acting on the rail track at the sensing region as derived from the time of flight are indicative on the strain, the location of contact, wheel rim contact, wheel flange contact, wheel climb overloading of rail vehicle, uneven loading, pummeling, friction coefficient, track, yaw, angle of attack, tracking, hunting, wheel impact, wheel flats and wheel slip. Hence, the loads may indicate problems between the rail track, risk of derailment, need for lubricant etc.

The apparatus may further comprise an alarm (audible, visible) configured to activate if the determined load acting on rail track/vehicle is outside a threshold range, above a threshold value or below a threshold value.

During monitoring over a predetermined time period, the longitudinal wave signal (bulk, surface, multi-frequency) detected by the longitudinal wave transducer and/or shear wave signal detected by the shear wave transducer may comprise a pattern indicative of the rail vehicle travelling along the track with respect to the sensing region of the rail track (for example, when the rail vehicle is upstream, passing and/or downstream the sensing region of the rail track).

As such, the processor may be configured:
to identify a pattern in the detected longitudinal wave signal and/or the detected shear wave signal, wherein the pattern is indicative of the rail vehicle travelling along the rail track with respect to the sensing region of the rail track for a predetermined period of time;
to determine a changing vehicle-rail track interaction based on the pattern.

During monitoring over a predetermined time period, the detected ultrasonic wave signals may comprise a pattern indicative of multiple wheel-rail track interactions as the multiple wheels pass over the sensing region of the rail track. FIG. 24b shows the change in time of flight during a single wheel passing event and FIG. 24c shows the change in time of flight for multiple wheel pass events

As such, the processor may be configured:
to identify a pattern in the detected longitudinal wave signal and/or the detected shear wave signal, wherein the pattern is indicative of multiple rail vehicle wheels passing over the rail track during a predetermined period of time;
to determine an axle count and/or velocity of the rail vehicle wheels passing over the rail track based on the pattern.

### The Amplitude of Ultrasonic Wave Signals

The multiplanar ultrasonic sensor allows for simultaneous measuring of longitudinal and shear waves to provide accurate sensing of the amplitude and changes in the amplitude, and subsequent determining of track interaction parameters based on the amplitude/change of amplitude at the sensing region of the rail track.

The one or more interface parameter derivable from the amplitude of detected ultrasonic wave signals may include contact location, geometry of the mating contact region between the rail vehicle wheel and rail track, identify an intermediate layer (third body) between the rail vehicle wheel and the rail track such as leaves, friction modifiers, corrosion, or ice, identify surface roughness, identify the angle of attack/yaw of the wheel acting on the rail track, tracking of the wheel, hunting of the wheel, wheel slip and/or identify stiffness of the interface (for example, multi-planar interface stiffness).

The multi-planar ultrasonic sensor may comprise at least one longitudinal wave transducer detecting a reflected longitudinal wave signal and at least one shear wave transducer detecting a reflected shear wave signal. Alternatively, or additionally, the ultrasonic sensor may comprise at least one longitudinal surface wave transducer detecting a surface longitudinal wave signal and at least one shear surface wave transducer detecting a surface shear wave signal. The multi-planar ultrasonic sensor may detect wave signals with multiple frequencies and/or multiple directions of polarisations.

The amplitude of an ultrasonic bulk wave (longitudinal or shear) reflected from the interface formed at the interface surface is indicative of contact interface parameters. A change in the amplitude of the ultrasonic bulk wave (longitudinal or shear) is indicative of a change in contact at the interface surface.

The amplitude of the ultrasonic surface wave (longitudinal or shear) propagating along the surface of the rail track via the interface surface is indicative of contact interface parameters. The change in the amplitude of the ultrasonic surface wave (longitudinal or shear) is indicative of a change in contact at the interface surface.

The amplitude of the ultrasonic surface wave propagating along the surface of the rail track that is separate and spaced from the interface surface is indicative of load and/or wheel parameters. The change in the amplitude is indicative of a change in the load or wheel parameters at the interface surface.

As explained further below, normal stiffness of the interface can be derived from the amplitude of one or more longitudinal wave signals. Shear stiffness of the interface can be derived from the amplitude of one or more shear wave signals.

When a longitudinal and/or shear bulk wave strikes an interface formed at the interface surface of the sensing region of the rail track, for example the wheel-track interface, the amount of ultrasonic energy transferred across the interface is proportional to the acoustic impedance of the materials bounding the interface and the conditions at the interface.

For a longitudinal bulk wave and a vehicle-rail track interface (solid-solid interface), the interface normal stiffness affects the portion of transmission of the longitudinal bulk wave at the interface. If a liquid is present at the interface, then the liquid's compressibility plays a role.

Similarly for a shear bulk wave and a vehicle-rail track interface (solid-solid interface), the shear stiffness influences the proportion of transmission of the shear bulk wave at the interface. If a liquid is present at the interface, then the liquid's viscosity plays a role.

Simultaneous measuring of the amplitude of longitudinal and shear wave signals in different polarisations allows for the three-dimensional interface stiffness of the rail track or wheel to be determined.

The change in amplitude is determined by assessing the change in amplitude of the ultrasonic waves propagating through the sensing region of the rail track in a known reference state (unloaded or known load) relative to the unknown state.

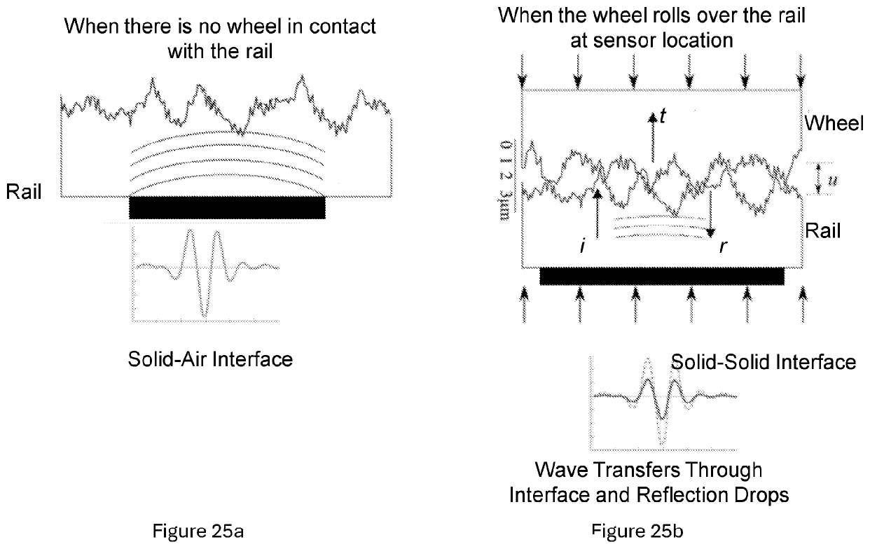

FIG. 25a depicts an example when the interface surface is exposed to the atmosphere and an air-rail track interface forms at the interface surface (no wheel contacts the interface surface and the sensing region is in an unloaded state), approximately 100% of an ultrasonic bulk wave is reflected from the air-rail track interface.

However, FIG. 25b depicts an example when, as the wheel rolls over the interface surface at the sensing region of the rail track to form the wheel-rail track interface, part of the soundwave is transferred into the wheel, and the reflected ultrasonic bulk wave signal drops in amplitude:

As such, the unloaded interface surface that is exposed to the atmosphere, may be considered as being in a known reference state and the detected ultrasonic waves signals may be considered reference ultrasonic wave signals.

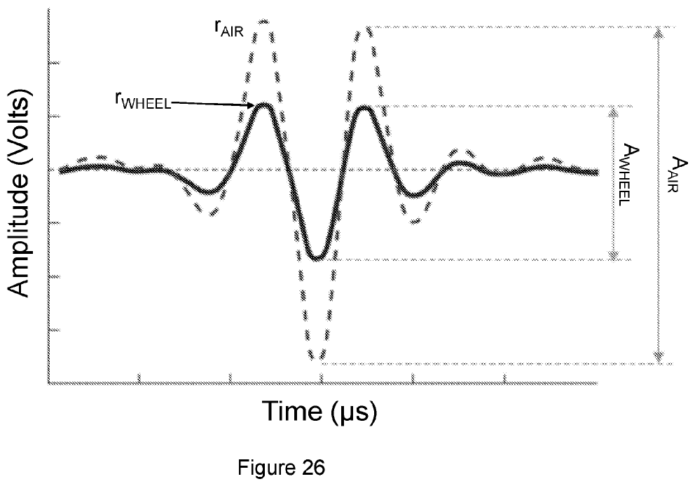

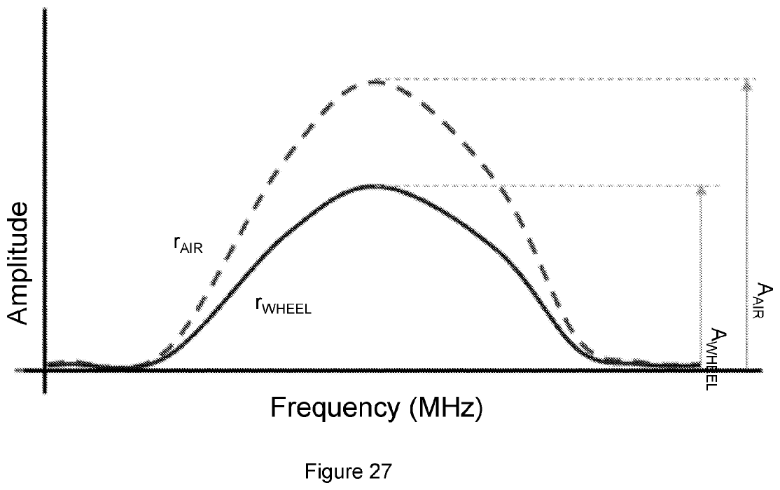

The amplitude of the detected ultrasonic wave signals can be extracted in the time domain using the peak-to-peak amplitude of the signal as shown in the time-amplitude graph as shown in FIG. 26. However, if the ultrasonic sensor detects signals of different frequencies, the amplitude of the reflected signals may be extracted in the frequency domain using a Fast Fourier Transform (FFT) as shown in the frequency-amplitude graph as shown in FIG. 27. In these graph examples, Aair is the amplitude of the detected ultrasonic wave signals propagating through the sensing region of the rail track and measured when the sensing region of the rail track is in the reference state when no wheel is present and there is an air-rail track interface; and Awheel is the amplitude of the detected ultrasonic wave signals propagating through the sensing region of the rail track when the wheel passes over the rail track and the wheel-rail track interface is formed.

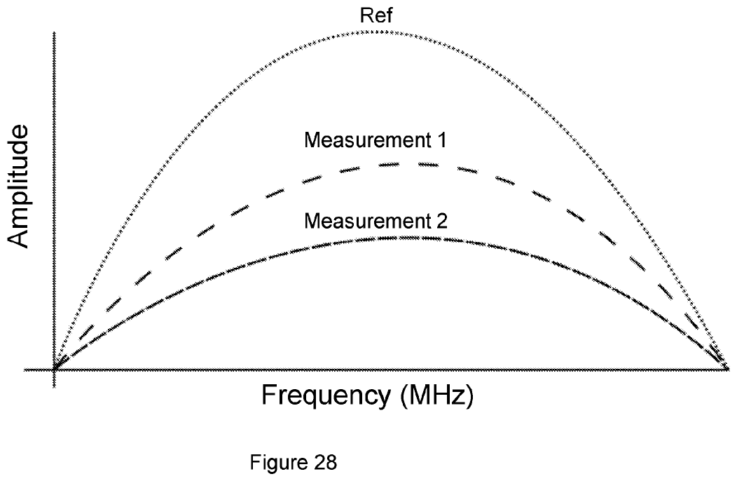

This dynamic change in amplitude is compared to the reference as shown in FIG. 28. Measurements 1 and 2 relate to the amplitude of two different ultrasonic wave signals. Ref relates to the amplitude of an ultrasonic wave signal when sensing region of the rail track in a reference state. FIG. 28 shows measurement 1 which is a lightly loaded contact and such has a small change in magnitude, whereas measurement 2 shows a highly loaded contact with a large change in amplitude.

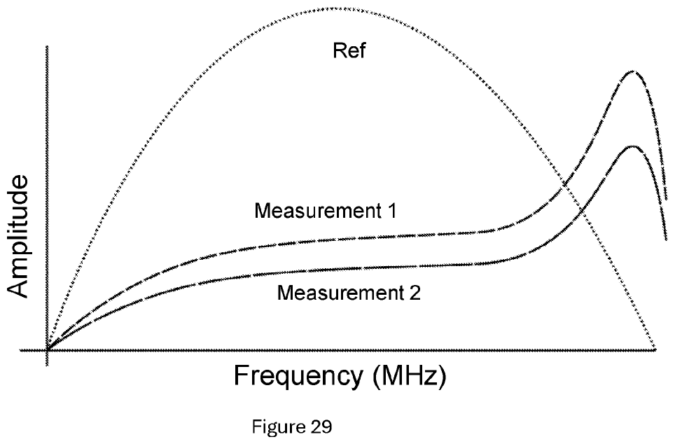

This amplitude change, which can be calculated at a single (index) point on the FFT or across the full spectrum, as shown in FIG. 29.

The amplitude change can then be used as an input for more complex calculations, such as film thickness, layer stiffness etc.

The change in amplitude can be calculated in the time or frequency domain

The stiffness and/or compressibility and/or viscosity can be calculated from the amplitude change considering the frequency and material properties.

When an ultrasonic longitudinal wave signals strike and are reflected by a mixed solid/liquid interface the reflected wave it is affected strongly by both solid and liquid interfacial media.

When ultrasonic shear polarised waves strike and are reflected by a mixed solid/liquid interface, the reflected wave is predominantly affected by the solid media at the interface

Combining information from both the reflected shear and longitudinal waves can therefore yield information not possible with either one type on their own.

Furthermore, if the media at the interface behaves anisotropically, using shear wave transducers polarised in different directions can yield additional information about the interfacial material properties.

By varying the transducer frequency, the frequency-dependent interfacial properties can be extracted to yield additional information about the interfacial elements.

When the sensor is mounted on the rail track, and the characteristic of the detected longitudinal wave signal comprises amplitude, the processor may be further configured to determine a percentage change in amplitude % A for the longitudinal wave signal, whereby:

$$\% A σ = ( A σ wheel / A σ reference ) \times 100$$

wherein % Aσ is the percentage change in the amplitude of the longitudinal wave signal;
wherein Aσwheel is the amplitude of the detected longitudinal signal when the wheel passes over the sensing region of the rail track and the wheel-rail track interface forms;
wherein Aσreference is the amplitude of the detected longitudinal signal when the sensing region of the rail track is in a known reference state.

The processor may be further configured to determine the normal interface stiffness (K_{RW})σ at the wheel-track interface, whereby:

$$( {K}_{RW} ) σ = π fc ρ \sqrt{{( \frac{1}{\vert \% A σ \vert} )}^{2} - 1}$$

wherein (K_{RW})σ is the normal interface stiffness at the wheel-track interface from the longitudinal wave signal;
wherein f is the wave frequency;
wherein c is the acoustic velocity in the rail;
wherein ρ is density in the rail;
wherein |% Aσ| is the magnitude of proportion vector % Aσ.

If the ultrasonic sensor comprises longitudinal wave transducers with different frequencies, the processor may be configured to determine the normal interface stiffness for each frequency of the detected longitudinal wave signals.

Likewise, when the sensor is mounted on the rail track, and the characteristic of the detected shear wave signal comprises amplitude, the processor may be further configured to determine percentage change in amplitude % A for the shear wave signal, whereby:

$$\% A τ = ( A τ wheel / A τ reference ) \times 100$$

wherein % Aτ is the percentage change in the amplitude of the shear wave signal;
wherein Aτwheel is the amplitude of the detected shear signal when the wheel passes over the sensing region of rail track and the wheel-rail track forms;
wherein Aτreference is the amplitude of the detected shear signal when the sensing region of the rail track is in a known reference state.

The processor may be further configured to determine the shear interface stiffness (K_{RW})τ at the wheel-track interface, whereby:

$$( {K}_{RW} ) τ = π fc ρ \sqrt{{( \frac{1}{\vert \% A τ \vert} )}^{2} - 1}$$

wherein (K_{RW})τ is the shear interface stiffness at the wheel-track interface from the shear wave signal;
wherein f is the wave frequency;
wherein c is the acoustic velocity in the rail;
wherein ρ is density in the rail;
wherein |% Aτ| is the magnitude of proportion vector % Aτ.

If the ultrasonic sensor comprises shear wave transducers with different polarisations, the processor may be configured to determine the shear interface stiffness in the different polarised directions from each of the differently polarised detected shear wave signals.

If the ultrasonic sensor comprises shear wave transducers with different frequencies, the processor may be configured to determine the shear interface stiffness for each frequency of the detected shear wave signals.

A liquid located between the interface surface of the rail track and rail vehicle wheel (for example, friction modifiers, lubricants, water etc) are identifiable from longitudinal interface stiffness.

Liquid does not have a significant shear stiffness, and so a liquid located between rail track and wheel will not be identifiable from shear interface stiffness.

Solid-solid interfacial contact has shear stiffness. As such, third body solids (for example, sand, dirt, corrosion, leaves etc) located between the rail track and wheel are identifiable from the shear interface stiffness.

Using shear wave transducers polarised in different directions provides useful shear stiffness information in relation to media at the interface that behaves anisotropically.

The processor may be configured to compare the normal interface stiffness (K_{RW})σ and the shear interface stiffness (K_{RW})τ by determining a difference in normal interface stiffness and shear interface stiffness ΔK and/or a percentage ratio between the normal interface stiffness and shear interface stiffness % K, whereby:

$$\begin{matrix}Δ K = {( {K}_{RW} )}_{σ} - {( {K}_{RW} )}_{τ} \\ \% K = ( {( {K}_{RW} )}_{τ} / {( {K}_{RW} )}_{σ} ) \times 100\end{matrix}$$

The processor may be configured to compare the normal interface stiffness (K_{RW})σ and the shear interface stiffness (K_{RW})τ to identify wheel slip, to identify any third bodies between the wheel and rail track, to identify a continuous liquid layer between the wheel and rail track, to identify a mixed mode interface, and/or to identify surface texturing and roughness at the interface sensing region.

For example, identifying wheel contact presence—comparing normal interface stiffness (K_{RW})σ with a corresponding measured (K_{RW})τ indicates presence of a solid-solid or mixed solid and liquid contact on the rail such as the presence of a wheel and the formation of the wheel-rail track interface.

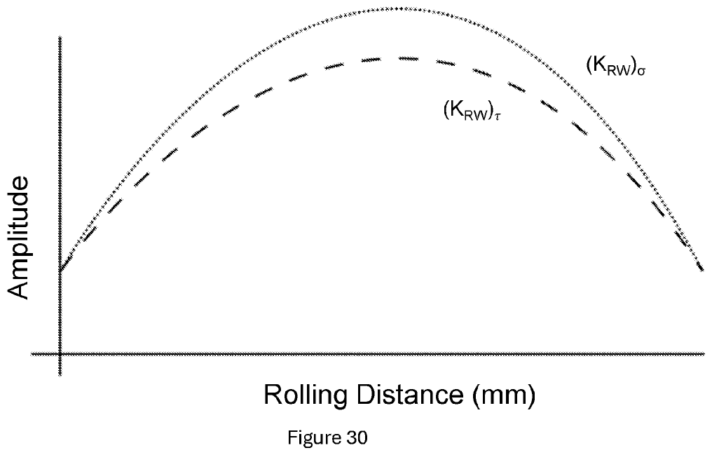

FIG. 30 shows the sensor output at the interface sensing region when the wheel-rail track interface is formed as the wheel passes over the rail track at the interface surface. The sensor system reports high values of both (K_{RW})σ and (K_{RW})τ indicating there is some level of solid-solid contact at the interface of the rail track, which indicates a wheel-rail contact is in occurrence. By utilising an array of transducers it is possible to identify the precise size and location of the contact patch of the wheel on the interface surface.

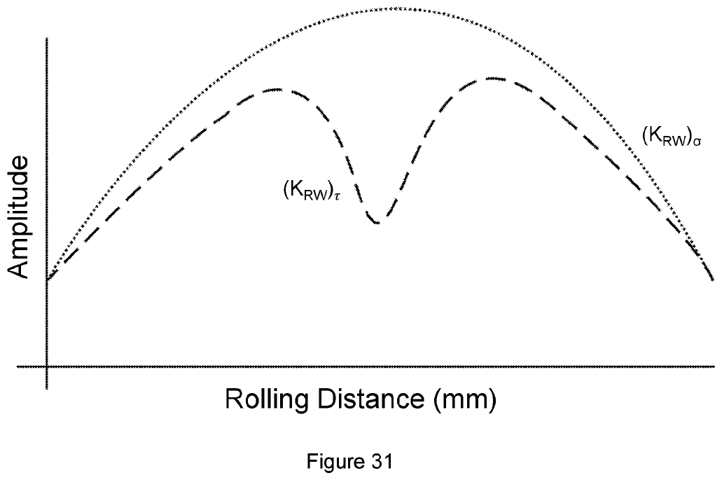

For example, identifying wheel slip—A drop in shear stiffness (K_{RW})τ₁ and (K_{RW})τ₂ without a corresponding drop in normal stiffness (K_{RW})σ indicates slipping of the wheel against the rail. FIG. 31 is a representative sensor system output showing an instantaneous drop in shear stiffness (K_{RW})τ indicating a slip event occurred as the contact patch moves through the measurement area at the wheel-rail track interface.

For example, identifying third body layers—The relative proportion of shear and normal stiffnesses, % K, and any deviation from the expected wheel-rail % K indicates the presence and properties of any third body layers, such as sand/dirt particles and corrosion layers. Specifically, a much lower % K indicates liquid or gel friction modifier, leaf or water layer as shear stiffness is reduced and liquid normal stiffness dominates over the solid stiffness.

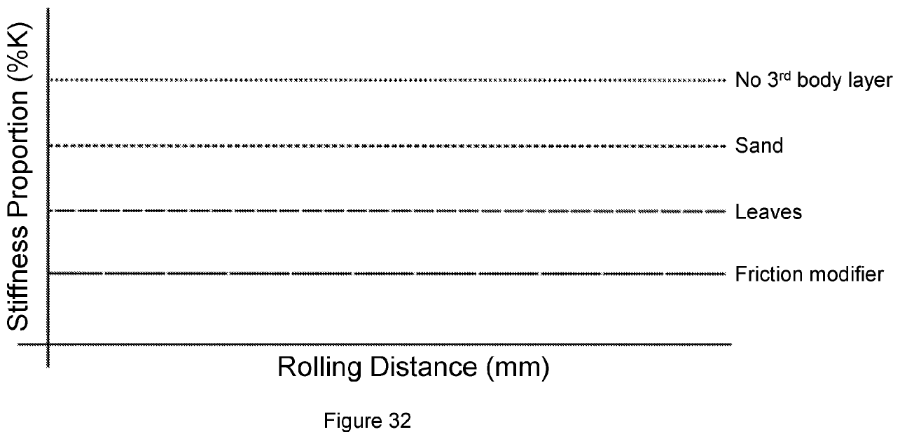

Some example sensor system measurement outputs for different third body layer conditions can be seen in the FIG. 32.

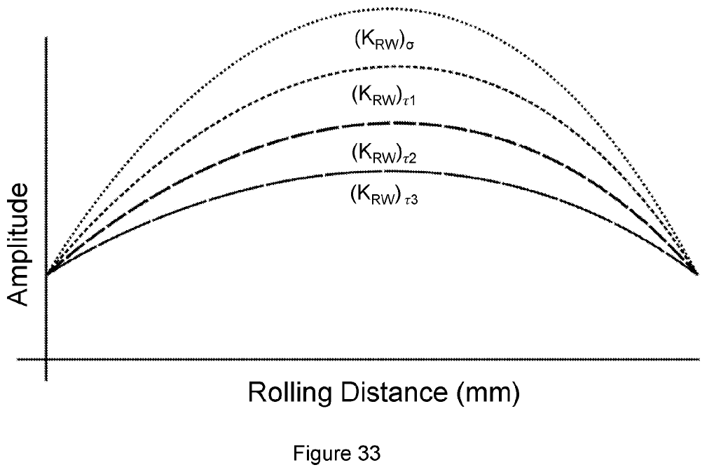

In a wheel-rail track interface example as depicted in the FIG. 33, using a multi-planar sensor with a longitudinal wave transducer and array of shear wave transducers operating with different polarisations and/or different frequency, it can be determined that the wheel-rail track interface at the interface surface has high normal stiffness and a range of shear stiffnesses. This would indicate that the third body layer displays shear dependent viscosity behaviour indicative of a leave and soil mix. As depicted in FIG. 33, there is a low shear stiffness and a range of normal stiffnesses reported from a longitudinal array transducer comprised of longitudinal wave transducers each with different attributes.

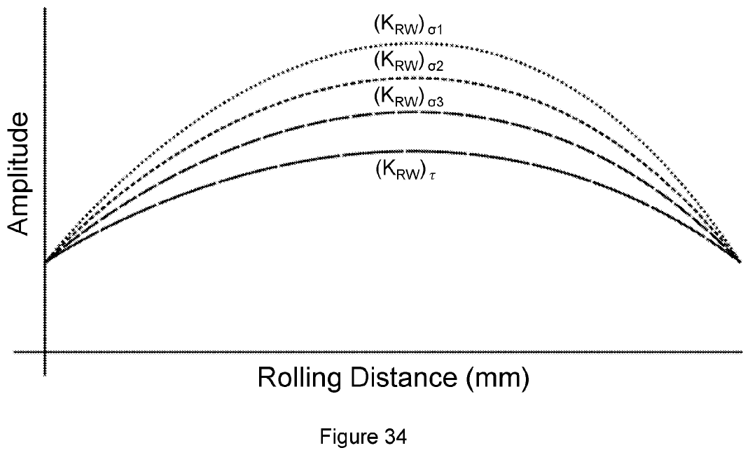

In the wheel-rail track example depicted in FIG. 34, using a multi-planar sensor with a shear wave transducer and an array of longitudinal wave transducers with three different frequencies, the wheel-rail track interface at the sensing region of the rail track has a low shear stiffness and a range of normal stiffnesses.

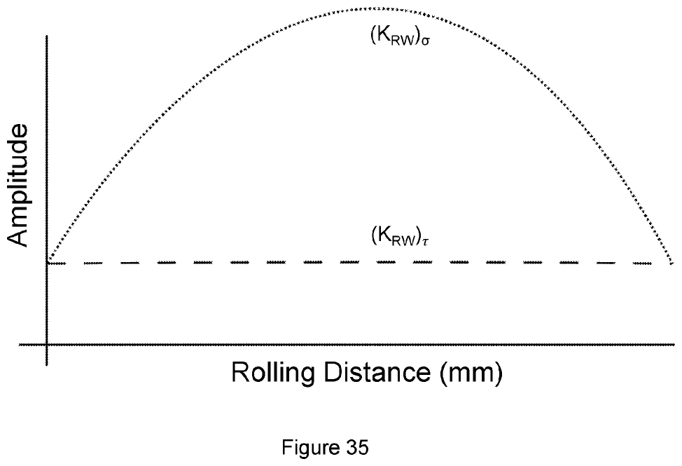

For example, identifying a continuous liquid layer presence—As shown in FIG. 35, a measured (K_{RW})σ without a corresponding measured (K_{RW})τ indicates the presence of a continuous liquid layer with no solid contact such as the presence of a continuous liquid i.e.: a gel friction modifier, wet leaf, or water layer.

For example, identifying multi-planar wheel-rail track contact stiffness—Shear and longitudinal wave measurements using the methods detailed can yield simultaneous normal stiffness (K_{RW})σ, and shear stiffness in one or more directions (K_{RW})τ. This can be used to understand a multitude of features of the interface including surface texturing and roughness, and micro-forces at the interface. For example, multi-planer micro-forces can be detected.

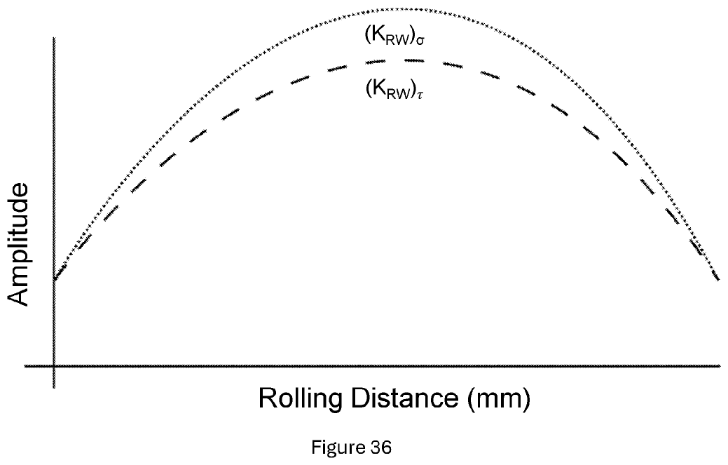

FIG. 36 relates to an example ultrasonic sensor output when a wheel-rail interface forms as a rail vehicle wheel passes over the rail track, and identifies high amplitude measurements of both (K_{RW})σ and (K_{RW})τ, which indicate high interfacial stiffness with solid-solid contact, or indicate a mixed solid-liquid contact which may be due to a worn wheel or rail profile, or misaligned loading where one wheel is bearing most of the vehicle load.

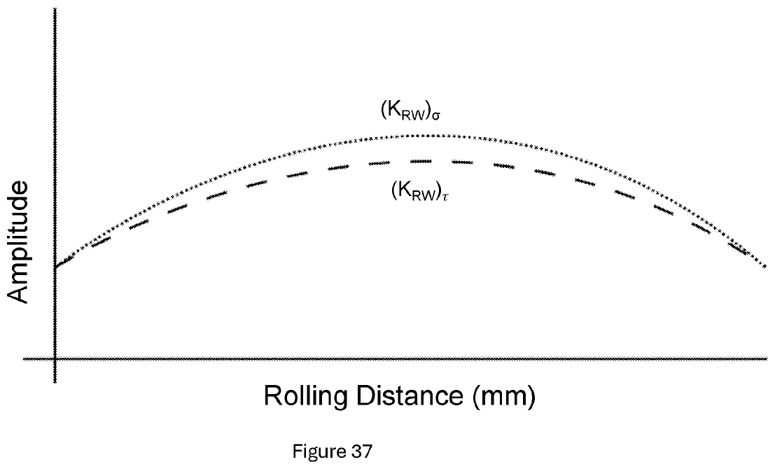

FIG. 37 depicts a wheel-rail track interface example with relatively low amplitude output for (K_{RW})σ and (K_{RW})τ, which would indicate a lightly loaded wheelset with new profiles, reporting standard wheel-rail contact distribution.

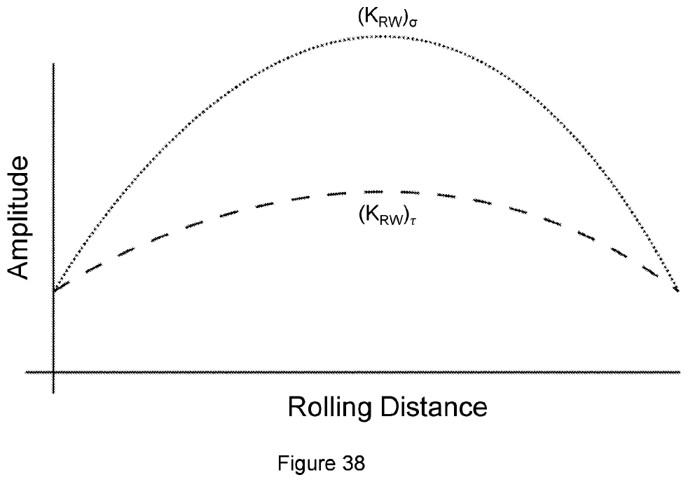

FIG. 38 depicts a wheel-rail track interface example that has high normal stiffness but low shear stiffness.

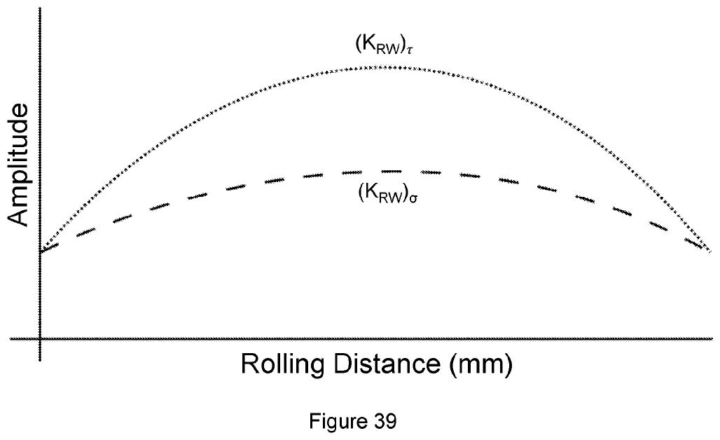

FIG. 39 depicts a wheel-rail track interface example that has high shear stiffness and low normal stiffness.

For example, measuring friction modifier layer thickness-A multiplanar sensor may detect characteristics of a mixed mode wheel-rail track interface. For example, a mixed-mode wheel-rail track interface comprising a friction modifier located between a rail track and rail wheel.

The interface stiffness of a mixed mode interface is the summation of the stiffnesses resulting from the solid and fluid components, as given below:

$${K}_{Total} = {K}_{Liquid} + {K}_{Solid}$$

Multiple ultrasonic transducers with differing polarisations can be used in parallel to measure these different stiffness characteristics of the interface. Longitudinal waves will give a measurement of the interface normal stiffness and shear polarised waves will measure the shear stiffness, both are comprised of a combination of both solid and liquid components, as given below:

$$\begin{matrix}{K}_{σ} = {( {K}_{a} )}_{σ} + {( {K}_{l} )}_{σ} \\ {K}_{τ} = {( {K}_{a} )}_{τ} + {( {K}_{l} )}_{τ}\end{matrix}$$

Where the subscripts σ and τ denote normal and shear respectively with the subscripts a and/the contributions from the solid and liquid parts of the contact. The normal and shear stiffnesses can be calculated from the longitudinal and shear wave amplitudes respectively.

As, by definition, a liquid does not support a shear load it also does not transmit a shear wave. The shear stiffness of the liquid part of the interface is only due to liquid viscosity and so (K_{I})τ can be treated as negligible. For this reason, the shear stiffness from a mixed mode interface will only result from the solid-solid contact between the wheel and the rail track, and/or solid-solid contact between a solid third body and the rail track. The shear stiffness can be translated to normal stiffness with knowledge of the surface geometry, to derive the normal stiffness of just the solid-solid contact at the interface. The stiffness only due to liquid can therefore be calculated from the difference between the solid-solid normal stiffness measurement and the total normal stiffness measurement.

A combination of the longitudinal and shear polarised sensors arranged in parallel can identify both the solid and liquid aspects of the interface. This is only achievable where both wave polarisations are used simultaneously.

### Multi-Frequency Ultrasonic Sensor

To achieve wide frequency spectrum measurements, the ultrasonic sensor may comprise a plurality of longitudinal wave transducers operating at different frequencies, and/or a plurality of shear wave transducers operating at different frequencies.

As such, the multi-frequency ultrasonic sensor may comprise a plurality of longitudinal bulk wave transducers each detecting a reflected longitudinal wave signal of a different frequency and/or a plurality of shear bulk wave transducers each detecting a reflected shear wave signal of a different frequency. Alternatively, or additionally the ultrasonic sensor may comprise a plurality of longitudinal surface wave transducers each detecting a surface longitudinal wave signal of a different frequency and/or a plurality of shear surface wave transducers each detecting a surface shear wave signal of a different frequency.

For example, the multi-frequency ultrasonic sensor may comprise at least one ultrasonic wave transducer operating at a first frequency and at least one ultrasonic wave transducer operating at a second frequency. The transducers may generate ultrasonic longitudinal bulk waves or ultrasonic shear bulk waves or ultrasonic longitudinal surface waves or ultrasonic shear surface waves.

The multi-frequency array of transducers may be piezoelectric or EMAT. The transducers may also be arranged in a capacitive or piezoelectric micromachined ultrasonic transducer (cMUT/pMUT) form factor.

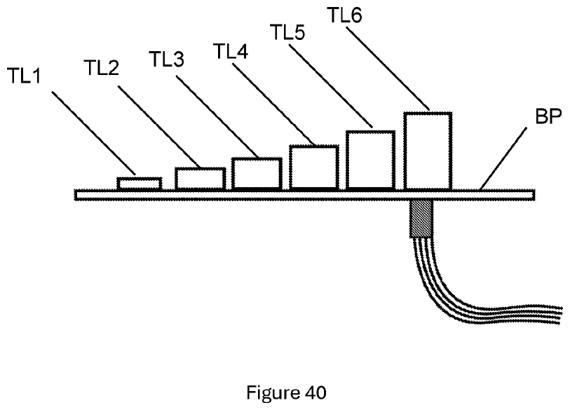

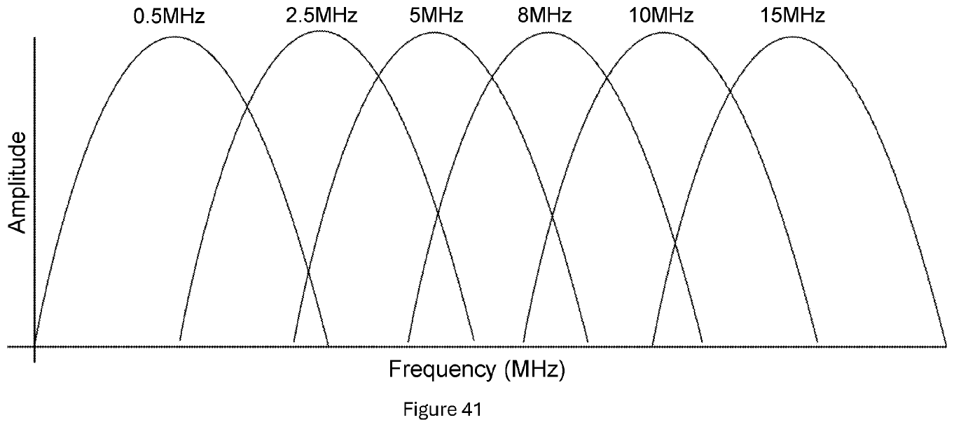

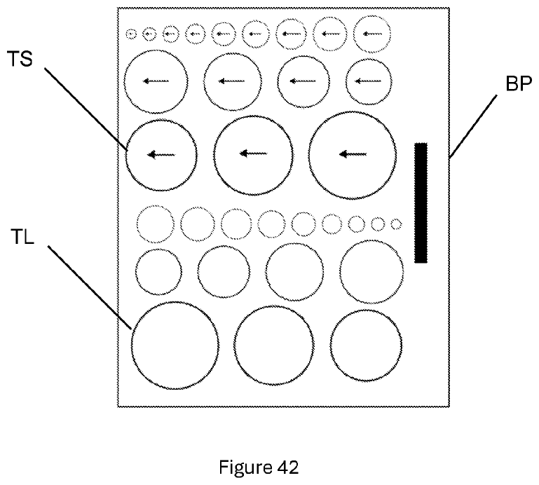

FIGS. 40 and 41 relate to an example of a multi-frequency ultrasonic sensor comprising a linear array of 6 longitudinal wave transducers (bulk or surface) (TL1-TL6) mounted on a backing plate (BP). The longitudinal wave transducers have central frequencies of 0.5 MHz, 2.5 MHz, 5 MHz, 8 MHz, 10 MHz, and 15 MHz. FIG. 41 depicts an example frequency response from the multi-frequency transducer array showing wave signal amplitude (wave energy) at multiple centre frequencies. The wave signal measurements from each transducer can be compared to achieve a wide-frequency spectrum analysis. This approach is useful when identifying third body layer characterisation, and increases the range of properties that can be measured such as layer thickness.

FIG. 42 depicts an example of an ultrasonic sensor comprising a multi-frequency array of longitudinal wave transducers (TL) and a multi-frequency array of shear wave transducers (TS) each having the same direction of polarisation. The transducers are mounted on a backing plate (BP) in two distinct groups.

Using an ultrasonic sensor with multiple frequency transducers can yield additional information about the interface of the rail track and also allow self-verification of measurements by the ultrasonic sensor.

As shown earlier the proportion of a wave reflected by the wheel-rail interface, % A, can be calculated by dividing the amplitude of the wave signal when the wheel is in contact with the interface surface of the sensing region of rail track, and by the amplitude of the wave signal when the interface surface is exposed to the atmosphere. These amplitudes of the wave signals can be extracted for a specific frequency in the frequency domain using an FFT. When using a multi-frequency ultrasonic sensor, the amplitudes of wave signals can be extracted across the full frequency spectrum for each different frequency.

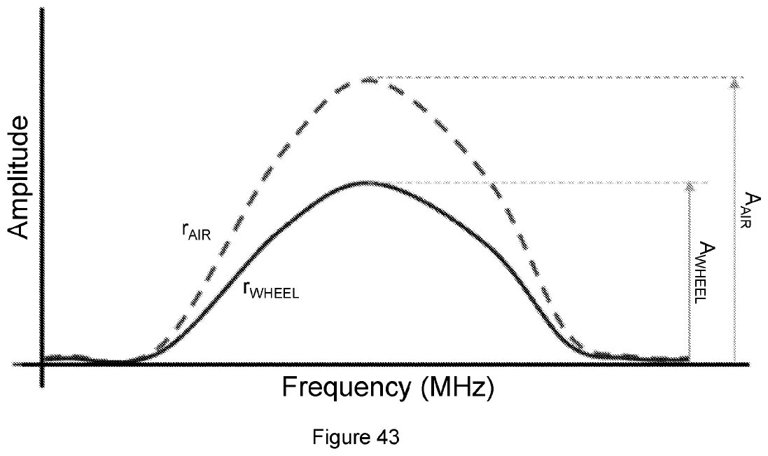

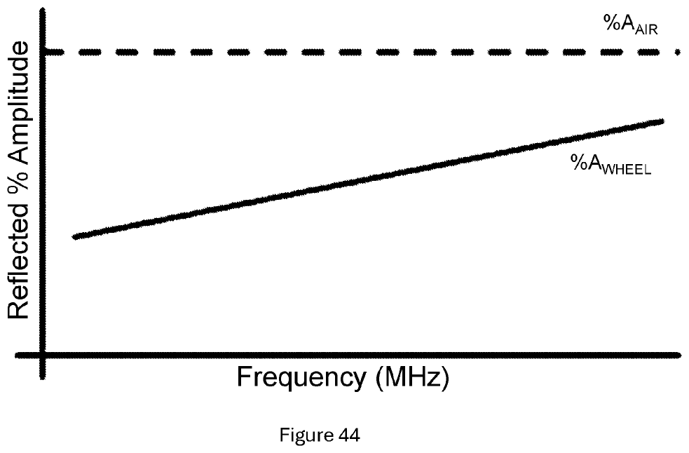

This is particularly relevant if there are third body layers present such as corrosion, leaves, friction modifiers, water, ice, or lubrication, or when quantifying the surface roughness, because wave signals reflected from the interface or propagating along the surface of the rail track via the interface surface exhibit a frequency dependent response, as shown in the FIGS. 43 and 44.

Using multiple transducers of different frequencies advantageously extends the measurement range of the ultrasonic sensor. For example, a multi-frequency ultrasonic sensor would cover a wider frequency measurement range when detecting third body layer stiffness at a wheel-rail track interface of the interface sensing region of the rail track.

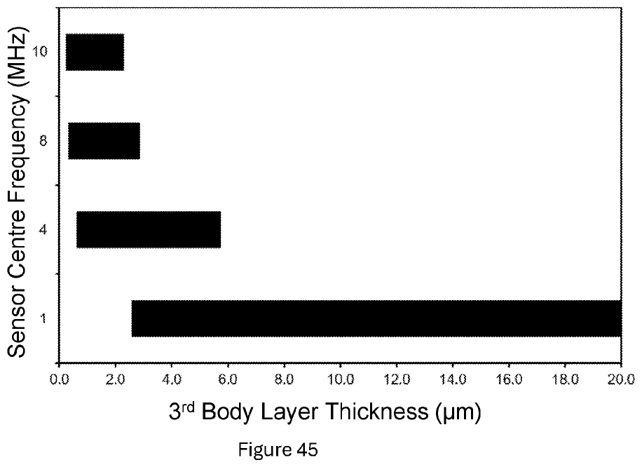

FIG. 45 below shows some overlapping measurement ranges for four ultrasonic wave transducers with central frequencies, 1 MHz, 4 MHz, 8 MHz, and 10 MHz and the range of typical third body layer thicknesses they can measure. Using a plurality of ultrasonic transducers covering these bandwidths allows the total measurement range to be expanded. Any overlap in the measurement range between the transducers allows for self-verification of the sensor operation. In this case to cover layer thicknesses that vary between 0.25 μm to 10 μm a minimum of two transducer frequencies would be required, for example a first transducer operating at a frequency of 10 MHz and a second transducer operating at a frequency of 1 MHz.

The beam spread of an ultrasonic bulk wave is dependent on its frequency, where the higher the frequency the narrower the beam spread. As such, a bulk wave transducer with a higher frequency has a narrower beam spread, which is suitable for ultrasonic sensing using a combined emit-detect (pitch-catch) sensor configuration. A transducer with a lower frequency has a broader beam spread, which is suitable for a separate emit-detect (pulse-echo) sensor configuration.

The wave dispersion of a multi-frequency ultrasonic sensor can be utilised to measure additional properties of the rail track and wheel.

For example, a multi-frequency ultrasonic sensor may comprise a higher frequency transducer operating in the pitch-catch mode and a lower frequency transducer operating in the pulse-echo mode. Comparative analysis of the time of flight signals of the higher frequency and lower frequency transducers helps to reduce errors, for example errors from interface reflection effects. As mentioned above, the multi-frequency ultrasonic sensor may comprise an array of longitudinal wave transducers each detecting a reflected longitudinal wave signal of a different frequency and any array of shear wave transducers each detecting a reflected shear wave signal of a different frequency Alternatively, the ultrasonic sensor may comprise an array of longitudinal surface wave transducers each detecting a surface longitudinal wave signal of a different frequency and an array of shear surface wave transducer each detecting a surface shear wave signal of a different frequency.

In an example, a multi-frequency ultrasonic sensor may comprise a 10 MHz high frequency longitudinal bulk wave transducer with a beam spread in steel of 2.87°, and operating in a pitch-catch mode, and may include a 1 MHz low frequency longitudinal bulk wave transducer with a beam spread of 30.1°, and operating in a pulse-echo mode. By comparing the time-of-flight from the high-frequency longitudinal wave transducer to the time-of-flight from the low frequency longitudinal wave transducer, the normal load from the vehicle load can be decoupled from the interface reflection effects and thereby reduce the error from the resultant phase shift that will result as the wheel passes over the sensing region of the rail track.

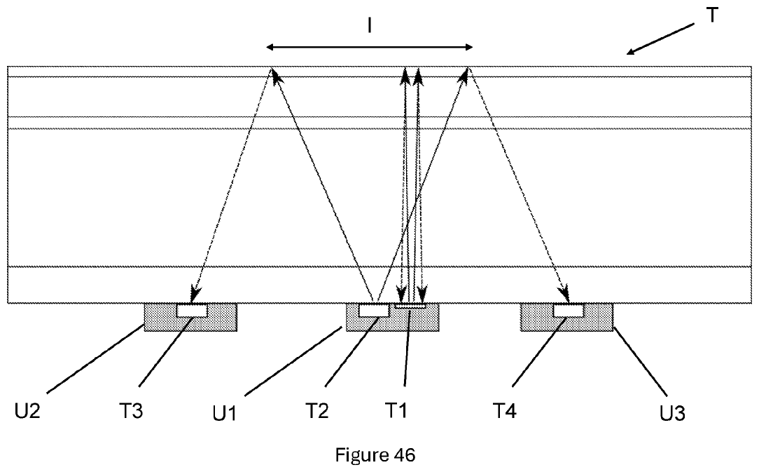

FIG. 46 depicts an example of a multi-frequency ultrasonic sensor mounted on the underside of a rail track (T). The sensor comprises a first sensor unit (U1) comprising a first transducer (T1) (longitudinal wave or shear wave) and a second transducer (T2) (longitudinal wave or shear wave), a second sensor unit (U2) comprising a third transducer (T3) corresponding to the second transducer, and a third sensor unit (U3) comprising a fourth transducer (T4) corresponding to the second transducer. The first sensor unit, the second sensor unit and the third sensor unit are arranged longitudinally along the length of the rail track. The first sensor unit is arranged between the second sensor unit and the third sensor unit. In the first sensor unit, the first transducer has a high frequency with a narrow beam spread and operates in a pitch-catch mode. In pitch-catch mode, the first transducer is configured to both emit and detect the ultrasonic wave. In other words, the first transducer is configured to emit a high frequency ultrasonic wave (longitudinal wave or shear wave), whereby the emitted high frequency ultrasonic wave propagates through the rail track to the interface surface I (at which a wheel-rail track interface forms when the rail vehicle wheel is passing over the interface surface of the sensing region of the rail track) and is reflected from the interface surface, and propagate through the sensing region to the first transducer, and the first transducer is configured to detect the reflected high frequency wave. The second transducer has a low frequency and operates in the pulse-echo mode where it is configured to emit a low frequency ultrasonic wave with the wide beam spread. As a result, the low frequency ultrasonic wave propagates at an angle through the rail track to the interface surface I (at which the wheel-track interface forms when the rail vehicle wheel is passing over and contacts the interface surface), is reflected at the angle at the interface surface and propagates through the sensing region of the rail track to the third transducer of the second sensor unit and the fourth transducer of the third sensor unit. The third transducer and fourth transducer operate in pulse-echo mode to detect the reflected low frequency ultrasonic wave.

### Using an Ultrasonic Sensor

In an example, a method for monitoring VTI between a rail vehicle and rail track may comprise:
mounting a multi-planar ultrasonic sensor on a rail track, wherein the ultrasonic sensor comprises at least one ultrasonic longitudinal bulk wave transducer and at least one ultrasonic shear bulk wave transducer;
detecting, using the at least one ultrasonic longitudinal bulk wave transducer, an ultrasonic longitudinal bulk wave signal reflected from an interface formed at an interface surface of a sensing region of the rail track;
detecting, using the at least one ultrasonic shear bulk wave transducer, an ultrasonic shear bulk wave signal reflected from the interface formed at the interface surface at a sensing region of the rail track
determining, using a processor, a characteristic of the detected longitudinal bulk wave signal and the corresponding characteristic of the detected shear bulk wave signal, wherein the characteristic comprises a time of flight and/or amplitude;
determining, using the processor, a vehicle-track interaction parameter based on the characteristic of the detected longitudinal bulk wave signal and/or the corresponding characteristic of the detected shear bulk wave signal, wherein the characteristic of the detected longitudinal bulk wave signal and corresponding characteristic of the detected shear bulk wave signal are indicative of the vehicle-track interaction parameter.

When the characteristic of the detected bulk wave signals is the time of flight, the VTI parameters of lateral load, longitudinal load, normal load, friction, wheel-rail track position contact and wear of the rail track (removal of material) may be derived.

When the characteristic of the detected bulk wave signals is the amplitude, the VTI parameters of interfacial stiffness, wheel-rail track position of contact, size and shape of contact, angle of attack/yaw of wheel acting on rail track, surface roughness, characterisation of third body layers (including ice, leaves, water, lubricant films, friction modifiers, corrosion) may be derived.

In an example, a method for monitoring VTI between a rail vehicle and rail track may comprise:
mounting an ultrasonic sensor on a rail track, wherein the ultrasonic sensor comprises a plurality of ultrasonic longitudinal bulk wave transducers each operating at the same predetermined frequency or a different predetermined frequency;
detecting, using each ultrasonic longitudinal bulk wave transducer, ultrasonic longitudinal bulk wave signals with the same predetermined frequency or different predetermined frequencies reflected from an interface formed at the interface surface region of a sensing region of the rail track;
determining, using a processor, a characteristic of the detected longitudinal bulk wave signals with the same predetermined frequency or different predetermined frequencies, wherein the characteristic is a time of flight and/or amplitude;
determining, using the processor, a vehicle-track interaction parameter based on the characteristic of the detected longitudinal bulk wave signals with the same predetermined frequency or different predetermined frequencies, wherein the characteristic of the detected longitudinal bulk wave signal is indicative of the vehicle-track interaction parameter.

When the characteristic is the time-of-flight characteristic, the wear of the rail track may be derived.

When the characteristic is the amplitude characteristic, the VTI parameters of surface roughness, contact position, size and shape of contact, characterisation of third body layers (includes ice, leaves, water, lubricant films, friction modifiers, corrosion) may be derived.

If the ultrasonic sensor comprises a plurality of longitudinal bulk wave sensors each operating at a different predetermined frequency to detect longitudinal bulk waves with the different predetermined frequencies, wherein the characteristics of the detected longitudinal bulk wave signals amplitudes are indicative of the vehicle-track interaction parameters of interfacial stiffness, characterisation of third body layers (including ice, leaves, water, lubricant films, friction modifiers, corrosion) and the characteristics of the detected longitudinal bulk wave signals time of flights are indicative of loading, wheel-rail track position of contact, size and shape of contact, angle of attack/yaw of wheel acting on the rail track.

In an example, a method for monitoring VTI between a rail vehicle and rail track may comprise:
mounting an ultrasonic sensor on a rail track, wherein the ultrasonic sensor comprises a plurality of ultrasonic shear bulk wave transducers each operating at the same predetermined frequency or a different predetermined frequency;
detecting, using each ultrasonic shear bulk wave transducer, ultrasonic shear bulk wave signals with the same predetermined frequency or different predetermined frequencies reflected from an interface formed at an interface surface at a sensing region of the rail track;
determining, using a processor, a characteristic of the detected shear bulk wave signals with the same predetermined frequency or different predetermined frequencies, wherein the characteristic is a time of flight and/or amplitude;
determining, using the processor, a vehicle-track interaction parameter based on the characteristic of the detected shear bulk wave signals of same predetermined frequency or the different predetermined frequencies, wherein the characteristic of the detected shear bulk wave signal is indicative of the vehicle-track interaction parameter.

When the characteristic is the time of flight, the vehicle-track interaction parameter of rail track wear may be derived.

When the characteristic is the amplitude, the vehicle-track interaction parameters of surface roughness, wheel-rail track position of contact, size and shape of contact, characterisation of third body layers (including ice, leaves, water, lubricant films, friction modifiers, corrosion) may be derived.

If the ultrasonic sensor comprises a plurality of shear bulk wave sensors each operating at a different predetermined frequency to detect shear bulk waves with the different predetermined frequencies, wherein the characteristics of the detected shear bulk wave signals amplitudes are indicative of the vehicle-track interaction parameters of interfacial stiffness, characterisation of third body layers (including ice, leaves, water, lubricant films, friction modifiers, corrosion) and the characteristics of the detected shear bulk wave signals time of flights are indicative of loading, wheel-rail track position of contact, size and shape of contact, angle of attack/yaw of wheel acting on rail track.

In an example, a method for monitoring VTI between a rail vehicle and rail track may comprise:
mounting an ultrasonic sensor on a rail track, wherein the ultrasonic sensor comprises a plurality of ultrasonic shear bulk wave transducers each operating at the same predetermined direction of polarisation or different predetermined directions of polarisation;
detecting, using each ultrasonic shear bulk wave transducers, ultrasonic shear bulk wave signals with the same predetermined direction of polarisation or different predetermined directions of polarisation reflected from an interface formed at an interface surface of a sensing region of the rail track;
determining, using a processor, a characteristic of the detected shear bulk wave signals with the same predetermined direction of polarisation or different predetermined directions of polarisation, wherein the characteristic is a time of flight and/or amplitude;
determining, using the processor, a vehicle-track interaction parameter based on the characteristic of the detected shear bulk wave signals with the same predetermined direction of polarisation or the different predetermined directions of polarisation, wherein the characteristic of the detected shear longitudinal bulk wave signal is indicative of the vehicle-track interaction parameter.

If the ultrasonic sensor comprises a plurality of shear bulk wave sensors each operating with a different polarisation, the VTI parameters of multi-polarised load, friction, wheel-rail track position contact, wear of rail track (removal of material) may be derived from the time-of-flight characteristic. Likewise, the VTI parameters of multi-polarised interfacial stiffness, wheel-rail track position of contact, size and shape of contact, angle of attack/yaw of wheel acting on rail track, surface roughness, characterisation of third body layers (including ice, leaves, water, lubricant films, friction modifiers, corrosion) may be derived from the amplitude characteristic.

The interface may comprise a wheel-rail track interface when the rail vehicle passes and contacts the interface surface of the sensing region of the rail track.

The interface may comprise a reference interface when the interface surface is in a known state. For example, the interface may comprise an air-rail track interface when the interface surface is exposed to the environmental atmosphere and no contact with the rail vehicle wheel.

The interface may comprise a variable interface when the interface surface is subject to a changing state as a rail vehicle travels along the rail track with respect to the sensing region of the rail track.

In an example, a method for ultrasonically sensing rail-vehicle track interaction may comprise:
mounting a multi-planar ultrasonic sensor on a rail track, wherein the ultrasonic sensor comprises at least one ultrasonic longitudinal surface wave transducer and at least one ultrasonic shear surface wave transducer;
detecting, using the at least one ultrasonic longitudinal surface wave transducer, an ultrasonic longitudinal surface wave signal propagating along a rail track surface at a sensing region of the rail track;
detecting, using the at least one ultrasonic shear surface wave transducer, an ultrasonic shear wave signal propagating along the rail track surface at the sensing region of the rail track;
determining, using a processor, a characteristic of the detected longitudinal surface wave signal and the corresponding characteristic of the detected shear surface wave signal, wherein the characteristic comprises a time of flight and/or amplitude;
determining, using the processor, a vehicle-track interaction parameter based on the characteristic of the detected longitudinal surface wave signal and/or the corresponding characteristic of the detected shear surface wave signal, wherein the characteristic of the detected longitudinal surface wave signal and corresponding characteristic of the detected shear surface wave signal are indicative of the vehicle-track interaction parameter.

When detecting both longitudinal and shear surface wave signals, the VTI parameters of lateral strain, longitudinal strain, normal strain, friction, and wheel-rail track contact position can be derived from the time-of-flight characteristic. Likewise, the vehicle-track interaction parameters of interfacial stiffness, wheel-rail track position of contact, size and shape of contact, angle of attack/yaw of wheel acting on rail track, characterisation of third body layers (includes ice, leaves, water, lubricant films, friction modifiers, corrosion) can be determined from the amplitude characteristic.

In an example, a method for ultrasonically sensing rail-vehicle track interaction may comprise:
mounting an ultrasonic sensor on a rail track, wherein the ultrasonic sensor comprises at a plurality of ultrasonic longitudinal surface wave transducers each operating at the same predetermined frequency or at a different predetermined frequency;
detecting, using each ultrasonic longitudinal surface wave transducer, ultrasonic longitudinal surface wave signals with the same predetermined frequency or different predetermined frequencies propagating along a rail track surface at a sensing region of the rail track;
determining, using a processor, a characteristic of the detected longitudinal surface wave signals with the same predetermined frequency or different predetermined frequencies, wherein the characteristic comprises a time of flight and/or amplitude;
determining, using the processor, a vehicle-track interaction parameter based on the characteristic of the detected longitudinal surface wave signals with the same predetermined frequency or different predetermined frequencies, wherein the characteristic of the detected longitudinal surface wave signal is indicative of the vehicle-track interaction parameter.

When detecting only longitudinal surface wave signals, the vehicle-track interaction parameters of lateral load (as longitudinal surface wave signal propagates in a direction parallel to the longitudinal axis of the rail track) and wheel-rail track position contact can be derived from the time-of-flight characteristic. The vehicle-track interaction parameters of interfacial stiffness, wheel-rail track position of contact, size and shape of contact, angle of attack/yaw of wheel acting on rail track, characterisation of third body layers (including ice, leaves, water, lubricant films, friction modifiers, corrosion) can be determined from the amplitude characteristic.

If the ultrasonic sensor comprises a plurality of longitudinal surface wave sensors each operating at a different predetermined frequency to detect longitudinal surface waves with the different predetermined frequencies, wherein the characteristics of the detected longitudinal surface wave signals amplitudes are indicative of the vehicle-track interaction parameters of interfacial stiffness, characterisation of third body layers (including ice, leaves, water, lubricant films, friction modifiers, corrosion) and the characteristics of the detected longitudinal surface wave signals time of flights are indicative of loading, wheel-rail track position of contact, size and shape of contact, angle of attack/yaw of wheel acting on the track.

In an example, a method for ultrasonically sensing rail-vehicle track interaction may comprise:
mounting an ultrasonic sensor on a rail track, wherein the ultrasonic sensor comprises at a plurality of ultrasonic shear surface wave transducers operating at the same predetermined frequency or each having a different predetermined frequency;
detecting, using each ultrasonic shear surface wave transducer, ultrasonic shear surface wave signals with the same predetermined frequency or different predetermined frequencies propagating along a rail track surface at a sensing region of the rail track;
determining, using a processor, a characteristic of the detected shear surface wave signals with the same predetermined frequency or different predetermined frequencies, wherein the characteristic comprises a time of flight and/or amplitude;
determining, using the processor, a vehicle-track interaction parameter based on the characteristic of the detected shear surface wave signals with the same predetermined frequency or different predetermined frequencies, wherein the characteristic of the detected shear surface wave signal is indicative of the vehicle-track interaction parameter.

When detecting only shear surface wave signals, the time-of-flight characteristic is indicative of the vehicle-track interaction parameters of polarised strain and wheel-rail track contact position. The amplitude characteristic is indicative of the vehicle-track interaction parameters of interfacial stiffness, wheel-rail track position of contact, size and shape of contact, angle of attack/yaw of wheel acting on rail track, characterisation of third body layers (including ice, leaves, water, lubricant films, friction modifiers, corrosion).

If the ultrasonic sensor comprises a plurality of shear surface wave sensors each operating at a different predetermined frequency to detect shear surface waves with the different predetermined frequencies, wherein the characteristics of the detected shear surface wave signals amplitudes are indicative of the vehicle-track interaction parameters of interfacial stiffness, characterisation of third body layers (including ice, leaves, water, lubricant films, friction modifiers, corrosion) and the characteristics of the detected shear surface wave signals time of flights are indicative of loading, wheel-rail track position of contact, size and shape of contact, angle of attack/yaw of wheel acting on track.

In an example, a method for ultrasonically sensing rail-vehicle track interaction may comprise:
mounting an ultrasonic sensor on a rail track, wherein the ultrasonic sensor comprises at a plurality of ultrasonic shear surface wave transducers operating at the same predetermined direction of polarisation or different predetermined directions of polarisation;
detecting, using each ultrasonic shear surface wave transducer, ultrasonic shear surface wave signals with the same predetermined direction of polarisation or different directions of polarisation propagating along a rail track surface at the sensing region of the rail track;
determining, using a processor, a characteristic of the detected shear surface wave signals with the same predetermined direction of polarisation or different predetermined directions of polarisation, wherein the characteristic comprises a time of flight and/or amplitude;
determining, using the processor, a vehicle-track interaction parameter based on the characteristic of the detected shear surface wave signals with the same predetermined direction of polarisation or different predetermined directions or polarisation, wherein the characteristic of the detected shear surface wave signal is indicative of the vehicle-track interaction parameter.

If the ultrasonic sensor comprises a plurality of shear surface wave sensors each operating with a different polarisation, wherein the characteristics of the detected shear surface wave signals amplitudes are indicative of the vehicle-track interaction parameters of interfacial stiffness in the direction of polarisation, friction in the direction of polarisation, characterisation of third body layers (including ice, leaves, water, lubricant films, friction modifiers, corrosion) and the detected shear surface wave signals time-of flights are indicative of loading in the direction of polarisation.

An example of the method of operating the apparatus with the ultrasonic sensor as shown in FIG. 4a. comprises the mounting the ultrasonic sensor using a clamp as shown in FIGS. 19 and 20 to install the ultrasonic sensor under the foot of the rail track foot. In this example, the ultrasonic sensor comprises two longitudinal bulk wave transducers operating at the same predetermined frequency and one longitudinal shear bulk wave transducers configured to operate in pulse-echo mode. However, the ultrasonic sensor may comprise any type and combination of transducers. For example, the ultrasonic transducer may comprise at least longitudinal bulk wave transducer, at least one shear bulk wave transducer, at least one longitudinal surface wave transducer, at least one shear surface wave transducer, a plurality of transducers with different frequencies and/or a plurality of shear transducers with different directions of polarisation.

The transducers of the ultrasonic sensor are activated using a controller, such as an ultrasonic DAQ. The controller sends control signals to activate the transducers of the ultrasonic sensor.

In response to receiving the activation control signals, three ultrasonic bulk wave signals are emitted by the transducers, and the emitted ultrasonic wave signals propagate in a forward path through the sensing region of the rail track at a high frequency to the interface surface, whereby at least a portion of each ultrasonic wave signal is reflected from the interface formed at the interface sensing region. The reflected ultrasonic wave signals propagate a return path through the sensing region of the rail track and are detected by the respective ultrasonic transducers.

The controller may activate the transducers of the ultrasonic sensor when a known, reference interface (with a known contact and known load) forms at the interface surface such that the ultrasonic transducers detect reflected reference ultrasonic wave signals.

The controller may activate the transducers of the ultrasonic sensor when the rail vehicle wheel passes and contacts the interface surface and a wheel-rail track interface forms at the interface surface such that the ultrasonic transducers detect reflected VTI ultrasonic wave signals.

The controller may activate the transducers of the ultrasonic sensor for a predetermined time period as the rail vehicle travels along the rail track with respect to the sensing region of the rail track and the interface formed at the interface surface varies, such that ultrasonic transducers detect reflected variable ultrasonic wave signals over the predetermined period of time.

Using a processor, the detected ultrasonic wave signals are digitized and processed in real time. As part of the data processing process, data may be transmitted via a network or to the Cloud. The detected ultrasonic wave signals are processed to determine a characteristic of each reflected VTI ultrasonic wave signals (amplitude and/or time of flight), and to subsequently determine VTI interaction parameters based on a characteristic of each ultrasonic bulk wave signal.

Processing may comprise a comparative analysis of the reflected VTI ultrasonic wave signals with the reflected reference ultrasonic wave signals detected when the known, reference interface formed at the interface surface of the sensing region of the rail track to determine a change in the characteristics of each reflected ultrasonic wave signals and determine VTI interaction parameters based on the change in the characteristic of each ultrasonic wave signal.

Processing may comprise determining a characteristic pattern of each reflected variable ultrasonic wave signal, and determining VTI interaction parameter pattern based on the characteristic pattern of each ultrasonic wave signal to monitor how the VTI varies at the sensing region of the rail track.

An alarm may be triggered if the determined VTI parameters are above or below predetermined thresholds or outside ranges. For example, an alarm may automatically be generated to identify problem track segments, damaged wheelsets, or wheel faults.

The ultrasonic sensor mounted under the under rail track allows, for example, the ultrasonic sensor to determine the normal vehicle load acting on the rail track at the sensing region of the rail track, determine a lateral vehicle load acting the rail track at the sensing region of the rail track, determine the lateral/normal load ratio, determine normal interface stiffness at the sensing region of the rail track, determine further VTI parameters derivable from the normal load, lateral load and/or load ratio, determine, change in amplitude, determine normal interface stiffness at the sensing region of the rail track, determine shear interface stiffness at the sensing region of the rail track, determine third bodies between the rail track and rail vehicle wheel including solids and liquids, determine further VTI parameters derivable from the normal interface stiffness and/or the shear interface stiffness.

A multiplanar sensor incorporating the multiple ultrasonic longitudinal bulk wave transducers and also a shear wave transducer polarised in the direction of the lateral axis of the rail track (y-axis). When flange contact occurs between the rail track and rail vehicle wheel, a lateral load will act on the rail track. Therefore, this example of the ultrasonic sensor, allows the ultrasonic sensor to determine lateral loading (parallel to the y-axis of the rail track) from uneven vehicle load and cornering/flange contact/track alignment issues. The longitudinal bulk wave transducers are arranged in an array across the interface surface to detect contact position.

Combining the output from ultrasonic longitudinal bulk wave transducers and the shear wave transducers at the same location in the same housing and measuring simultaneously allows the direct comparison to yield the lateral load over vertical load ratio (L/V), a key measurement in assessing vehicle track interaction.

Additionally, a shear wave transducer polarised along the length of the rail detects changes in longitudinal rail strain from poor pre-loading and temperature effects (expansion and contraction) in continuously welded rail.

### Additional Complementary Sensors

In addition to having an ultrasonic sensor as previously described, the apparatus may comprise at least one complementary sensor to detect a complementary sensor signal indicative of one or more VTI parameter of the rail track and rail vehicle wheel.

For example, the apparatus may include one or more temperature sensor, acoustic emission sensor, accelerometer, optical sensor, and/or audible range acoustic sensor, and/or any other suitable complementary (non-ultrasonic) sensor for detecting a VTI parameter. See the example multi-sensor sensing probe depicted in FIG. 15.

A temperature sensor may detect temperature signals to detect a temperature of the rail vehicle wheel, monitor for neutral rail temperature (NRT), and/or detect hot axle/hot box, detect for stuck wheels.

An acoustic emission sensor may detect high frequency acoustic signals to allow for high frequency acoustic analysis for rolling contact fatigue (RCF), surface roughness, friction and/or lubricant characterisation.

An accelerometer sensor (for example a 3-axis accelerometer) may measure vibration which is indicative of track displacement, wheel flats, and/or out of round wheels.

An optical sensor may visibly detect the appearance of the rail track and/or rail wheel, rail track environment.

An audible range acoustic sensor may monitor for noise and/or squeal indicating corrugation, poor lubrication, and/or severely worn wheels.

With one or more complementary sensors in combination with a multiplanar ultrasonic sensor, the apparatus and method may determine a variety of different VTI parameters. For example;
Rail vehicle noise and vibration associated with wheelset/rail vehicle faults may be detected using one or more audible range acoustic sensor detecting sound signals in combination with an ultrasonic sensor detecting wheelset and rail vehicle faults.
Rail track displacement may be detected using an ultrasonic sensor to determine dynamic loading of the rail track and one or more accelerometers to determine vibration during loading.
Dynamic temperature/hot-box-hot axle detection may be derived using one or more thermal sensors to identify hot wheelset components and an ultrasonic sensor may detect wheel slip or stuck wheel which are temperature sensitive features.
Wheel/rail surface features may be detected using an ultrasonic sensor in combination with an acoustic emission sensor to identify excessive roughness or rolling contact fatigue and associated noise indicative of the excessive roughness or rolling contact fatigue.

### Complementary Sensor Analysis

As mentioned above, the apparatus may comprise an ultrasonic sensor to detect at least one ultrasonic signal associated with one or more VTI parameter of the rail vehicle wheel and rail track, and one or more complementary sensor to detect a complementary sensor signal associated with the one or more VTI parameters of the rail vehicle wheel and rail track.

The ultrasonic sensor may comprise any of the features of the ultrasonic sensor as previously described.

Following the processing of the ultrasonic signal to determine a characteristic of the ultrasonic signal (amplitude or time of flight) and to determine at least one VTI parameter based on the characteristic of the ultrasonic signal, apparatus may comprise a processor configured to conduct an complementary analysis of the ultrasonic signal and complementary sensor signal to train a complementary sensor model for the VTI parameter.

For example, a processor may be configured:
to receive an ultrasonic signal of the ultrasonic sensor, wherein the at least one ultrasonic signal comprises a known signal feature indicative of a known VTI parameter;
to receive a complementary sensor signal of a complementary sensor, wherein the complementary sensor signal is detected concurrently with the ultrasonic signal of the ultrasonic sensor;
to correlate the known signal feature of the ultrasonic signal indicative of the known VTI parameter with signal features of the complementary sensor signal to identify a complementary signal feature of the complementary sensor signal indicative of the known VTI parameter; and
to create a complimentary sensor model for the known VTI parameter based on the identified complementary signal feature of the complementary sensor signal indicative of the known VTI parameter.

A method of training the complementary sensor model for the VTI parameter may comprise:
receiving, at a processor, an ultrasonic signal of an ultrasonic sensor, wherein the ultrasonic signal comprises a known signal feature indicative of a known VTI parameter;
receiving, at the processor, a complementary sensory signal of a complementary sensor detected concurrently with the ultrasonic signal of the ultrasonic sensor;
correlating, using the processor, the known signal feature of the ultrasonic signal and signal features of the complementary sensor signal to identify a complementary signal feature of the complementary sensor signal indicative of the known VTI parameter;
creating, using the processor, a complementary sensor model for the known VTI parameter based on the identified complementary signal feature of the complementary sensor signal indicative of the known VTI parameter.

The processor may correlate the ultrasonic signal and complementary sensor signal using a peak matching technique, a regression analysis, a neural network or any other suitable technique.

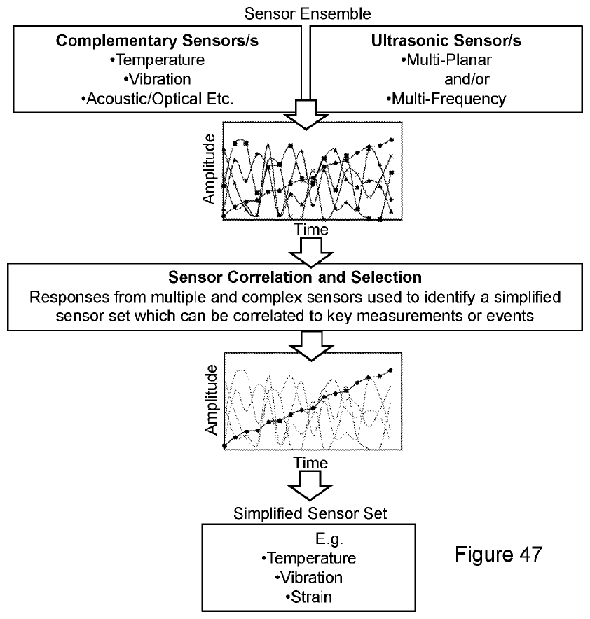

FIG. 47 depicts an example of creating a complementary sensor model, whereby having received concurrent signals data from the one or more ultrasonic sensor (for example, ultrasonic longitudinal bulk wave signals, ultrasonic shear bulk wave signals, ultrasonic longitudinal surface wave signals, ultrasonic shear surface wave signals, ultrasonic multi-frequency wave signals, and/or ultrasonic multi-polarised wave signals) and signal data from one or more complementary sensors (for example temperature signals, displacement signals, pressure and load signals), the processor may correlate one or more ultrasonic wave signal with a known VTI parameter with one or more complementary signal to identify the complementary signal feature of complementary signal that is indicative of the known VTI parameter, and create a complementary model based on the identified complementary signal data.

Following the creation of the complementary sensor model, apparatus may comprise a processor configured to use the complementary sensor model to monitor further complementary sensor signals for the known VTI parameter.

As such, following the creating of the complementary sensor model, apparatus may only use the complementary sensor model and complementary sensor signals of one or more complementary sensor to identify VTI parameters.

In an example, a processor may be configured:
to receive a complementary sensor signal of a complementary sensor;
using a complementary sensor model for a VTI parameter, to identify a complimentary signal feature of the complementary sensor signal indicative of the VTI parameter.

Optionally, the processor may be further configured to determine, based on the complimentary signal feature and using the complementary sensor model, a metric of the VTI parameter.

The processor may be configured to activate an alarm if the VTI parameter is present and/or the metric of the VTI parameter is outside a threshold range, above a threshold and/or below a threshold.

In an example, an apparatus for monitoring VTI may comprise:
a complimentary sensor configured to detect a complementary sensor signal;
a processor comprising a complementary sensor model for a VTI parameter and configured to:
   to receive a complementary sensor signal of the complementary sensor;
   use the complementary sensor model to identify a complimentary signal feature of the complementary sensor signal indicative of the VTI parameter.

Optionally, the processor may be further configured to determine, based on the complimentary signal feature and using the complementary sensor model, a metric of the VTI parameter.

The apparatus may comprise an alarm configure to activate if the VTI parameter is present and/or the metric of the VTI parameter is outside a threshold range, above a threshold and/or below a threshold.

In an example, a method for monitoring VTI may comprise:
detecting, using a complimentary sensor, a complimentary sensor signal;
identifying, using a processor with a complimentary sensor model for a VTI parameter, a complementary signal feature of the complementary sensor signal indicative of the VTI parameter.

The method may further comprise determining, using the processor with the complementary sensor model, a metric of the VTI parameter based on the identified complementary signal feature.

The method may comprise triggering an alarm if the VTI parameter is present and/or the metric of the VTI parameter is outside a threshold range, above a threshold and/or below a threshold.

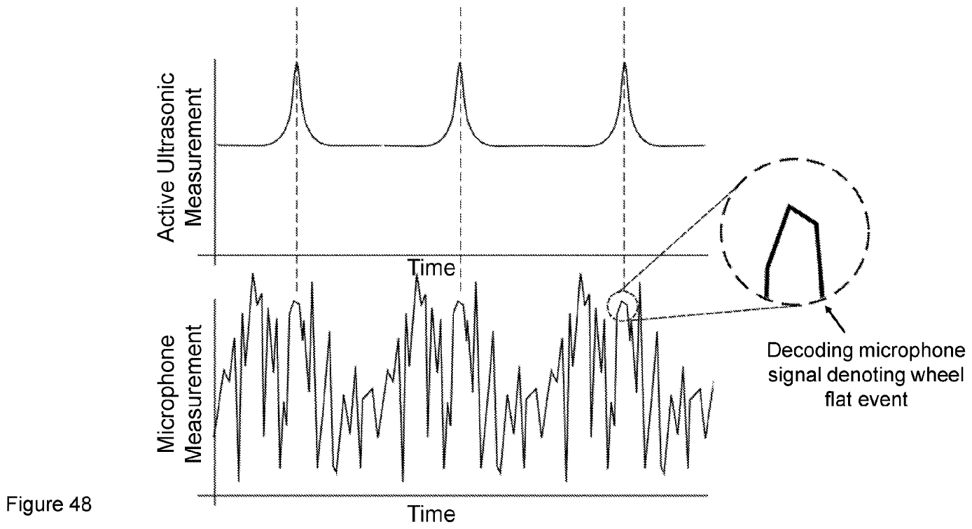

In an example depicted in FIG. 48, a processor correlates an ultrasonic wave signal with a known signal characteristic indicative of known wheel flats parameter with a corresponding microphone signal of a microphone sensor (detected concurrently with the ultrasonic wave signal) to identify the corresponding signatures microphone signal that correlate to the same wheel flat parameter. As shown in FIG. 48, in addition to containing signal features relating to the wheel flat parameter, the microphone signal of the microphone sensor contains other signal features relating to noise from rolling element bearings, ballast migration, sleeper displacement, track deflection, pantograph sliding contact, combustion etc. Due to the complexity of the microphone signal, it is difficult to decode the microphone signal in isolation and the signal component denoting wheel flats will be difficult/impossible to extract with any confidence using just the microphone output. To counter these problems, a high-fidelity ultrasonic signal is correlated with the microphone signal to develop a microphone sensor model relating to the wheel flat parameter. FIG. 48 shows the correlation of the two sensor signal features indicative of the wheel flat parameter by the processor.

The microphone sensor model relating to the wheel flat parameter allows for direct identification of wheel-flat event problems from subsequent complex microphone output signal. As a result, apparatus may only require microphone sensors to detect Dwheel flat problems with confidence. For example, apparatus may comprise a plurality of microphone sensor mounted at predetermined locations along a rail track and a processor comprising the microphone sensor model for the wheel flat parameter and configured to identify a wheel flat parameter at each predetermined location along the rail track from each detected microphone signal.

In another example, a processor may correlate ultrasonic wave signals of an ultrasonic sensor indicative of a known lateral force parameter acting on the rail track with a concurrent corresponding accelerometer signal of a 3-axis accelerometer to identify the accelerometer signal features that correspond to the same lateral force parameter. The ultrasonic sensor and accelerometer detect the respective ultrasonic wave signals and accelerometer signals at the sensing region of the rail track as the rail vehicle wheel passes and contacts the interface surface of the sensing region of the rail track. The accelerometer outputs time-domain signals which are highly complex and are influenced by not only the lateral force on the rail, but also the sleeper material, the ballast density around the sensor location, the profile of the wheel etc. Hence, it is difficult to extract the lateral force data in isolation from the accelerometer signals. By correlating the direct ultrasonic wave signal indicative of the lateral force parameter with the indirect accelerometer signal, the accelerometer signal feature relating to the lateral force parameter can be decoded and extracted to create an accelerometer model for lateral loads. The accelerometer model relating to lateral loads can then be deployed to identify the lateral load parameter from other accelerometer signals. Hence, to monitor lateral load, apparatus may utilise the accelerometer model for lateral loads and low cost simple accelerometer sensors. For example, apparatus may comprise a plurality of accelerometer sensors mounted at a different predetermined location along a rail track to detect an accelerometer sensor signal, and a processor comprising the accelerometer model for the lateral load parameter and configured to determine a lateral load parameter at each predetermined location along the rail track from the detected accelerometer signal as the rail vehicle travels along the track.

Correlating ultrasonic wave signals with complementary sensor signals and creating complementary models for certain VTI parameters reduces the system complexity, reduces the risk of measurement error, reduces system cost, simplifies the installation of a monitoring system, of complementary sensor.

### Benefits of Apparatus and Method Sensing Vehicle-Track Interaction (VTI)

The apparatus and method with the ultrasonic sensor allows for accurate ultrasonic sensing of vehicle-track interaction (VTI) between a rail vehicle wheel and rail track, and can sense the vehicle-track interaction in real-time and at full vehicle speeds.

The apparatus and method allows for the quick attachment of the ultrasonic sensor to be quickly and easily mounted on the rail track, on dedicated inspection vehicles, on rail freight vehicles, rail passenger vehicles, towed trucks or coaches.

The apparatus and method with the ultrasonic multi-planar sensor allows for a wide range of critical VTI parameter measurements, some of which are otherwise unobtainable using existing sensor technologies. These VTI parameter measurements include wheel-rail contact area, shape and location of contact, flange contact, wheel climb, problems with gauge, cyclic top, wheel unloading point, understanding pummeling (distribution of contact, wear/damage), yaw/angle of attack, wheel-rail contact stiffness and pressure (inferring surface roughness and traction), rail surface characteristics such as RCF and third body layers, wheel-rail wear, and rail head defects.

The apparatus and method provides high-speed, direct, and non-invasive measurements of these key VTI interfacial conditions. By monitoring these factors, service operators can make substantial cost savings while ensuring more efficient operations. This will be achieved through increasing operational reliability, decreasing unnecessary downtime by optimising strategic predictive maintenance, optimizing and maintaining rail friction modification, risk identification, and increasing overall safety.

The apparatus and method is able to identify trouble areas of rail track sections. For example the apparatus and method is able to identify rail track sections suffering as extreme wear, broken ties, or ballast disruption, that could result in accelerated wheel damage or could lead to catastrophic failure. This optimises operational efficiencies, maximising rail service speeds and prevents disruption.

Maintaining key VTI parameters within established safe norms requires data to be collected across the rail network. The apparatus and method allows for the mounting the ultrasonic multiplanar sensor on a vehicle wheel, which in turn allows for the gathering of real-time VTI parameter measurements over long distances, along extensive lengths of rail tracks.

Having up-to-date quantitative geotagged VTI data across the rail network supports next generation intelligent engineering business systems, and provides critical real-time information to rail service operators. The VTI data allows for efficient operations with advanced maintenance scheduling, maximum rail vehicle operating speeds and highest revenue vehicle throughput.

The VTI data across the rail network allows rail service operators to prioritise “outlier” track locations to focus maintenance efforts (rail grinding, friction management, setting of super-elevation, rail head cleaning programs etc.), resulting in informed strategic maintenance programs, increased operational efficiencies, improved safety and reliability and reduced downtime of both the rail network and the rolling stock.

The apparatus and method allow for sensing of VTI using ultrasonic sensors and complementary sensors.

The apparatus and method provide correlation between the ultrasonic sensor and complementary sensor to create a complementary sensor model for a VTI parameter. The complementary sensor model allows for the identifying of a VTI parameter from complex complementary sensor signals. This improves the accuracy of VTI monitoring using complementary sensors, and allows for extensive rail track monitoring by using cheaper complementary sensors to monitor VTI parameters along the length of a rail track.

It should be appreciated that the sensors described above may be deployed and installed on an existing rail track. Moreover, the sensor can be retrieved and reused at different locations, as required.

It will also be appreciated by persons skilled in the art that the apparatus and methods have been described by way of example and not in any way limitative sense, and that various alterations and modifications are possible without departing from the scope of the invention as defined by the appended claims.

Examples of the invention are described in the clauses below:

An apparatus for monitoring rail vehicle wheel-rail track interaction (VTI) comprising an ultrasonic sensor mountable on a rail track at a sensing region of the rail track, whereby the sensing region comprises an interface surface at which an interface forms during monitoring, the ultrasonic sensor comprising
at least one ultrasonic longitudinal bulk wave transducer configured to detect an ultrasonic longitudinal bulk wave signal reflected from the interface; and
at least one ultrasonic shear bulk wave transducer configured to detect an ultrasonic shear bulk wave signal reflected from the interface.

In combination with one or more clause, the at least one ultrasonic longitudinal bulk wave transducer comprises a plurality of ultrasonic longitudinal bulk wave transducers operating at the same predetermined longitudinal bulk wave frequency or different predetermined longitudinal bulk wave frequencies, whereby each transducer is configured to detect an ultrasonic longitudinal bulk wave signal of the same predetermined frequency or the different predetermined frequency reflected from the interface.

In combination with one or more clause, the at least one ultrasonic shear bulk wave transducer comprises a plurality of ultrasonic shear bulk wave transducers operating at the same predetermined shear bulk wave frequency or different predetermined shear bulk wave frequencies, whereby each transducer is configured to detect an ultrasonic shear bulk wave signal of the same predetermined frequency or the different predetermined frequency reflected from the interface.

In combination with one or more clause, the at least one ultrasonic shear bulk wave transducer comprises a plurality of ultrasonic shear bulk wave transducers operating at the same predetermined direction of polarisation or different predetermined directions of polarisation, whereby each transducer is configured to detect an ultrasonic shear bulk wave signal of the same predetermined direction of polarisation or the different predetermined direction of polarisation reflected from the interface.

An apparatus for monitoring rail vehicle wheel-rail track interaction (VTI) comprising an ultrasonic sensor mountable on a rail track at a sensing region of the rail track, whereby the sensing region comprises an interface surface at which an interface forms during monitoring, the first ultrasonic sensor comprising:
a plurality of ultrasonic longitudinal bulk wave transducers operating at the same predetermined longitudinal bulk wave frequency or different predetermined longitudinal bulk wave frequencies, whereby each transducer is configured to detect an ultrasonic longitudinal bulk wave signal of the same predetermined frequency or the different predetermined frequency reflected from the interface.

An apparatus for monitoring rail vehicle wheel-rail track interaction (VTI) comprising an ultrasonic sensor mountable on a rail track at a sensing region of the rail track, whereby the sensing region comprises an interface surface at which an interface forms during monitoring, the first ultrasonic sensor comprising:
a plurality of ultrasonic shear bulk wave transducers operating at the same predetermined shear bulk wave frequency or different predetermined shear bulk wave frequencies, whereby each transducer is configured to detect an ultrasonic shear bulk wave of the predetermined frequency or the different predetermined frequencies reflected from the interface.

An apparatus for monitoring rail vehicle wheel-rail track interaction (VTI) comprising an ultrasonic sensor mountable on a rail track at a sensing region of the rail track, whereby the sensing region comprises an interface surface at which an interface forms during monitoring, the first ultrasonic sensor comprising:
a plurality of ultrasonic shear bulk wave transducers operating at the same predetermined direction of polarisation or different predetermined directions of polarisation, whereby each transducer is configured to detect an ultrasonic shear bulk wave of the same predetermined direction of polarisation or at the different predetermined directions of polarisation reflected from the interface.

In combination with one or more clause, the interface is wheel-rail track interface when the wheel contacts the interface surface, whereby:
the or each ultrasonic longitudinal bulk wave signal reflected from the wheel-rail track interface is a VTI longitudinal bulk wave signal; and/or
the or each an ultrasonic shear bulk wave signal reflected from the wheel-rail track interface is a VTI shear bulk wave signal.

In combination with one or more clause, the interface is a reference interface when the interface surface is in a known state, whereby:
the or each ultrasonic longitudinal bulk wave signal reflected from the reference interface is a reference longitudinal bulk wave signal; and/or
the or each an ultrasonic shear bulk wave signal reflected from the reference interface is a reference shear bulk wave signal.

In combination with one or more clause, the interface is a variable interface when the interface is in a variable state, whereby:
the or each ultrasonic longitudinal bulk wave signal reflected from the variable interface is a variable longitudinal bulk wave signal detected over a predetermined period of time; and/or
the or each an ultrasonic shear bulk wave signal reflected from the variable interface is a variable shear bulk wave signal detected over the predetermined period of time.

An apparatus for monitoring rail vehicle wheel-rail track interaction (VTI) comprising an ultrasonic sensor mountable on a rail track at a sensing region of the rail track, whereby the sensing region comprises an interface surface at which an interface forms during monitoring, the ultrasonic sensor comprising
at least one ultrasonic longitudinal surface wave transducer configured to detect an ultrasonic longitudinal surface wave signal propagating along a rail track surface at the sensing region of the rail track; and
at least one ultrasonic shear surface wave transducer configured to detect an ultrasonic shear surface wave signal propagating along a rail track surface at the sensing region of the rail track.

In combination with one or more clause, the at least one ultrasonic longitudinal surface wave transducer comprises a plurality of ultrasonic longitudinal surface wave transducers operating at the same predetermined frequency or different predetermined frequencies, whereby each transducer is configured to detect an ultrasonic longitudinal surface wave signal of the same predetermined frequency or the different predetermined frequency propagating along the rail track surface at the sensing region of the rail track.

In combination with one or more clause, the at least one ultrasonic shear surface wave transducer comprises a plurality of ultrasonic shear surface wave transducers operating at the same predetermined shear surface wave frequency or different predetermined shear surface wave frequencies, whereby each transducer is configured to detect an ultrasonic shear surface wave signal of the same predetermined frequency or the different predetermined frequency propagating along the rail track surface at the sensing region of the rial track.

In combination with one or more clause, the at least one ultrasonic shear surface wave transducer comprises a plurality of ultrasonic shear surface wave transducers operating at the same predetermined direction of polarisation or different predetermined directions of polarisation, whereby each transducer is configured to detect an ultrasonic shear surface wave signal of the same predetermined direction of polarisation or the different predetermined direction of polarisation propagating along the rail track surface at the sensing region of the rail track.

An apparatus for monitoring rail vehicle wheel-rail track interaction (VTI) comprising an ultrasonic sensor mountable on a rail track at a sensing region of the rail track, whereby the sensing region comprises an interface surface at which an interface forms during monitoring, the first ultrasonic sensor comprising:
a plurality of ultrasonic longitudinal surface wave transducers operating at the same predetermined longitudinal surface wave frequency or different predetermined longitudinal surface wave frequencies, whereby each transducer is configured to detect an ultrasonic longitudinal bulk wave signal of the same predetermined frequency or the different predetermined frequency propagating along a rail track surface at the sensing region of the rail track.

An apparatus for monitoring rail vehicle wheel-rail track interaction (VTI) comprising an ultrasonic sensor mountable on a rail track at a sensing region of the rail track, whereby the sensing region comprises an interface surface at which an interface forms during monitoring, the first ultrasonic sensor comprising:
a plurality of ultrasonic shear surface wave transducers operating at the same predetermined shear surface wave frequency or different predetermined shear surface wave frequencies, whereby each transducer is configured to detect an ultrasonic shear bulk wave of the predetermined frequency or the different predetermined frequencies propagating along a rail track surface of the sensing region of the rail track.

An apparatus for monitoring rail vehicle wheel-rail track interaction (VTI) comprising an ultrasonic sensor mountable on a rail track at a sensing region of the rail track, whereby the sensing region comprises an interface surface at which an interface forms during monitoring, the first ultrasonic sensor comprising:
a plurality of ultrasonic shear surface wave transducers operating at the same predetermined direction of polarisation or different predetermined directions of polarisation, whereby each transducer is configured to detect an ultrasonic shear surface wave of the same predetermined direction of polarisation or at the different predetermined directions of polarisation propagating along a rail track surface of the sensing region of the rail track.

In combination with one or more clause, the interface is wheel-rail track interface when the wheel contacts the interface surface, whereby:
the or each ultrasonic longitudinal surface wave signal reflected from the wheel-rail track interface is a VTI longitudinal surface wave signal; and/or
the or each an ultrasonic shear surface wave signal reflected from the wheel-rail track interface is a VTI shear surface wave signal.

In combination with one or more clause, the interface is a reference interface when the interface surface is in a known state, whereby:
the or each ultrasonic longitudinal surface wave signal reflected from the reference interface is a reference longitudinal surface wave signal; and/or
the or each an ultrasonic shear surface wave signal reflected from the reference interface is a reference shear surface wave signal.

In combination with one or more clause, the interface is a variable interface when the interface is in a variable state, whereby:
the or each ultrasonic longitudinal surface wave signal reflected from the variable interface is a variable longitudinal surface wave signal detected over a predetermined period of time; and/or
the or each an ultrasonic shear surface wave signal reflected from the variable interface is a variable shear surface wave signal detected over the predetermined period of time.

In combination with one or more clause, the ultrasonic sensor may comprise damping to selectively control the frequency bandwidth of the ultrasonic sensor.

In combination with one or more clause, the or each longitudinal bulk wave transducer is configured to emit an ultrasonic longitudinal bulk wave signal to propagate through the sensing region to the interface.

In combination with one or more clause, the or each shear bulk wave transducer is configured to emit an ultrasonic shear bulk wave signal to propagate through the sensing region to the interface.

In combination with one or more clause, the ultrasonic sensor comprises a first longitudinal bulk wave emitting unit and a second longitudinal bulk wave detecting unit, whereby:
the first emitting unit comprises at least one of longitudinal bulk wave transducer configured to emit a longitudinal bulk wave signal through the sensing region to the interface;
the second detecting unit comprises the or each longitudinal bulk wave transducer configured to detect the longitudinal bulk wave signal reflected from the interface.

In combination with one or more clause, the ultrasonic sensor comprises a first shear bulk wave emitting unit and a second shear bulk wave detecting unit, whereby:
the first emitting unit comprises at least one of longitudinal bulk wave transducer configured to emit a longitudinal bulk wave signal through the sensing region to the interface;
the second detecting unit comprises the or each longitudinal bulk wave transducer configured to detect the longitudinal bulk wave signal reflected from the interface.

In combination with one or more clause, the ultrasonic sensor comprises a first longitudinal surface wave emitting unit and a second longitudinal surface wave detecting unit, whereby:
the first emitting unit comprises at least one of longitudinal surface wave transducer configured to emit a surface wave signal along the rail surface at the sensing region of the rail track;
the second detecting unit comprises the or each longitudinal surface wave transducer configured to detect the longitudinal surface wave signal propagating along the rail surface at the sensing region of the rail track from the first emitting unit.

In combination with one or more clause, the ultrasonic sensor comprises a first shear surface wave emitting unit and a second shear surface wave detecting unit, whereby:
the first emitting unit comprises at least one of shear surface wave transducer configured to emit a surface wave signal along the rail surface at the sensing region of the rail track;
the second detecting unit comprises the or each shear surface wave transducer configured to detect the shear surface wave signal propagating along the rail surface at the sensing region of the rail track from the first emitting unit.

1. An apparatus for monitoring rail vehicle-rail track interaction (VTI) at a sensing region of a rail track, the apparatus comprising:
an ultrasonic sensor mountable on the rail track to form the sensing region of the rail track;
whereby the sensing region of the rail track comprises an interface surface at which a wheel-rail interface forms when a rail vehicle wheel contacts the interface surface;
whereby the ultrasonic sensor comprises:
at least one ultrasonic longitudinal bulk wave transducer configured to detect a VTI ultrasonic longitudinal bulk wave signal reflected from the wheel-rail track interface; and
at least one ultrasonic shear bulk wave transducer configured to detect a VTI ultrasonic shear bulk wave signal reflected from the wheel-rail track interface.

2. The apparatus according to claim 1, wherein the apparatus further comprises a processor configured to:
determine a characteristic of the detected VTI longitudinal bulk wave signal, wherein the characteristic comprises the time of flight and/or amplitude; and
determine a VTI parameter based on the characteristic of the detected VTI longitudinal bulk wave signal, wherein the characteristic of the detected VTI longitudinal bulk wave signal is indicative of a VTI parameter.

3. The apparatus according to claim 1, wherein the apparatus further comprises a processor configured to:
determine a characteristic of the detected VTI shear bulk wave signal, wherein the characteristic is the time of flight and/or amplitude; and
determine a VTI parameter based on the characteristic of the detected VTI shear bulk wave signal, wherein characteristic of the detected VTI shear bulk wave signal is indicative of a VTI parameter.

4. The apparatus according to claim 1, wherein a reference interface forms at the interface surface when the interface surface is in a reference state, whereby:
the at least one ultrasonic longitudinal bulk wave transducer is configured to detect a reference ultrasonic longitudinal bulk wave signal reflected from the reference interface; and
the at least one ultrasonic shear bulk wave transducer is configured to detect a reference ultrasonic shear bulk wave signal reflected from the reference interface.

5. The apparatus according to claim 4, wherein the apparatus further comprises a processor configured to:
compare a characteristic of the detected VTI longitudinal bulk wave signal with a corresponding characteristic of the detected reference longitudinal bulk wave signal, wherein the characteristic is the time of flight and/or amplitude; and
determine a VTI parameter based on the change in characteristic of the detected VTI longitudinal bulk wave signal and the detected reference longitudinal bulk wave signal, wherein the characteristic of the detected reference longitudinal bulk wave signal is indicative of a reference state.

6. The apparatus according to claim 5, wherein when the characteristic of the detected VTI longitudinal bulk wave signal and the corresponding characteristic of the reference longitudinal bulk wave signal is amplitude, and the VTI parameter is contact position and contact shape at the interface surface, wherein the processor is configured to:
determine a percentage change in the amplitude of the detected VTI longitudinal bulk wave signal and the amplitude of the detected reference longitudinal bulk wave signal; and
determine a contact position and contact shape between the interface surface and the rail vehicle wheel based on the percentage change in amplitude.

7. The apparatus according to claim 5, wherein when the characteristic of the detected VTI longitudinal bulk wave signal and the corresponding characteristic of the reference longitudinal bulk wave signal is amplitude, and the VTI parameter is normal interface stiffness at the interface; wherein the processor is configured to:
determine a percentage change in the amplitude of the detected VTI longitudinal bulk wave signal and the amplitude of the detected reference longitudinal bulk wave signal; and
determine a normal interface stiffness at the interface based on the percentage change in amplitude,
optionally wherein the at least one ultrasonic longitudinal bulk wave transducer comprises a plurality of longitudinal bulk wave transducers operating at different frequencies, wherein: the processor is configured to determine the normal stiffness at the interface for each frequency of the detected longitudinal bulk wave signals.

8. (canceled)

9. The apparatus according to claim 4, wherein the apparatus further comprises a processor configured to
compare a characteristic of the detected VTI shear bulk wave signal with a corresponding characteristic of the detected reference shear bulk wave signal, wherein the characteristic is the time of flight and/or amplitude; and
determine a VTI parameter based on the change in characteristic of the detected VTI shear bulk wave signal and the detected reference shear bulk wave signal, wherein the characteristic of the detected reference shear bulk signal is indicative of a reference state.

10. The apparatus according to claim 9, wherein when the characteristic of detected shear bulk wave signal and the corresponding characteristic of the reference shear bulk wave signal is amplitude, and the VTI parameter is contact position and contact shape, wherein the processor is configured to:
determine a percentage change in the amplitude of the detected VTI shear bulk signal and the amplitude of the detected reference shear bulk wave signal; and
determine a contact position and contact shape between the interface surface and the rail vehicle wheel based on the percentage change in amplitude.

11. The apparatus according to claim 9, wherein when the characteristic of detected shear bulk wave signal and corresponding characteristic of the reference shear bulk wave signal is the amplitude, and the VTI parameter is shear interface stiffness at the interface, wherein the processor is configured to:
determine a percentage change in the amplitude of the detected VTI shear bulk wave signal and the amplitude of the detected reference shear bulk wave signal; and
determine a shear interface stiffness at the interface based on the percentage change in amplitude.

12. The apparatus according to claim 11, wherein the at least one ultrasonic shear bulk wave transducer comprises a plurality of shear bulk wave transducers operating at different frequencies, wherein:
the processor is configured to determine the shear stiffness at the interface for each frequency of the detected shear bulk wave signals.

13. The apparatus according to claim 11, wherein the at least one ultrasonic shear bulk wave transducer comprises a plurality of shear bulk wave transducers with different directions of polarisation, wherein:
the processor is configured to determine the shear stiffness at the interface for each direction of polarisation of the detected shear bulk wave signals.

14. The apparatus according to claim 5, wherein when the characteristic of the detected VTI longitudinal bulk wave signal is the time of flight, and the VTI parameter is normal load at the interface; wherein the processor is configured to:
determine a time of flight for the detected VTI longitudinal bulk wave signal; with a direction of propagating parallel to the vertical axis of the track; and
determine the normal load at the interface based on the time of flight.

15. The apparatus according to claim 5, wherein when the characteristic of the detected VTI shear bulk wave signal is the time of flight, and the VTI parameter is lateral load at the interface; wherein the processor is configured to:
determine a time of flight for the detected VTI shear bulk wave signal with a direction of polarisation parallel to the lateral axis of the rail track; and
determine the lateral load at the interface based on the time of flight.

16. The apparatus according to claim 1, wherein a variable interface forms when the interface surface is in a variable state, whereby;
the at least one ultrasonic longitudinal bulk wave transducer is configured to detect a variable ultrasonic longitudinal bulk wave signal reflected from the variable interface for a predetermined period of time; and
the at least one ultrasonic shear bulk wave transducer is configured to detect a variable ultrasonic shear bulk wave signal reflected from the variable interface for the predetermined period of time,
optionally wherein the apparatus further comprises a processor configured to: determine a characteristic of the detected variable longitudinal bulk wave signal, wherein the characteristic comprises the time of flight and/or amplitude; and determine a pattern in the characteristic of the detected variable longitudinal bulk wave signal, wherein the pattern is indicative of the rail vehicle travel.

17. (canceled)

18. (canceled)

19. The apparatus according to claim 1, wherein:
the at least one ultrasonic longitudinal bulk wave transducer is configured to emit an ultrasonic longitudinal bulk wave signal to propagate through the sensing region of the rail track to the interface surface; and/or
the at least one ultrasonic shear bulk wave transducer is configured to emit an ultrasonic shear bulk wave signal to propagate through the sensing region of the rail track to the interface surface.

20. The apparatus according to claim 1, wherein the ultrasonic sensor comprises:
a longitudinal bulk wave emitting unit comprising at least one ultrasonic longitudinal bulk wave transducer configured to emit an ultrasonic longitudinal bulk wave signal to propagate through the sensing region of the rail track to the interface surface; and
a longitudinal bulk wave detecting unit comprising the at least one ultrasonic longitudinal bulk wave transducer configured to detect the reflected longitudinal bulk wave signal.

21. The apparatus according to claim 1, wherein the ultrasonic sensor comprises:
a shear bulk wave emitting unit comprising at least one ultrasonic shear bulk wave transducer configured to emit an ultrasonic shear bulk wave signal to propagate through the sensing region of the rail track to the interface surface; and
a shear bulk wave detecting unit comprising the at least one ultrasonic shear bulk wave transducer configured to detect the reflected shear bulk wave signal.

22. The apparatus according to claim 1, wherein the ultrasonic sensor comprises damping integrated with a backing plate, whereby the transducers are mounted on the backing plate.

23. The apparatus according to claim 1, wherein the ultrasonic sensor further comprises: at least one ultrasonic longitudinal surface wave transducer configured to detect an ultrasonic longitudinal surface wave signal propagating along a rail track surface at the sensing region of the rail track; and/or
at least one ultrasonic shear surface wave transducer configured to detect an ultrasonic shear surface wave signal propagating along a rail track surface at the sensing region of the rail track.

24. (canceled)

25. (canceled)
